(19) United States
(12) Patent Application Publication
(10) Pub. No.: US 2024/0179705 A1
(43) Pub. Date: May 30, 2024

(54) METHOD AND APPARATUS FOR UPLINK DATA TRANSMISSION BY CONSIDERING MULTI-PANEL SIMULTANEOUS TRANSMISSION IN WIRELESS COMMUNICATION SYSTEM

(71) Applicant: Samsung Electronics Co., Ltd., Gyeonggi-do (KR)

(72) Inventors: Seongmok LIM, Gyeonggi-do (KR); Kyoungmin PARK, Gyeonggi-do (KR); Ameha Tsegaye ABEBE, Gyeonggi-do (KR); Youngrok JANG, Gyeonggi-do (KR); Hyoungju JI, Gyeonggi-do (KR); Kyungjun CHOI, Gyeonggi-do (KR)

(21) Appl. No.: 18/502,635

(22) Filed: Nov. 6, 2023

(30) Foreign Application Priority Data
Nov. 7, 2022 (KR) 10-2022-0147149
Oct. 6, 2023 (KR) 10-2023-0133525

(51) Int. Cl. H04W 72/1268; H04L 1/1607; H04W 72/232

(52) U.S. Cl. CPC H04W 72/1268; H04L 1/1642; H04W 72/232

(57) ABSTRACT

The disclosure relates to a fifth generation (5G) or sixth generation (6G) communication system for supporting higher data transfer rates. A method performed by a user equipment (UE) in a wireless communication system, the method comprising: receiving configuration information on a resource for transmitting a first physical uplink shared channel (PUSCH) based on a configured grant, the first PUSCH being associated with a first control resource set (CORESET) pool identifier; receiving downlink control information (DCI) including information on a resource for transmitting a second PUSCH based on a dynamic grant (DG), the second PUSCH being associated with a second CORESET pool identifier, wherein the resource for transmitting the first PUSCH overlaps with all or part of the resource for transmitting the second PUSCH in a time domain; identifying whether a value of the first CORESET pool identifier is different from a value of the second CORESET pool identifier; and in case that the value of the first CORESET pool identifier is identified to be different from the value of the second CORESET pool identifier, transmitting the first PUSCH and the second PUSCH.

### CROSS-REFERENCE TO RELATED APPLICATION(S)

This application is based on and claims priority under 35 U.S.C. § 119 to Korean Patent Application Nos. 10-2022-0147149 and 10-2023-0133525, filed on Nov. 7, 2022 and Oct. 6, 2023, respectively, in the Korean Intellectual Property Office, the disclosures of which are incorporated herein by reference in their entireties.

### BACKGROUND

### 1. Field

The disclosure relates generally to the operation of a terminal and a base station in a wireless communication system, and more particularly, to a method of performing simultaneous uplink transmission using multiple panels in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz. In addition, it has been considered to implement sixth generation (6G) mobile communication technologies (referred to as Beyond 5G systems) in terahertz bands (for example, 95 GHz to 3 THz bands) to accomplish transmission rates fifty times faster than 5G mobile communication technologies and ultra-low latencies one-tenth of 5G mobile communication technologies.

When the development of 5G mobile communication technologies began, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Discussions are ongoing regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks. Thus, it is anticipated that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

In addition, the development of such a 5G mobile communication system is a new waveform, full dimensional MIMO (FD-MIMO), and array antenna for guaranteeing coverage in the THz band of 6G mobile communication technology. Multi-antenna transmission technologies such as large scale antennas, metamaterial-based lenses and antennas to improve coverage of terahertz band signals, high-dimensional spatial multiplexing technology using orbital angular momentum (OAM), reconfigurable intelligent surface (RIS) technology, as well as full duplex technology to improve frequency efficiency and system network of 6G mobile communication technology, satellite, and AI are utilized from the design stage and end-to-end development of AI-based communication technology that realizes system optimization by internalizing AI-supported functions and next-generation distributed computing technology that realizes complex services beyond the limits of terminal computing capabilities by utilizing ultra-high-performance communication and computing resources are being developed.

Wireless communication systems have evolved from providing early voice-oriented services to high speed packet access (HSPA), long term evolution (LTE) or evolved universal terrestrial radio access (E-UTRA), and LTE-advanced. Broadband wireless that provides high-speed, high-quality packet data services such as communication standards such as (LTE-A), LTE-Pro, high rate packet data (HRPD), ultra mobile broadband (UMB), and the institute of electrical and electronics engineers (IEEE) 802.16e.

As a representative example of the broadband wireless communication system, the LTE system adopts orthogonal frequency division multiplexing (OFDM) in the downlink (DL), and single carrier frequency division multiplexing (SC-FDMA) in the uplink (UL). UL refers to a wireless link in which a terminal (user equipment (UE) or mobile station (MS)) transmits data or control signals to a base station (BS or eNode B), and DL refers to a wireless link in which the base station transmits data or control signals to the user equipment. In the above multiple access method, the time-frequency resources to carry data or control information for each user are usually allocated and operated so that they do not overlap, that is, orthogonality is established, so that each user's data or control information is distinguished.

As a future communication system after LTE, that is, the 5G communication system must be able to freely reflect the various requirements of users and service providers, so services that simultaneously satisfy various requirements must be supported. Services considered for the 5G communication system include eMBB, mMTC, and URLLC.

eMBB aims to provide more improved data transmission speeds than those supported by existing LTE, LTE-A or LTE-Pro. For example, in a 5G communication system, eMBB must be able to provide a peak data rate of 20 gigabits per second (Gbps) in the DL and 10 Gbps in the UL from the perspective of one base station. The 5G communication system must provide the maximum transmission rate and increased user perceived data rate. In order to meet these requirements, improvements in various transmission and reception technologies are required, including more advanced MIMO transmission technology. In addition, while LTE transmits signals using a maximum of 20 megahertz (MHz) transmission bandwidth in the 2 gigahertz (GHz) band, the 5G communication system uses a frequency bandwidth wider than 20 MHz in the 3-6 GHz or above 6 GHz frequency band to transmit the data, and transmission speed required by the 5G communication system can be satisfied.

mMTC is being considered to support application services such as the Internet of things (IoT) in 5G communication systems. In order to efficiently provide the IoT, mMTC requires support for access to a large number of terminals within a cell, improved coverage of terminals, improved battery time, and reduced terminal costs. Since the IoT provides communication functions by attaching various sensors and various devices, it must be able to support a large number of terminals (for example, 1,000,000 terminals/km\hat{ }2) within a cell. Additionally, due to the nature of the service, terminals that support mMTC are likely to be located in shadow areas that cannot be covered by cells, such as the basement of a building, so they may require wider coverage than other services provided by the 5G communication system. Terminals that support mMTC must be composed of low-cost materials. Since it is difficult to frequently replace the terminal's battery, a very long battery life time, such as 10 to 15 years, may be required.

URLLC is a cellular-based wireless communication service used for a specific purpose (mission-critical), such as remote control of robots or machinery, industrial automation, unmanned aerial vehicles, remote health care, and emergency situations. Services used for emergency alerts, etc. can be considered. Therefore, the communication provided by URLLC must provide very low latency and very high reliability. For example, a service that supports URLLC must satisfy an air interface latency of less than 0.5 milliseconds and has a packet error rate of less than 10\hat{ }−5. Therefore, for services supporting URLLC, the 5G system must provide a lower transmit time interval (TTI) than other services, and at the same time, design requirements that wide resources must be allocated in the frequency band to ensure the reliability of the communication link may be required.

The three 5G services, namely eMBB, URLLC, and mMTC, can be multiplexed and transmitted in one system. Different transmission/reception techniques and transmission/reception parameters can be used between services to satisfy the different requirements of each service. However, 5G is not limited to the three services.

### SUMMARY

This disclosure has been made to address at least the above-mentioned problems and/or disadvantages and to provide at least the advantages described below.

Accordingly, an aspect of the disclosure is to provide an apparatus and a method that can effectively provide services by simultaneously transmitting multiple uplink channels using multiple panels in a wireless communication system.

In accordance with an aspect of the disclosure, a method performed by a UE in a wireless communication system includes receiving configuration information on a resource for transmitting a first physical uplink shared channel (PUSCH) based on a configured grant, the first PUSCH being associated with a first control resource set (CORESET) pool identifier, wherein the resource for transmitting the first PUSCH overlaps with all or part of the resource for transmitting the second PUSCH in a time domain, receiving downlink control information (DCI) including information on a resource for transmitting a second PUSCH based on a dynamic grant (DG), the second PUSCH being associated with a second CORESET pool identifier, identifying whether a value of the first CORESET pool identifier is different from a value of the second CORESET pool identifier, and in case that the value of the first CORESET pool identifier is identified to be different from the value of the second CORESET pool identifier, transmitting the first PUSCH and the second PUSCH.

In accordance with an aspect of the disclosure, a method performed by a base station in a wireless communication system includes transmitting configuration information on a resource for transmitting a first PUSCH based on a configured grant, the first PUSCH being associated with a first CORESET pool identifier, wherein the resource for transmitting the first PUSCH overlaps with all or part of the resource for transmitting the second PUSCH in a time domain, transmitting DCI including information on a resource for transmitting a second PUSCH based on a dynamic grant (DG), the second PUSCH being associated with a second CORESET pool identifier, and in case that a value of the first CORESET pool identifier is different from a value of the second CORESET pool identifier, receiving the first PUSCH and the second PUSCH.

In accordance with an aspect of the disclosure, a UE in a wireless communication system includes a transceiver; and a controller coupled with the transceiver, wherein the controller is configured to receive configuration information on a resource for transmitting a first PUSCH based on a configured grant, the first PUSCH being associated with a first CORESET pool identifier, wherein the resource for transmitting the first PUSCH overlaps with all or part of the resource for transmitting the second PUSCH in a time domain, receive DCI including information on a resource for transmitting a second PUSCH based on a DG, the second PUSCH being associated with a second CORESET pool identifier, identify whether a value of the first CORESET pool identifier is different from a value of the second CORESET pool identifier, and in case that the value of the first CORESET pool identifier is identified to be different from the value of the second CORESET pool identifier, transmit the first PUSCH and the second PUSCH.

In accordance with an aspect of the disclosure, a base station in a wireless communication system includes a transceiver, and a controller coupled with the transceiver, wherein the controller is configured to transmit configuration information on a resource for transmitting a first PUSCH based on a configured grant, the first PUSCH being associated with a first CORESET pool identifier, wherein the resource for transmitting the first PUSCH overlaps with all or part of the resource for transmitting the second PUSCH in a time domain, transmit DCI including information on a resource for transmitting a second PUSCH based on a DG, the second PUSCH being associated with a second CORESET pool identifier, and in case that a value of the first CORESET pool identifier is different from a value of the second CORESET pool identifier, receive the first PUSCH and the second PUSCH.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency area in a wireless communication system according to an embodiment;

FIG. 2 illustrates structures of a frame, a subframe, and a slot in a wireless communication system according to an embodiment;

FIG. 3 illustrates a bandwidth part configuration in a wireless communication system according to an embodiment;

FIG. 4 illustrates base station beam allocation according to a transmission configuration indicator (TCI) state in a wireless communication system according to an embodiment;

FIG. 5 illustrates frequency axis resource allocation of a physical downlink shared channel (PDSCH) in a wireless communication system according to an embodiment;

FIG. 6 illustrates time axis resource allocation of a PDSCH in a wireless communication system according to an embodiment;

FIG. 7 illustrates a process for beam configuration and activation of a PDSCH according to an embodiment;

FIG. 8 illustrates a medium access control (MAC) control element (CE) for activating a physical uplink control channel (PUCCH) resource group-based spatial relation in a wireless communication system according to an embodiment;

FIG. 9 illustrates a physical uplink shared channel (PUSCH) repetitive transmission type B in a wireless communication system according to an embodiment;

FIG. 10 illustrates a wireless protocol structure of a base station and a UE in single cell, carrier aggregation, and dual connectivity situations in a wireless communication system according to an embodiment;

FIG. 11 illustrates an antenna port configuration and resource allocation for cooperative communication in a wireless communication system according to an embodiment;

FIG. 12 illustrates configuration of DCI for cooperative communication in a wireless communication system according to an embodiment;

FIG. 13 illustrates an enhanced PDSCH TCI state activation/deactivation MAC-CE structure according to an embodiment;

FIG. 14 illustrates a radio link monitoring (RLM) reference signal (RS) selection process according to an embodiment;

FIG. 15 illustrates a MAC-CE structure for joint TCI state activation and indication in a wireless communication system according to an embodiment;

FIG. 16 illustrates a MAC-CE structure for joint TCI state activation and indication in a wireless communication system according to an embodiment;

FIG. 17 illustrates a MAC-CE structure for joint TCI state activation and indication in a wireless communication system according to an embodiment;

FIG. 18 illustrates a MAC-CE structure for separate TCI state activation and indication in a wireless communication system according to an embodiment;

FIG. 19 illustrates a MAC-CE structure for separate TCI state activation and indication in a wireless communication system according to an embodiment;

FIG. 20 illustrates a MAC-CE structure for separate TCI state activation and indication in a wireless communication system according to an embodiment;

FIG. 21 illustrates a MAC-CE structure for separate TCI state activation and indication in a wireless communication system according to an embodiment;

FIG. 22 illustrates a MAC-CE structure for joint and separate TCI state activation and indication in a wireless communication system according to an embodiment;

FIG. 23 illustrates a MAC-CE structure for joint and separate TCI state activation and indication in a wireless communication system according to an embodiment;

FIG. 24 illustrates a beam application time that can be considered when using a unified TCI scheme in a wireless communication system according to an embodiment;

FIG. 25 illustrates a MAC-CE structure for activating and indicating a plurality of joint TCI states in a wireless communication system according to an embodiment;

FIG. 26 illustrates a MAC-CE structure for activating and indicating a plurality of separate TCI states in a wireless communication system according to an embodiment;

FIG. 27 illustrates a MAC-CE structure for activating and indicating a plurality of separate TCI states in a wireless communication system according to an embodiment;

FIG. 28 illustrates a MAC-CE structure for activating and indicating a joint TCI state or a separate DL or UL TCI state in a wireless communication system according to an embodiment;

FIG. 29 illustrates a MAC-CE structure for activating and indicating a plurality of joint TCI states, or separate DL or UL TCI states in a wireless communication system according to an embodiment;

FIG. 30 illustrates a MAC-CE structure for activating and indicating a plurality of joint TCI states, or separate DL or UL TCI states in a wireless communication system according to an embodiment;

FIG. 31 illustrates when two sets of SRS resources each include two SRS resources, and when a UE can support simultaneous uplink transmission using two panels in a wireless communication system according to an embodiment;

FIG. 32 illustrates when two sets of SRS resources each include two SRS resources, and when a UE can support simultaneous uplink transmission using two panels in a wireless communication system according to an embodiment;

FIG. 33 illustrates when two PUSCH transmissions associated with each CORESETPoolIndex overlap according to an embodiment;

FIG. 34 illustrates a case of determining multi-panel simultaneous transmission according to CORESETPoolIndex according to an embodiment;

FIG. 35 illustrates a case of determining whether multi-panel simultaneous transmission is possible based on the sum of the number of layers of two different overlapping PUSCHs according to an embodiment;

FIG. 36 illustrates scheduling two different overlapping PUSCHs based on a minimum timeline condition required to determine the processing of the two different overlapping PUSCHs according to an embodiment;

FIG. 37 illustrates determining whether multi-panel simultaneous transmission is possible by identifying whether there is a section capable of starting initial transmission for the repeatedly transmitted CG PUSCH according to an embodiment;

FIG. 38 illustrates CG PUSCH scheduling based on whether a CG PUSCH is transmitted through a single panel or multi-panel simultaneous transmission according to an embodiment;

FIG. 39 illustrates an operation between a base station and a UE to illustrate simultaneously transmitting and receiving dynamic grant (DG) PUSCH and CG PUSCH through multiple panels according to an embodiment;

FIG. 40 illustrates a structure of a UE in a wireless communication system according to an embodiment; and

FIG. 41 illustrates a structure of a base station in a wireless communication system according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

For the same reason, some components in the attached drawings are exaggerated, omitted, or schematically shown. Additionally, the size of each component does not entirely reflect its actual size. In each drawing, identical or corresponding components are assigned the same reference numbers.

The advantages and features of the present disclosure and methods for achieving them will become clear by referring to the embodiments described in detail below along with the accompanying drawings. However, the present disclosure is not limited to the embodiments disclosed below and may be implemented in various different forms, and the present embodiments are merely intended to ensure that the disclosure is complete and are within the scope of common knowledge in the technical field to which the present disclosure pertains. Like reference numerals refer to like elements throughout the disclosure.

Herein, elements included in the disclosure are expressed in singular or plural numbers depending on the specific embodiment presented. However, singular or plural expressions are selected to suit the presented situation for convenience of explanation, and the present disclosure is not limited to singular or plural components, and even components expressed in plural may be composed of singular or singular. Even expressed components may be composed of plural elements.

The terms described below are defined in consideration of the functions in the present disclosure, and may vary depending on the intention or custom of the user or operator. Therefore, the definition should be made based on the contents throughout this disclosure.

The term unit used herein refers to software or hardware components such as field programmable gate array (FPGA) or an application specific integrated circuit (ASIC), and the unit performs certain roles. do. However, part is not limited to software or hardware and may be configured to reside in an addressable storage medium and may be configured to reproduce on one or more processors. Therefore, as an example, part refers to components such as software components, object-oriented software components, class components, and task components, processes, functions, properties, and procedures, subroutines, segments of program code, drivers, firmware, microcode, circuitry, data, databases, data structures, tables, arrays, and variables. The functions provided within the components and parts may be combined into a lower number of components and parts or may be further separated into additional components and parts. Additionally, components and parts may be implemented to regenerate one or more CPUs within a device or a secure multimedia card. A part herein may include one or more processors.

Hereinafter, the disclosure will be described using a 5G system as an example, but the disclosure may be applied to other communication systems having a similar technical background or channel type. For example, LTE or LTE-A mobile communication and mobile communication technology developed after 5G may be included therein. Accordingly, the disclosure may be applied to other communication systems through some modifications within a range that does not significantly depart from the scope of the disclosure as determined by those of ordinary skill in the art. The contents of the disclosure are applicable to frequency division duplex (FDD) and time division duplex (TDD) systems. Higher layer signaling is a signal transmission method in which signal transmission occurs from a base station to a UE by using a DL data channel of a physical layer, or in which transmission occurs from a UE to a base station by using an uplink data channel of a physical layer, and may be referred to as radio resource control (RRC) signaling, PDCP signaling, or a medium access control (MAC) control element (MAC CE).

In describing the disclosure, higher layer signaling may correspond to at least one or a combination of one or more of a master information block (MIB), a system information block (SIB) or SIB X (X=1, 2, . . . ), RRC, and MAC control element (CE).

In addition, L1 signaling may correspond to at least one or a combination of one or more of signaling methods using physical layer channel or signaling including a physical downlink control channel (PDCCH), DCI, UE-specific DCI, group common DCI, common DCI, scheduling DCI (for example, DCI used for scheduling DL or UL data, non-scheduling DCI (for example, DCI not for the purpose of scheduling downlink or uplink data), PUCCH, and UL control information (UCI).

Hereinafter, determining a priority between A and B refers to selecting one having a higher priority according to a predetermined priority rule and performing an operation corresponding thereto or omitting or dropping an operation corresponding to one having a lower priority.

As used herein, the term slot may refer to a specific unit of time corresponding to a transmit time interval (TTI), and may specifically refer to a slot used in a 5G NR system, or a slot or subframe used in a 4G LTE system.

The base station performs resource allocation for the terminal and may be at least one of gNode B, eNode B, Node B, BS, wireless access unit, base station controller, or node on the network. A terminal may include a UE, MS, a cellular phone, a smartphone, a computer, or a multimedia system capable of performing communication functions. Although the LTE or LTE-A system may be described herein, embodiments of the present disclosure can also be applied to other communication systems with similar technical background or channel type, including the 5th generation mobile communication technology (5G, new radio, NR) developed after LTE-A, and the term 5G hereinafter may also include the existing LTE, LTE-A, and other similar services. In addition, this disclosure may be applied to other communication systems through some modifications without significantly departing from the scope of the present disclosure at the discretion of a person with skilled technical knowledge.

NR Time-Frequency Resources

Hereinafter, a frame structure of a 5G system will be described in detail with reference to the drawings.

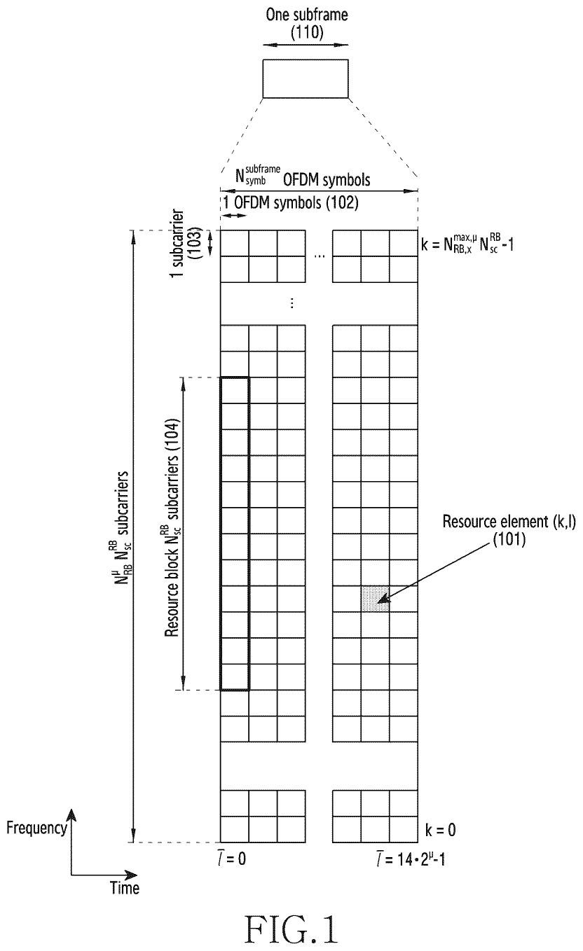

FIG. 1 illustrates a basic structure of the time-frequency domain, which is a radio resource domain in which data or a control channel is transmitted in a 5G system according to an embodiment.

In FIG. 1, the horizontal axis represents a time domain, and the vertical axis represents a frequency domain. A basic resource unit in the time and frequency domain is a resource element (RE) 101, which may be defined as one OFDM symbol 102 on the time axis and one subcarrier NRP 103 on the frequency axis. In the frequency domain, N_{SC}^{RB} (e.g., 12) consecutive REs may constitute one resource block (RB) 104. In the time domain, one subframe 110 may include a plurality of OFDM symbols 102. For example, the length of 1 subframe may be 1 millisecond (ms).

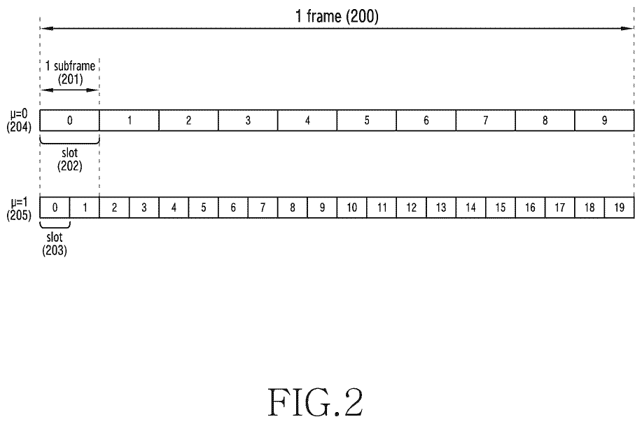

FIG. 2 illustrates structures of a frame, a subframe, and a slot in a wireless communication system according to an embodiment.

In FIG. 2, examples of structures of a frame 200, a subframe 201, a slot 202 are illustrated. One frame 200 may be defined as being 10 ms long. The one subframe 201 may be defined to be 1 ms, and thus a total of 10 subframes 201 may constitute the one frame 200. One slot 202, 203 may be defined as 14 OFDM symbols (that is, the number of symbols per one slot (N_{symb}^{slot}=14)). One or a plurality of slots 202, 203 may constitute one subframe 201, and the number of slots 202, 203 per one subframe 201 may vary according to a configuration value μ 204, 205 regarding a subcarrier spacing. FIG. 2 illustrates a case in which a subcarrier spacing configuration value μ equals 0 (indicated by reference numeral 204) and a case in which μ equals 1 (indicated by reference numeral 205). In a case of μ=0 (indicated by reference numeral 204), one subframe 201 may be configured by one slot 202, and, in a case of μ=1 (indicated by reference numeral 205), one subframe 201 may be configured by two slots 203. That is, the number of slots per one subframe (Nₛₗₒₜ^{subframe,μ}) may vary according to the configuration value regarding the subcarrier spacing, and accordingly, the number of slots per one frame (Nₛₗₒₜ^{frame,μ}) may vary. Nₛₗₒₜ^{subframe,μ} and Nₛₗₒₜ^{frame,μ} according to a subcarrier spacing configuration μ may be defined as shown below in Table 1.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Bandwidth Part (BWP)

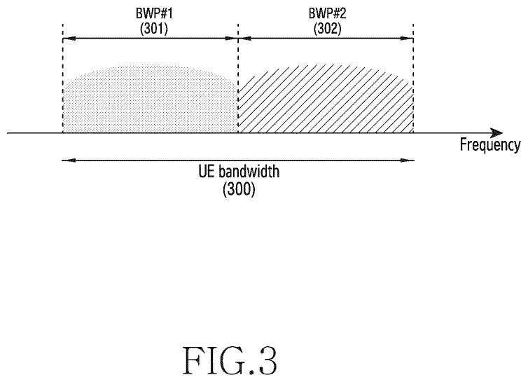

FIG. 3 illustrates a BWP configuration in a wireless communication system according to an embodiment.

In FIG. 3, a UE bandwidth 300 is configured by two bandwidth parts, that is, a bandwidth part #1 (BWP #1) 301 and a bandwidth part #2 (BWP #2) 302. Abase station may configure one or a plurality of bandwidth parts for a terminal, and information shown below in Table 2 may be configured for each bandwidth part.

TABLE 2

| | |
|---|---|
| BWP ::= | SEQUENCE { |
| bwp-Id | BWP-Id, |

(Bandwidth part identifier)

| | |
|---|---|
| locationAndBandwidth | INTEGER (1..65536), |

(Bandwidth part location)

| | |
|---|---|
| subcarrierSpacing | ENUMERATED {n0, n1, n2, n3, n4, n5}, |

(Subcarrier spacing)

| | |
|---|---|
| cyclicPrefix | ENUMERATED { extended } |

(Cyclic prefix)
}

The configuration of the bandwidth part is not limited by Table 2, and various parameters related to a BWP in addition to the configuration information may be configured in the UE. The pieces of information may be transmitted by the base station to the UE via higher layer signaling such as radio resource control (RRC) signaling. At least one BWP among the configured one or multiple BWPs may be activated. Whether to activate the configured BWP may be semi-statically transmitted from the base station to the UE via RRC signaling or may be dynamically transmitted through DCI.

A UE before RRC connection may be configured with an initial bandwidth part (BWP) for initial access from abase station through an MIB. The UE may receive configuration information about a search apace and a control resource set (CORESET) through which the PDCCH for reception of system information required for initial access (which may correspond to remaining system information (RMSI) or an SIB 1) may be transmitted through the MIB in an initial access operation. The control resource set (CORESET) and search space, which are configured through the MIB, may be regarded as identity (ID) 0, respectively. The base station may notify the UE of configuration information, such as frequency allocation information, time allocation information, and numerology for the control resource set #0 through the MIB. In addition, the base station may notify the UE of configuration information regarding the monitoring periodicity and occasion for the control resource set #0, that is, configuration information regarding the search space #0, through the MIB. The UE may regard the frequency domain configured as the control resource set #0, obtained from the MIB, as an initial BWP for initial access. The identifier (ID) of the initial BWP may be regarded as zero.

The configuration of the BWP supported by 5G may be used for various purposes.

A case in which a bandwidth supported by the UE is less than a system bandwidth, may be supported through the BWP configuration. For example, the base station configures, in the UE, a frequency location (configuration information 2) of the BWP to enable the UE to transmit or receive data at a specific frequency location within the system bandwidth.

The base station may configure multiple BWPs in the UE for the purpose of supporting different numerologies. For example, in order to support both data transmission/reception to/from a predetermined UE by using a subcarrier spacing of 15 kHz and a subcarrier spacing of 30 kHz, two BWPs may be configured to use a subcarrier spacing of 15 kHz and a subcarrier spacing of 30 kHz, respectively. Different BWPs may be frequency division multiplexed, and when attempting to transmit or receive data at a specific subcarrier spacing, the BWP configured with the corresponding subcarrier spacing may be activated.

The base station may configure, in the UE, the BWPs having bandwidths of different sizes for the purpose of reducing power consumption of the UE. For example, when the UE supports a very high bandwidth, such as 100 MHz, and always transmits or receives data at the corresponding bandwidth, the transmission or reception may cause very high power consumption in the UE. In particular, when the UE performs monitoring on unnecessary downlink control channels of a large bandwidth of 100 MHz even when there is no traffic, the monitoring may be very inefficient in terms of power consumption. Therefore, in order to reduce power consumption of the UE, the base station may configure, for the UE, a BWP of a relatively low bandwidth such as 20 MHz. In a situation without traffic, the UE may perform a monitoring operation on a BWP of 20 MHz. When data reception has occurred, the UE may transmit or receive data in a BWP of 100 MHz according to an indication of the base station.

In a method of configuring the BWP, the UEs before the RRC connection may receive configuration information about the initial bandwidth part through the master information block (MIB) in the initial connection operation. More specifically, the UE may be configured with a CORESET for a DL control channel through which DCI for scheduling a system information block (SIB) may be transmitted from a MIB of a physical broadcast channel (PBCH). The bandwidth of the control resource set configured through the MIB may be regarded as the initial BWP. The UE may receive, through the configured initial BWP, a physical DL shared channel (PDSCH) through which the SIB is transmitted. The initial BWP may be used for other system information (OSI), paging, and random access as well as the reception of the SIB.

BWP Change

When one or more BWPs have been configured for a UE, a base station may indicate the UE to change (or switching, shift) the BWP by using a bandwidth part indicator field in DCI. As an example, in FIG. 3, when the currently activated BWP of the UE is BWP #1 301, the base station may indicate BWP #2 302 to the UE by using the BWP indicator in DCI, and the UE may perform a BWP switch to the BWP #2 302 indicated by the BWP indicator in the received DCI.

Since the DCI-based BWP change may be indicated by the DCI scheduling the PDSCH or PUSCH, when receiving a request to switch the BWP, the UE should smoothly receive or transmit the PDSCH or PUSCH, which is scheduled by the DCI, without difficulty in the switched BWP. To this end, the standard stipulates the requirements for a delay time (T_{BWP}) required when switching the BWP, and may be defined as shown below in Table 3.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the BWP switch delay time support type 1 or type 2 depending on UE capability. The UE may report a BWP delay time type that is supportable to the base station.

When the UE receives the DCI including the BWP switch indicator in slot n according to the requirements for the BWP switch delay time, the UE may complete a switch to a new BWP indicated by the BWP switch indicator at a time not later than slot n+T_{BWP}, and may perform transmission and reception with respect to a data channel scheduled by the corresponding DCI in the switched new BWP. When the base station intends to schedule the data channel to the new BWP, the base station may determine a time domain resource assignment for the data channel by considering the BWP switch delay time (T_{BWP}) of the UE. That is, the base station may schedule the corresponding data channel after the BWP switch delay time according to the method for determining time domain resource assignment for the data channel. Therefore, the UE may not expect the DCI indicating the BWP switch to indicate a slot offset (K0 or K2) value less than the BWP switch delay time (T_{BWP}).

If the UE receives the DCI (for example, DCI format 1_1 or 0_1) indicating the BWP switch, the UE may not perform transmission or reception during a time interval from a third symbol of the slot in which the PDCCH including the DCI is received to a start time of the slot indicated by the slot offset (K0 or K2) value indicated by the time domain resource assignment indicator field in the DCI. For example, if the UE has received the DCI indicating the BWP switch in slot n and the slot offset value indicated by the DCI is K, the UE may not perform transmission or reception from the third symbol of the slot n to the symbol prior to slot (n+K) (i.e., the last symbol of slot (n+K−1)).

PDCCH: Related to DCI

In the 5G system, scheduling information regarding UL data (or a physical uplink shared channel (PUSCH)) or DL data (or a physical downlink shared channel (PDSCH)) may be forwarded from the base station to the terminal through DCI. The terminal may monitor a DCI format for fallback and a DCI format for non-fallback with respect to the PUSCH or PDSCH. The DCI format for fallback may be constituted by a fixed field that is pre-defined between the base station and the terminal, and the DCI format for non-fallback may include a configurable field.

The DCI may be transmitted through the PDCCH after undergoing through a channel coding and modulation process. A cyclic redundancy check (CRC) may be attached to a DCI message payload and may be scrambled by a radio network temporary identifier (RNTI) which corresponds to an identity of the terminal. Different RNTIs may be used according to a purpose of the DCI message, such as UE-specific data transmission, a power control command or a random access response. That is, the RNTI is not explicitly transmitted and is transmitted while being included in a CRC calculation process. When the DCI message transmitted on the PDCCH is received, the terminal may identify the CRC by using an allocated RNTI. When a result of identifying the CRC matches, the terminal may know that the corresponding message is transmitted to the terminal.

For example, DCI for scheduling a PDSCH on system information (SI) may be scrambled by an SI-RNTI. DCI for scheduling a PDSCH for a random access response (PAR) message may be scrambled by an RA-RNTI. DCI for scheduling a PDSCH for a paging message may be scrambled by a P-RNTI. DCI for notifying a slot format indicator (SFI) may be scrambled by an SFI-RNTI. DCI for notifying transmit power control (TPC) may be scrambled by a TPC-RNTI. DCI for scheduling a UE-specific PDSCH or PUSCH may be scrambled by a cell-RNTI (C-RNTI).

A DCI format 0_0 may be used as fallback DCI for scheduling the PUSCH, and in this case, the CRC may be scrambled by the C-RNTI. The DCI format 0_0 in which the CRC is scrambled by the C-RNTI may include information shown below in Table 4.

TABLE 4
- Identifier for DCI formats - [1] bit
- Frequency domain _resource assignment - [┌log₂ (N_{RB}^{UL, BWP}) (N_{RB}^{DL, BWP} + 1)/2)┐ ] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- TPC (transmit power control) command for scheduled PUSCH - [2] bits
- UL/SUL (supplementary UL) indicator - 0 or 1 bit

A DCI format 0_1 may be used as non-fallback DCI for scheduling the PUSCH, and in this case, the CRC may be scrambled by the C-RNTI. The DCI format 0_1 in which the CRC is scrambled by the C-RNTI may include information shown below in Table 5.

```
TABLE 5
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
      • For resource allocation type 0, ┌N_{RB}^{UL,BWP} / P┐ bits
      • For resource allocation type 1,
          ┌log2 (N_{RB}^{UL,BWP} + 1)/2)┐ bits
- Time domain resource assignment -1, 2, 3, or 4 bits
- VRB-to-PRB (virtual resource block -to- physical resource block) mapping
          - 0 or 1 bit only for resource allocation type 1.
      • 0 bit if only resource allocation type 0 is configured;
      • 1 bit otherwise.
- Frequency hopping flag - 0 or 1 bit, only for resource allocation type 1.
      • 0 bit if only resource allocation type 0 is configured;
      • 1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
      • 1 bit for semi-static HARQ-ACK codebook;
      • 2 bits for dynamic HARQ-ACK codebook with single HARQ-ACK codebook.
- 2nd downlink assignment index - 0 or 2 bits
      • 2 bits for dynamic HARQ-ACK codebook with two HARQ-ACK sub-codebooks;
      • 0 bit otherwise.
- TPC command for scheduled PUSCH - 2 bits
      $\cdot ‐ S R S resource indicator - ⌈ {log}_{2} ( {\sum }_{k = 1}^{{L}_{SRS}} ( \begin{matrix}{N}_{SRS} \\ k\end{matrix} ) ) ⌉ or ⌈ {log}_{2} ( {N}_{SRS} ) ⌉ bits$
      $\cdot ⌈ {log}_{2} ( {\sum }_{k = 1}^{{L}_{SRS}} ( \begin{matrix}{N}_{SRS} \\ k\end{matrix} ) ) ⌉ bits for non - codebook based PUSCH transmission ;$
      • ┌log₂ (N_{SRS} )┐ bits for codebook based PUSCH transmission.
- Precoding information and number of layers -up to 6 bits
- Antenna ports - up to 5 bits
- SRS request - 2 bits
- CSI request - 0, 1, 2, 3, 4, 5, or 6 bits
- CBG (code block group) transmission information - 0, 2, 4, 6, or 8 bits
- PTRS-DMRS association (Phase tracking reference signal-Demodulation reference signal association) - 0 or 2 bits.
- beta_offset indicator - 0 or 2 bits
- DMRS sequence initialization - 0 or 1 bit
```

A DCI format 0_1 may be used as fallback DCI for scheduling the PDSCH, and in this case, the CRC may be scrambled by the C-RNTI. The DCI format 0_1 in which the CRC is scrambled by the C-RNTI may include information shown below in Table 6.

TABLE 6
- Identifier for DCI formats - [1] bit
- Frequency domain resource assignment - [┌log₂ (N_{RB}^{DL,BWP} (N_{RB}^{DL,BWP} +1)/2)┐ ] bits
- Time domain resource assignment - X bits
- VRB-to-PRB mapping - 1 bit.
- Modulation and coding scheme - 5 bits
- New data Indicator - 1 bit
- Redundancy version - 2 bits
- HARQ process number - 4 bits
- Downlink assignment index - 2 bits
- TPC command for scheduled PUCCH - [2] bits
- PUCCH (physical uplink control channel, PUCCH) resource indicator - 3 bits
- PDSCH-to-HARQ feedback timing indicator - [3] bits

A DCI format 1_1 may be used as non-fallback DCI for scheduling the PDSCH, and in this case, the CRC may be scrambled by the C-RNTI. The DCI format 1_1 in which the CRC is scrambled by the C-RNTI may include information shown below in Table 7

TABLE 7

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{DL,BWP} /P┐ bits |
| | • | For resource allocation type 1, ┌log2 (N_{RB}^{DL,BWP} |
| | | (N_{RB}^{DL,BWP} +1)/2)┐ bits |
| - | Time domain resource assignment -1, 2, 3, or 4 bits. | |
| - | VRB-to-PRB mapping - 0 or 1 bit, only for resource allocation | |
| | type 1. | |
| | • | 0 bit if only resource allocation type 0 is configured; |
| | • | 1 bit otherwise. |

| | |
|---|---|
| - | PRB (Physical resource block) bundling size indicator - 0 or 1 bit |
| - | Rate matching indicator - 0, 1, or 2 bits |
| - | ZP CSI-RS (Zero power channel state information reference signal) |
| | trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG (Code block group) flushing out information - 0 or 1 bit |
| - | DMRS sequence initialization - 1 bit |

QCL, TCI State

In the wireless communication system, one or more different antenna ports (or channels, signals, and combinations thereof) may be associated with each other by a quasi co-location (QCL) configuration as shown below in Table 8. The TCI state is for announcing a QCL relationship between a PDCCH (or PDCCH DMRS) and another RS or channel, and a certain reference antenna port A (reference RS #A) and another target antenna port B (target RS #B) are QCLed denotes that the UE is allowed to apply some or all of the large-scale channel parameters estimated from the antenna port A to the channel measurement from the antenna port B. QCL is required to correlate different parameters, depending on situations, such as time tracking affected by average delay and delay spread, frequency tracking affected by Doppler shift and Doppler spread, radio resource management (RRM) affected by average gain, and beam management (BM) affected by spatial parameters. Accordingly, NR supports four types of QCL relationships as shown below in Table 8.

TABLE 8

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may collectly refer to some or all of various parameters, such as angle of arrival (AoA), power angular spectrum (PAS) of AoA, angle of departure (AoD), PAS of AoD, transmit/receive channel correlation, transmit/receive beamforming, and spatial channel correlation.

The QCL relationship can be configured for the UE through the RRC parameters TCI-State and QCL-Info as shown below in Table 9. Referring to Table 9, the base station may configure one or more TCI states for the UE and inform the UE of up to two QCL relationships (qcl-Type1, qcl-Type2) for RS referring to the ID of the TCI state or target RS. Pieces of QCL information (QCL-Info) included in each TCI state includes the serving cell index and BWP index of the reference RS indicated by the corresponding QCL information, the type and ID of the reference RS, and the QCL type as shown above in Table 8.

TABLE 9

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) referring to
corresponding TCI state ID)

| | | |
|---|---|---|
| qcl-Type2 | QCL-Info | OPTIONAL, -- |

```
Need R
  (QCL information of second reference RS of RS (target RS) referring to
corresponding TCI state ID)
  ...
}
```

| QCL-Info ::= | SEQUENCE { | |
|---|---|---|
| cell | ServCellIndex | OPTIONAL, -- Need R |

```
  (Serving cell index of reference RS indicated by corresponding QCL
  information)
```

| | | |
|---|---|---|
| bwp-Id | BWP-Id | OPTIONAL, -- Cond |
| | | CSI-RS-Indicated |

```
  (BWP index of reference RS indicated by corresponding QCL
  information)
```

| | |
|---|---|
| reference Signal | CHOICE { |
| csi-rs | NZP-CSI-RS-ResourceId, |
| ssb | SSB-Index |

```
    (One of CSI-RS ID and SSB ID indicated by corresponding QCL
information)
  },
```

| | |
|---|---|
| qcl-Type | ENUMERATED {typeA, typeB, typeC, typeD}, |

...
}

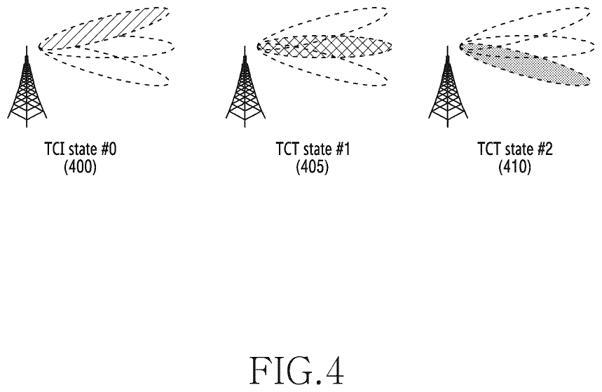

FIG. 4 illustrates base station beam allocation according to a TCI state according to an embodiment.

Referring to FIG. 4, a base station may transfer pieces of information relating to N number of different beams through N number of different TCI states to a terminal. For example, if N is 3, the base station may allow a qcl-Type 2 parameter included in each of three TCI states 400, 405, and 410 to be associated with a channel state information reference signal (CSI-RS) or synchronization signal block (SSB) corresponding to different beams and to be configured to be of QCL type D, so as to notify that antenna ports referring to the different TCI states 400, 405, and 410 are associated with different spatial Rx parameters or beams.

Tables 10 to 14 below show valid TCI state configurations according to target antenna port types.

Table 10 below shows valid TCI state configuration when the target antenna port is CSI-RS for tracking (TRS). The TRS refers to a non-zero power (NZP) CSI-RS, in which a repetition parameter is not configured and trs-Info is configured to be true, among CSI-RSs. Configuration 3 in Table 10 may be used for aperiodic TRS.

TABLE 10

| Valid | | | | |
|---|---|---|---|---|
| TCI state | | | | |
| Config- | DL | | DL RS 2 | qcl-Type2 |
| uration | RS 1 | qcl-Type1 | (if configured) | (if configured) |
| 1 | SSB | QCL-TypeC | SSB | QCL-TypeD |
| 2 | SSB | QCL-TypeC | CSI-RS (BM) | QCL-TypeD |
| 3 | TRS | | TSR (same as | QCL-TypeD |
| | (periodic) | | DL RS 1) | |

Table 11 below shows valid TCI state configuration when the target antenna port is CSI-RS for CSI. The CSI-RS for CSI refers to an NZP CSI-RS, in which a parameter (e.g., a repetition parameter) indicating repetition is not configured and trs-Info is not configured to be true, among CSI-RSs.

TABLE 11

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as DL RS 1) | QCL-TypeD |
| 4 | TRS | QCL-TypeB | | |

Table 12 below shows a valid TCI state configuration when a target antenna port is CSI-RS for beam management (BM, which has the same meaning as CSI-RS for L1 reference signal received power (RSRP) reporting). The CSI-RS for BM denotes an NZP CSI-RS, in which a repetition parameter is configured and has a value of On or Off, and trs-Info is not configured to be true, among CSI-RSs.

TABLE 12

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | TRS (same as DL RS 1) | QCL-TypeD |
| 2 | TRS | QCL-TypeA | CSI-RS (BM) | QCL-TypeD |
| 3 | SS/PBCH Block | QCL-TypeC | SS/PBCH Block | QCL-TypeD |

Table 13 below shows a valid TCI state configuration when a target antenna port is a PDCCH DMRS.

TABLE 13

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | TRS (same as DL RS 1) | QCL-TypeD |
| 2 | TRS | QCL-TypeA | CSI-RS (BM) | QCL-TypeD |
| 3 | CSI-RS (CSI) | QCL-TypeA | CSI-RS (same as DL RS 1) | QCL-TypeD |

Table 14 below shows a valid TCI state configuration when the target antenna port is a PDSCH DMRS.

TABLE 14

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS (CSI) | QCL-TypeA | CSI-RS (CSI) | QCL-TypeD |

In the representative QCL configuration method according to Tables 10 to 14, a target antenna port and a reference antenna port for each stage are configured to be “SSB”->“TRS”->“CSI-RS for CSI, CSI-RS for BM, PDCCH DMRS, or PDSCH DMRS”. Accordingly, it is possible to link the statistical characteristics that can be measured from the SSB and the TRS to each of antenna ports to help the reception operation of a UE.

PDSCH: Regarding Frequency Resource Allocation

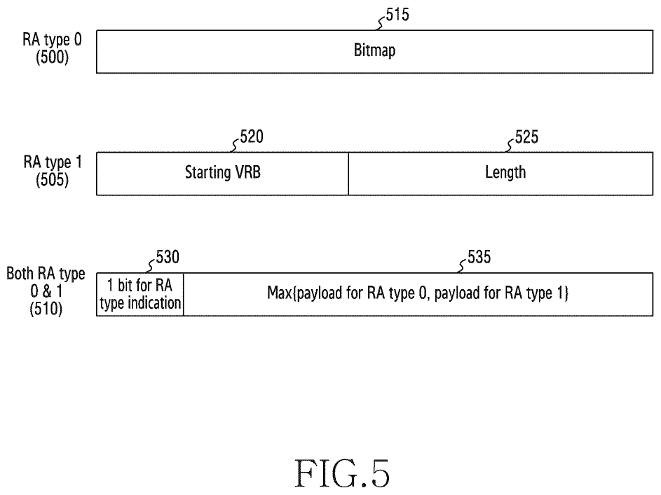

FIG. 5 illustrates frequency-axis resource allocation of a PDSCH in a wireless communication system according to an embodiment.

FIG. 5 illustrates three frequency-axis resource allocation methods including a type 0 5-00, a type 1 5-05, and a dynamic switch 5-10 which are configurable through a higher layer in an NR wireless communication system.

Referring to FIG. 5, in case that the terminal is configured to use only a resource type 0 500 through a higher layer signaling, some pieces of downlink control information (DCI) for allocating the PDSCH to the corresponding terminal include a bitmap configured by NRBG bits. In this case, N_RBG refers to the number of resource block groups (RBGs) which are determined according to a BWP size allocated by a BWP indicator and a higher layer parameter rbg-Size as shown below in Table 15, and data may be transmitted in the RGB displayed as “1” by a bitmap.

TABLE 15

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In case that the terminal is configured to use only a resource type 1 505 through a higher layer signaling (indicated by reference numeral 5-05), some pieces of DCI for allocating the PDSCH to the corresponding terminal include frequency-axis resource allocation information which is configured by ┌log₂(N_{RB}^{DL,BWP}(N_{RB}^{DL,BWP}+1)/2┐ bits. Through this, the base station may configure starting VRB 5-20 and a length of a frequency-axis resource 5-25 consecutively allocated therefrom.

If the terminal is configured to use all of the resource type 0 500 and the resource type 1 505 through a higher layer signaling 510, some pieces of DCI for allocating the PDSCH to the corresponding terminal includes frequency-axis resource allocation information which is configured by bits of a large value 535 out of a payload 515 for configuring the resource type 0 and a payload 520, 525 for configuring the resource type 1. In this case, one bit 530 may be added to the head portion or most significant bit (MSB) of the frequency-axis resource allocation information in the DCI, and, if the corresponding bit 530 is “0,” it is indicated that the resource type 0 500 is used, and, if the corresponding bit is “1,” it is indicated that the resource type 1 505 is used.

PDSCH/PUSCH: Regarding Time Resource Allocation

The base station may configure a table regarding time domain resource allocation information regarding a DL data channel (PDSCH) and a UL data channel (PUSCH) for the terminal through a higher layer signaling (for example, an RRC signaling). With respect to the PDSCH, a table including a maximum of 16 (=maxNrofDL-Allocations) entries may be configured, and, with respect to the PUSCH, a table including a maximum of 16 (=maxNrofUL-Allocations) entries may be configured. The time domain resource allocation information may include a PDCCH-to-PDSCH slot timing (corresponding to a time interval of a slot unit between a time point at which a PDCCH is received and a time point at which a PDSCH scheduled by the PDCCH is transmitted, expressed by K0), a PDCCH-to-PUSCH slot timing (corresponding to a time interval of a slot unit between a time point at which a PDCCH is received and a time point at which a PUSCH scheduled by the received PDCCH is transmitted, expressed by K2), information regarding a location and a length of a start symbol in which the PDSCH or PUSCH is scheduled in a slot, a mapping type of the PDSCH or PUSCH, and the like. For example, information shown below in Table 16 and Table 17 may be transmitted from the base station to the terminal.

TABLE 16
PDSCH-TimeDomainResourceAllocationList information element

PDSCH-TimeDomainResourceAllocationList ::= SEQUENCE
(SIZE(1..maxNrofDL-Allocations)) OF PDSCH-TimeDomainResourceAllocation

| | |
|---|---|
| PDSCH-TimeDomainResourceAllocation ::= | SEQUENCE { |
| k0 | INTEGER(0..32) |

OPTIONAL, -- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 17
PUSCH-TimeDomainResourceAllocation information element

PUSCH-TimeDomainResourceAllocationList ::= SEQUENCE
(SIZE(1..maxNrofUL-Allocations) OF PUSCH-TimeDomainResourceAllocation
PUSCH-TimeDomainResourceAllocation ::= SEQUENCE {

| | |
|---|---|
| k2 | INTEGER(0..32) |

OPTIONAL, -- Need S
e

| | |
|---|---|
| mappingType | ENUMERATED {typeA, typeB}, |

(PUSCH mapping type)

| | |
|---|---|
| startSymbolAndLength | INTEGER (0..127) |

(Start symbol and length of PUSCH)
}

The base station may notify the terminal of one of the entries of the table regarding the time domain resource allocation information described above through an L1 signaling (for example, DCI) (for example, indicated by a “time domain resource allocation” field in DCI). The terminal may obtain time domain resource allocation information regarding a PDSCH or PUSCH based on DCI received from the base station.

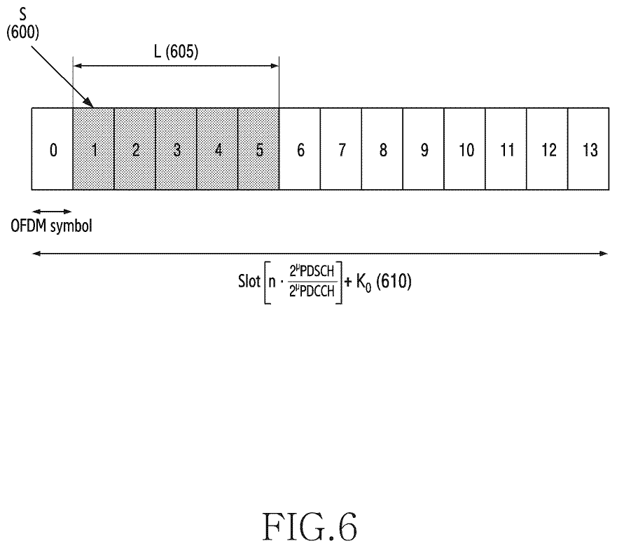

FIG. 6 illustrates time-axis resource allocation of a PDSCH in a wireless communication system according to an embodiment.

Referring to FIG. 6, the base station may indicate a time axis location of a PDSCH resource according to subcarrier spacings (SCSs) (μ_{PDSCH}, μ_{PDCCH}) of a data channel and a control channel, which are configured by using a higher layer, a scheduling offset (K0) value 610, and a start position 600 and a length 605 of an OFDM symbol in one slot which is dynamically indicated through DCI.

PDSCH: TCI State Activation MAC-CE

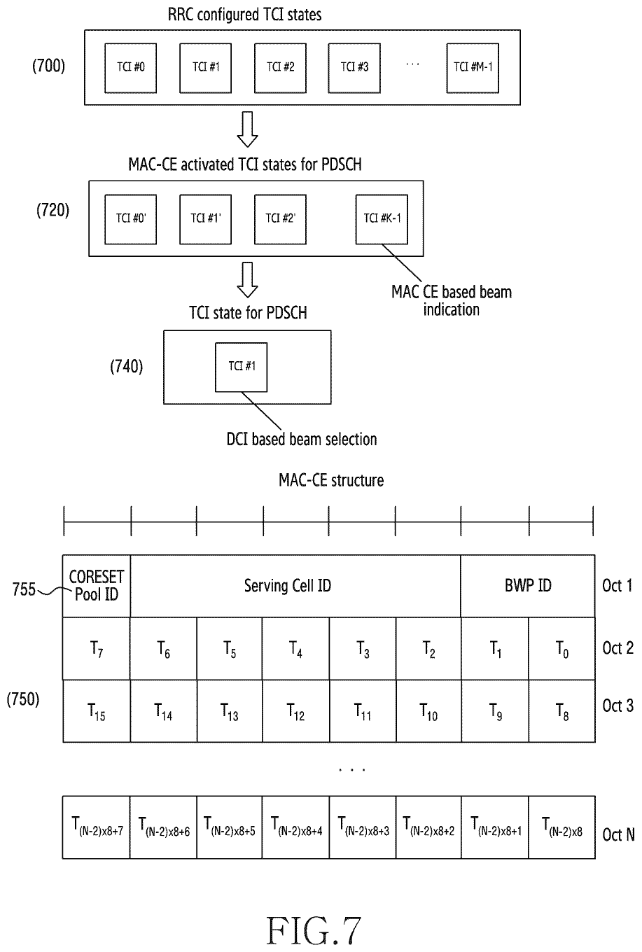

FIG. 7 illustrates a process for beam configuration and activation of a PDSCH according to an embodiment. A list of TCI states for the PDSCH may be indicated though a higher layer list, such as RRC 700. The TCI state list may be indicated as tci-StateosToAddModList and/or tci-StatesToReleaseList within a PDSCH-Config IE for each BWP. Subsequently, some of the TCI states in the TCI state list may be activated though a MAC-CE 720. Among the TCI states activated through the MAC-CE, the TCI state for the PDSCH may be indicated through DCI 740. The maximum number of activated TCI states may be determined according to a capability reported by the UE. Reference numeral 750 shows a MAC-CE format for PDSCH TCI state activation/deactivation.

The meaning of each field within the MAC CE and a value configurable in each field are as described below in Table 18.

TABLE 18
Serving Cell ID: This field indicates the identity of the Serving Cell for which
the MAC CE applies. The length of the field is 5 bits. If the indicated Serving Cell is
configured as part of a simultaneousTCI-UpdateList1 or simultaneousTCI-UpdateList2
as specified in TS 38.331 [5], this MAC CE applies to all the Serving Cells configured
in the set simultaneousTCI-UpdateList1 or simultaneousTCI-UpdateList2 respectively;
BWP ID: This field indicates a DL BWP for which the MAC CE applies as the
codepoint of the DCI bandwidth part indicator field as specified in TS 38.212 [9]. The length of
the BWP ID field is 2 bits. This field is ignored if this MAC CE applies to a set of Serving
Cells;
Ti: If there is a TCI state with TCI-StateId i as specified in TS 38.331 [5], this
field indicates the activation/deactivation status of the TCI state with TCI-StateId i,
otherwise MAC entity shall ignore the Ti field. The Ti field is set to 1 to indicate that the
TCI state with TCI-StateId i shall be activated and mapped to the codepoint of the DCI
Transmission Configuration Indication field, as specified in TS 38.214 [7]. The Ti field
is set to 0 to indicate that the TCI state with TCI-StateId i shall be deactivated and is not
mapped to the codepoint of the DCI Transmission Configuration Indication field. The
codepoint to which the TCI State is mapped is determined by its ordinal position among
all the TCI States with Ti field set to 1, i.e. the first TCI State with Ti field set to 1 shall
be mapped to the codepoint value 0, second TCI State with Ti field set to 1 shall be
mapped to the codepoint value 1 and so on. The maximum number of activated TCI
states is 8;
CORESET Pool ID: This field indicates that mapping between the activated TCI
states and the codepoint of the DCI Transmission Configuration Indication set by field
Ti is specific to the ControlResourceSetId configured with CORESET Pool ID as
specified in TS 38.331 [5]. This field set to 1 indicates that this MAC CE shall be applied
for the DL transmission scheduled by CORESET with the CORESET pool ID equal to
1, otherwise, this MAC CE shall be applied for the DL transmission scheduled by
CORESET pool ID equal to 0. If the coresetPoolIndex is not configured for any
CORESET, MAC entity shall ignore the CORESET Pool ID field in this MAC CE when
receiving the MAC CE. If the Serving Cell in the MAC CE is configured in a cell list
that contains more than one Serving Cell, the CORESET Pool ID field shall be ignored
when receiving the MAC CE.

PUCCH: Regarding Transmission

In the NR system, a terminal may transmit UCI to the base station through a PUCCH. The control information may include at least one of hybrid automatic repeat request acknowledgement (HARQ-ACK) indicating success or failure of demodulation/decoding for a transport block (TB) received by the UE through a PDSCH, scheduling request (SR) for requesting, by the terminal, resource allocation from a base station through a PUSCH for uplink data transmission, and channel state information (CSI), which is information for reporting the channel state of the terminal.

The PUCCH resource may be largely divided into a long PUCCH and a short PUCCH according to the length of the allocated symbol. In the NR system, the long PUCCH has a length of 4 symbols or more in a slot, and the short PUCCH has a length of 2 symbols or less in a slot.

The long PUCCH may be used for the purpose of improving uplink cell coverage, and thus may be transmitted in a DFT-S-OFDM scheme, which is a single carrier transmission rather than an OFDM transmission. The long PUCCH supports transmission formats such as PUCCH format 1, PUCCH format 3, and PUCCH format 4 depending on the number of supportable control information bits and whether terminal multiplexing through Pre-DFT OCC support at the front end of the IFFT is supported.

The PUCCH format 1 is a DFT-S-OFDM-based long PUCCH format capable of supporting up to 2 bits of control information, and uses as much frequency resources as 1RB. The control information may be configured by each of or a combination of HARQ-ACK and SR. In PUCCH format 1, an OFDM symbol including a demodulation reference signal (DMRS) and an OFDM symbol including UCI are repeatedly configured.

For example, when the number of transmission symbols of PUCCH format 1 is 8 symbols, the first start symbol of 8 symbols is sequentially configured by DMRS symbol, UCI symbol, DMRS symbol, UCI symbol, DMRS symbol, UCI symbol, DMRS symbol, and UCI symbol. The DMRS symbol may be spread using an orthogonal code (or orthogonal sequence or spreading code, wᵢ(m)) on the time axis to a sequence corresponding to the length of 1RB on the frequency axis within one OFDM symbol, and may be transmitted after performing IFFT.

The UCI symbol is generated as follows. The terminal generates d(0) by BPSK modulating 1-bit control information and QPSK modulating 2-bit control information, multiplies the generated d(0) by a sequence corresponding to the length of 1 RB on the frequency axis to scramble, spreads the scrambled sequence using an orthogonal code (or an orthogonal sequence or spreading code, wᵢ(m)) on the time axis, and transmits the same after performing the IFFT.

The terminal generates the sequence, based on the group hopping or sequence hopping configuration and the configured ID configured via higher layer signaling from the base station, and generates a sequence corresponding to a length of 1 RB by cyclic shifting the generated sequence with an initial cyclic shift (CS) value configured as a higher layer signal

The wᵢ(m) is determined as

$${w}_{i} ( m ) = {e}^{\frac{j 2 π ( m )}{{N}_{SF}}}$$

when the length of the spreading code (NSF) is given, and specifically shown below in Table 19. In the above, i denotes the index of the spreading code itself, and m denotes the index of the elements of the spreading code. The numbers within the brackets of Table 19 denote φ(m) in case that the length of the spreading code is 2 and the index of the configured spreading code is i=0, the spreading code wᵢ(m) becomes wᵢ(0)=e^{j2π·0/N}^{_{SF}}=1, wᵢ(1)=e^{j2π·0/N}^{_{SF}}=1, and wᵢ(m)=[1 1].

TABLE 19
Spreading code for PUCCH format 1 w [symbol] (m) = e

[symbol]

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

[symbol]

indicates data missing or illegible when filed

PUCCH format 3 is a DFT-S-OFDM-based long PUCCH format capable of supporting more than 2 bits of control information, and the number of RBs used can be configured through a higher layer. The control information may be configured by each of or a combination of HARQ-ACK, SR, and CSI. In PUCCH format 3, the location of the DMRS symbol is presented in below in Table 20, depending on whether frequency hopping is enabled within the slot and whether additional DMRS symbols are configured.

TABLE 20

| | DMRS position within PUCCH format 3/4 transmission | | | |
|---|---|---|---|---|
| | No additional DMRS | | Additional DMRS | |
| Transmission | configured | | configured | |
| length of | No frequency | Frequency | No frequency | Frequency |
| PUCCH | hopping | hopping | hopping | hopping |
| format 3/4 | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, when the number of transmission symbols of the PUCCH format 3 is 8 symbols, the first start symbol of the 8 symbols starts with 0, and the DMRS is transmitted in the first symbol and the fifth symbol. Table 20 is applied in the same manner as the DMRS symbol position of PUCCH format 4.

PUCCH format 4 is a DFT-S-OFDM-based long PUCCH format capable of supporting more than 2 bits of control information, and uses as much frequency resources as 1RB. The control information may be composed of each or a combination of HARQ-ACK, SR, and CSI. The difference between PUCCH format 4 and PUCCH format 3 is that in case of PUCCH format 4, PUCCH format 4 of multiple terminals can be multiplexed within one RB. It is possible to multiplex PUCCH format 4 of multiple terminals through application of pre-DFT orthogonal cover code (OCC) to control information in the front of the IFFT. However, the number of transmittable control information symbols of one terminal decreases according to the number of multiplexed terminals. The number of multiplexable terminals, that is, the number of different OCCs that can be used, may be 2 or 4, and the number of OCCs and the OCC index to be applied may be configured through a higher layer.

The short PUCCH may be transmitted in both a downlink centric slot and an uplink centric slot. In general, the short PUCCH may be transmitted at the last symbol of the slot or an OFDM symbol at the end (e.g., the last OFDM symbol, the second OFDM symbol from the end, or the last 2 OFDM symbols). It is also possible to transmit the short PUCCH at any location in the slot. In addition, the short PUCCH may be transmitted using one OFDM symbol or two OFDM symbols. The short PUCCH may be used to shorten a delay time compared to the long PUCCH when uplink cell coverage is good, and is transmitted in a CP-OFDM scheme.

The short PUCCH may support transmission formats such as PUCCH format 0 and PUCCH format 2 according to the number of supportable control information bits. PUCCH format 0 is a short PUCCH format capable of supporting up to 2 bits of control information, and uses frequency resources of 1 RB. The control information may be composed of each or a combination of HARQ-ACK and SR. PUCCH format 0 does not transmit DMRS, but transmits only sequences mapped to 12 subcarriers in the frequency axis within one OFDM symbol. The terminal generates a sequence, based on the group hopping or sequence hopping configuration and configured ID configured as a higher layer signal from the base station, cyclic shifts the generated sequence to the final cyclic shift (CS) value obtained by adding another CS value according to whether it is ACK or NACK to the indicated initial CS value, maps the sequence to 12 subcarriers, and transmits the same.

For example, in case that HARQ-ACK is 1 bit, as shown below in Table 21, if it is ACK, the terminal may add 6 to the initial CS value to generate the final CS, and if NACK, the terminal may add 0 to the initial CS to generate the final CS. The CS value of 0 for NACK and the CS value of 6 for ACK are defined in the standard, and the terminal may generate PUCCH format 0 according to the value defined in the standard to transmit 1-bit HARQ-ACK.

TABLE 21

| 1-bit HARQ-ACK | NACK | ACK |
|---|---|---|
| Final CS | (Initial CS + 0) mod | (Initial CS + 6) |
| | 12 = Initial CS | mod 12 |

For example, in case that HARQ-ACK is 2 bits, the terminal may add 0 to the initial CS value if (NACK, NACK) as shown below in Table 22, may add 3 to the initial CS value if (NACK, ACK), may add 6 to the initial CS value if (ACK, ACK), and may add 9 to the initial CS value if (ACK, NACK). The CS value 0 for (NACK, NACK), 3 for the CS value for (NACK, ACK), 6 for the CS value for (ACK, ACK), and 9 for the CS value for (ACK, NACK) are defined in the standard. The terminal may transmit a 2-bit HARQ-ACK by generating PUCCH format 0 according to the value defined in the standard. In case that the final CS value exceeds 12 by the CS value, which is added to the initial CS value according to ACK or NACK, the sequence length is 12, and thus modulo 12 may be applied to the final CS value.

TABLE 22

| 2-bit | NACK, | NACK, | ACK, | ACK, |
|---|---|---|---|---|
| HARQ-ACK | NACK | ACK | ACK | NACK |
| Final CS | (Initial | (Initial | (Initial | (Initial |
| | CS + 0) | CS + 3) | CS + 6) | CS + 9) |
| | mod 12 = | mod 12 | mod 12 | mod 12 |
| | Initial CS | | | |

PUCCH format 2 is a short PUCCH format that supports more than 2 bits of control information, and the number of RBs used may be configured through a higher layer. The control information may be composed of a combination of HARQ-ACK, SR, and CSI, or each of them. In PUCCH format 2, the position of the subcarrier through which the DMRS is transmitted within one OFDM symbol is fixed to the subcarrier having indexes of #1, #4, #7, and #10, when the index of the first subcarrier is #0. The control information is mapped to the remaining subcarriers through a modulation process after channel coding except for the subcarrier where the DMRS is located.

Values that may be configured for each of the above-described PUCCH formats and their ranges may be arranged as shown below in Table 23. The value that does not need to be configured in Table 23 is indicated as N.A.

TABLE 23

| | | PUCCH | PUCCH | PUCCH | PUCCH | PUCCH |
|---|---|---|---|---|---|---|
| | | Format 0 | Format 1 | Format 2 | Format 3 | Format 4 |
| Starting symbol | Configurability | [symbol] | [symbol] | [symbol] | [symbol] | [symbol] |
| | Value range | 0-13 | 0-10 | 0-13 | 0-10 | 0-10 |
| Number of | Configurability | [symbol] | [symbol] | [symbol] | [symbol] | [symbol] |
| Symbols in a slot | Value range | 1, 2 | 4-14 | 1, 2 | 4-14 | 4-14 |
| Index for | Configurability | [symbol] | [symbol] | [symbol] | [symbol] | [symbol] |
| identifying | Value range | 0-274 | 0-274 | 0-274 | 0-274 | 0-274 |
| starting PRB | | | | | | |
| Number of PRBs | Configurability | N.A. | N.A. | [symbol] | [symbol] | N.A. |
| | Value range | N.A.(Default is 1) | N.A.(Default is 1) | 1-16 | 1-6, 8-10, 12, 15, 16 | N.A.(Default is 1) |
| Enabling | Configurability | [symbol] | [symbol] | [symbol] | [symbol] | [symbol] |
| frequency | Value range | On/Off (only | On/Off | On/Off (only | On/Off | On/Off |
| hopping | | for 2 symbol) | | for 2 symbol) | | |
| (intra-slot) | | | | | | |
| Freq cy resource | Configurability | [symbol] | [symbol] | [symbol] | [symbol] | [symbol] |
| of 2^{nd} hop if | Value range | 0-274 | 0-274 | 0-274 | 0-274 | 0-274 |
| intra-slot | | | | | | |
| frequency | | | | | | |
| hopping is | | | | | | |
| enabled | | | | | | |
| Index of initial | Configurability | [symbol] | [symbol] | N.A. | N.A. | N.A. |
| cyclic shift | Value range | 0-11 | 0-11 | N.A. | N.A. | N.A. |
| Index of time- | Configurability | N.A. | [symbol] | N.A. | N.A. | N.A. |
| domain OCC | Value range | N.A. | 0-6 | N.A. | N.A. | N.A. |
| Length of | Configurability | N.A. | N.A. | N.A. | N.A. | [symbol] |
| Pre-DFT OCC | Value range | N.A. | N.A. | N.A. | N.A. | 2, 4 |
| Index of Pre- | Configurability | N.A. | N.A. | N.A. | N.A. | [symbol] |
| DFT OCC | Value range | N.A. | N.A. | N.A. | N.A. | 0, 1, 2, 3 |

[symbol]

indicates data missing or illegible when filed

To improve uplink coverage, multi-slot repetition may be supported for PUCCH formats 1, 3, and 4, PUCCH repetition may be configured for each PUCCH format. The terminal may repeatedly transmit the PUCCH including UCI as many as the number of slots configured through nrofSlots, which is higher layer signaling. For the repetitive PUCCH transmission, the PUCCH transmission in each slot may be performed using the same number of consecutive symbols, and the number of the corresponding consecutive symbols may be configured through a nrofSymbols in PUCCH format 1, PUCCH format 3, or PUCCH format 4, which is higher layer signaling. For the repetitive PUCCH transmission, the PUCCH transmission in each slot may be performed using the same start symbol, and the corresponding start symbol may be configured through a startingSymbolIndex in PUCCH format 1, PUCCH format 3, or PUCCH format 4, which is higher layer signaling. For the repetitive PUCCH transmission, single PUCCH-spatialRelationInfo may be configured for a single PUCCH resource. For the repetitive PUCCH transmission, if the terminal has been configured to perform frequency hopping in PUCCH transmission in different slots, the terminal may perform frequency hopping in units of slots. If the terminal has been configured to perform frequency hopping in the PUCCH transmission in different slots, the terminal may start the PUCCH transmission from the first PRB index configured through startingPRB, which is higher layer signaling, in the even-numbered slot, and the terminal may start the PUCCH transmission from the second PRB index configured through secondHopPRB, which is higher layer signaling, in the odd-numbered slot. Additionally, if the terminal is configured to perform frequency hopping in PUCCH transmission in different slots, the index of the slot in which the terminal is instructed to transmit the first PUCCH is 0, and during the configured total number of repetitive PUCCH transmissions, the value of the number of repetitive PUCCH transmissions is increased in each slot regardless of the PUCCH transmission performed. If the terminal is configured to perform frequency hopping in PUCCH transmission in different slots, the terminal does not expect that frequency hopping in the slot is configured when transmitting the PUCCH. If the terminal is not configured to perform frequency hopping in PUCCH transmission in different slots but is configured for frequency hopping in a slot, the first and second PRB indexes are applied equally in the slot. If the number of uplink symbols capable of performing PUCCH transmission is lower than nrofSymbols configured for higher layer signaling, the terminal may not transmit the PUCCH. Even if the terminal fails to transmit the PUCCH for some reason in a slot during PUCCH repetitive transmission, the terminal may increase the number of PUCCH repetitive transmissions.

PUCCH: PUCCH Resource Configuration

The base station may configure PUCCH resources for each BWP through a higher layer for a specific terminal, as shown below in Table 24.

TABLE 24

| | |
|---|---|
| PUCCH-Config ::= | SEQUENCE { |
| resourceSetToAddModList | SEQUENCE (SIZE (1..maxNrofPUCCH-ResourceSets)) OF |
| PUCCH-ResourceSet | OPTIONAL, -- Need N |
| resourceSetToReleaseList | SEQUENCE (SIZE (1..maxNrofPUCCH-ResourceSets)) OF |

PUCCH-ResourceSetId OPTIONAL, -- Need N

| resourceToAddModList | SEQUENCE (SIZE (1..maxNrofPUCCH-Resources)) OF | |
|---|---|---|
| PUCCH-Resource | OPTIONAL, -- Need N | |
| resourceToReleaseList | SEQUENCE (SIZE (1..maxNrofPUCCH-Resources)) OF | |
| PUCCH-ResourceId | OPTIONAL, -- Need N | |
| format1 | SetupRelease { PUCCH-FormatConfig } | OPTIONAL, -- Need M |
| format2 | SetupRelease { PUCCH-FormatConfig } | OPTIONAL, -- Need M |
| format3 | SetupRelease { PUCCH-FormatConfig } | OPTIONAL, -- Need M |
| format4 | SetupRelease { PUCCH-FormatConfig } | OPTIONAL, -- Need M |
| schedulingRequestResourceToAddModList | SEQUENCE (SIZE (1..maxNrofSR-Resources)) OF | |
| SchedulingRequestResourceConfig | | OPTIONAL, -- Need N |
| schedulingRequestResourceToReleaseList | SEQUENCE (SIZE (1..maxNrofSR-Resources)) OF | |
| SchedulingRequestResourceId | | OPTIONAL, -- Need N |
| multi-CSI-PUCCH-ResourceList | SEQUENCE (SIZE (1..2)) OF PUCCH-ResourceId | OPTIONAL, -- Need M |
| dl-DataToUL-ACK | SEQUENCE (SIZE (1..8)) OF INTEGER (0..15) | OPTIONAL, -- Need M |
| spatialRelationInfoToAddModList | SEQUENCE (SIZE (1..maxNrofSpatialRelationInfos)) OF | |
| PUCCH-SpatialRelationInfo | | OPTIONAL, -- Need N |
| spatialRelationInfoToReleaseList | SEQUENCE (SIZE (1..maxNrofSpatialRelationInfos)) OF | |
| PUCCH-SpatialRelationInfoId | | OPTIONAL, -- Need N |
| pucch-PowerControl | PUCCH-PowerControl | OPTIONAL, -- Need M |

```
  ...,
  [[
```

| | |
|---|---|
| resourceToAddModListExt-r16 | SEQUENCE (SIZE (1..maxNrofPUCCH-Resources)) OF |

PUCCH-ResourceExt-r16 OPTIONAL, -- Need N

| dl-DataToUL-ACK-r16 | SetupRelease { DL-DataToUL-ACK-r16 } | OPTIONAL, -- Need M |
|---|---|---|
| ul-AccessConfigListDCI-1-1-r16 | SetupRelease { UL-AccessConfigListDCI-1-1-r16 } | OPTIONAL, -- Need M |
| subslotLengthForPUCCH-r16 | CHOICE { | |
| normalCP-r16 | ENUMERATED {n2,n7}, | |
| extendedCP-r16 | ENUMERATED {n2,n6} | |
| } | | OPTIONAL, -- Need R |
| dl-DataToUL-ACK-DCI-1-2-r16 | SetupRelease { DL-DataToUL-ACK-DCI-1-2-r16} | OPTIONAL, -- Need M |
| numberOfBitsForPUCCH-ResourceIndicatorDCI-1-2-r16 INTEGER (0..3) | | OPTIONAL, -- Need R |
| dmrs-UplinkTransformPrecodingPUCCH-r16 | ENUMERATED {enabled} | OPTIONAL, |
| | | -- Cond PI2-BPSK |
| spatialRelationInfoToAddModListSizeExt-v1610 | SEQUENCE (SIZE (1..maxNrofSpatialRelationInfosDiff-r16)) | |
| OF PUCCH-SpatialRelationInfo | | OPTIONAL, -- Need N |
| spatialRelationInfoToReleaseListSizeExt-v1610 | SEQUENCE (SIZE (1..maxNrofSpatialRelationInfosDiff-r16)) OF | |
| PUCCH-SpatialRelationInfoId | | OPTIONAL, -- Need N |
| spatialRelationInfoToAddModListExt-v1610 | SEQUENCE (SIZE (1..maxNrofSpatialRelationInfos-r16) OF | |
| PUCCH-SpatialRelationInfoExt-r16 | | OPTIONAL, -- Need N |
| spatialRelationInfoToReleaseListExt-v1610 | SEQUENCE (SIZE (1..maxNrofSpatialRelationInfos-r16)) OF | |
| PUCCH-SpatialRelationInfoId-r16 | OPTIONAL, -- Need N | |
| resourceGroupToAddModList-r16 | SEQUENCE (SIZE (1..maxNrofPUCCH-ResourceGroups-r16)) OF | |
| PUCCH-ResourceGroup-r16 | | OPTIONAL, -- Need N |
| resourceGroupToReleaseList-r16 | SEQUENCE (SIZE (1..maxNrofPUCCH-ResourceGroups-r16)) OF | |
| PUCCH-ResourceGroupId-r16 | | OPTIONAL, -- Need N |
| sps-PUCCH-AN-List-r16 | SetupRelease { SPS-PUCCH-AN-List-r16 } | OPTIONAL, -- Need M |

| | |
|---|---|
| schedulingRequestResourceToAddModListExt-v1610 | SEQUENCE (SIZE (1..maxNrofSR-Resources)) OF |

| | |
|---|---|
| SchedulingRequestResourceConfigExt-v1610 | OPTIONAL -- Need N |

]]
}

In Table 24, one or a plurality of PUCCH resource sets in the PUCCH resource configuration for a specific BWP may be configured, and a maximum payload value for UCI transmission may be configured in some of the PUCCH resource sets. Each PUCCH resource set may belong to one or more PUCCH resources, and each of the PUCCH resources may belong to one of the above-described PUCCH formats.

For the PUCCH resource set, the maximum payload value of the first PUCCH resource set may be fixed to 2 bits, and thus the corresponding value may not be separately configured through a higher layer. When the remaining PUCCH resource set is configured, the index of the corresponding PUCCH resource set may be configured in ascending order according to the maximum payload value, and the maximum payload value may not be configured in the last PUCCH resource set. The higher layer configuration for the PUCCH resource set is shown below in Table 25.

TABLE 25

| | |
|---|---|
| PUCCH-ResourceSet ::= | SEQUENCE { |
| pucch-ResourceSetId | PUCCH-ResourceSetId, |
| resourceList | SEQUENCE (SIZE (1..maxNrofPUCCH-ResourcesPerSet)) OF |

PUCCH-ResourceId,

| | |
|---|---|
| maxPayloadSize | INTEGER (4..256) |

OPTIONAL -- Need R
}

The resourceList parameter of the Table 25 may include IDs of PUCCH resources belonging to the PUCCH resource set.

If at the time of initial access or in case that the PUCCH resource set is not configured, a PUCCH resource set as shown below in Table 26, which is composed of a plurality of cell-specific PUCCH resources in the initial BWP, may be used. The PUCCH resource to be used for initial access in this PUCCH resource set may be indicated through SIB1.

TABLE 26

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

The maximum payload of each of PUCCH resources included in the PUCCH resource set may be 2 bits in case of PUCCH format 0 or 1, and may be determined by a symbol length, the number of PRBs, and a maximum code rate in case of the remaining formats. The symbol length and number of PRBs may be configured for each PUCCH resource, and the maximum code rate may be configured for each PUCCH format.

In a case of SR transmission, a PUCCH resource for an SR corresponding to schedulingRequestID may be configured through a higher layer as shown below in Table 27. The PUCCH resource may be a resource belonging to PUCCH format 0 or PUCCH format 1.

TABLE 27

| SchedulingRequestResourceConfig ::= | SEQUENCE { | |
|---|---|---|
| schedulingRequestResourceId | SchedulingRequestResourceId, | |
| schedulingRequestID | SchedulingRequestId, | |
| periodicityAndOffset | CHOICE { | |
| sym2 | NULL, | |
| sym6or7 | NULL, | |
| sl1 | NULL, | -- Recurs in every slot |
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639) | |
| } | | OPTIONAL, -- Need M |
| resource | PUCCH-ResourceId | OPTIONAL -- Need M |

}

For the configured PUCCH resource, a transmission period and an offset may be configured through the periodicityAndOffset parameter of Table 27. When there is uplink data to be transmitted by the terminal at a time corresponding to the configured period and offset, the corresponding PUCCH resource is transmitted. Otherwise, the corresponding PUCCH resource may not be transmitted.

In the case of CSI transmission, a PUCCH resource for transmitting a periodic or semi-persistent CSI report through PUCCH may be configured in the pucch-CSI-ResourceList parameter as shown below in Table 28. The pucch-CSI-ResourceList parameter may include a list of PUCCH resources for each BWP for the cell or CC to which the corresponding CSI report is to be transmitted. The PUCCH resource may belong to PUCCH format 2, PUCCH format 3, or PUCCH format 4. For the PUCCH resource, a transmission period and an offset may be configured through reportSlotConfig of Table 28.

TABLE 28

| CSI-ReportConfig ::== | SEQUENCE { | |
|---|---|---|
| reportConfigId | CSI-ReportConfigId, | |
| carrier | ServCellIndex | OPTIONAL, -- Need S |

...

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs) OF |

PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs) OF |

PUCCH-CSI-Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1.. maxNrofUL-Allocations)) OF INTEGER(0..32), |
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations) OF INTEGER(0..32) |

```
    }
  },
  ...
}
```

In the case of HARQ-ACK transmission, a resource set of PUCCH resources to be transmitted may be first selected according to the payload of the UCI including the corresponding HARQ-ACK. That is, a PUCCH resource set having a minimum payload not lower than the UCI payload may be selected. Next, the PUCCH resource in the PUCCH resource set may be selected through a PUCCH resource indicator (PRI) in the DCI scheduling the TB corresponding to the corresponding HARQ-ACK, and the PRI may be the PUCCH resource indicator specified as shown above in Table 6 or Table 7. The relationship between the PRI and the PUCCH resource selected from the PUCCH resource set is shown below in Table 29.

TABLE 29

| PUCCH resource | |
|---|---|
| indicator | PUCCH resource |
| ‘000’ | 1^{st} PUCCH resource provided by pucch-ResourceId |
| | obtained from the 1^{st} value of resourceList |
| ‘001’ | 2^{nd} PUCCH resource provided by pucch-ResourceId |
| | obtained from the 2^{nd} value of resourceList |
| ‘010’ | 3^{rd} PUCCH resource provided by pucch-ResourceId |
| | obtained from the 3^{rd} value of resourceList |
| ‘011’ | 4^{th} PUCCH resource provided by pucch-ResourceId |
| | obtained from the 4^{th} value of resourceList |
| ‘100’ | 5^{th} PUCCH resource provided by pucch-ResourceId |
| | obtained from the 5^{th} value of resourceList |
| ‘101’ | 6^{th} PUCCH resource provided by pucch-ResourceId |
| | obtained from the 6^{th} value of resourceList |
| ‘110’ | 7^{th} PUCCH resource provided by pucch-ResourceId |
| | obtained from the 7^{th} value of resourceList |
| ‘111’ | 8^{th} PUCCH resource provided by pucch-ResourceId |
| | obtained from the 8^{th} value of resourceList |

If the number of PUCCH resources in the selected PUCCH resource set is greater than 8, the PUCCH resource may be selected by the following Equation (1).

$${r}_{PUCCH} = \qquad ( 1 )$$

$$\{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot \\ ⌊ \frac{{R}_{PUCCH}}{8} ⌋ + {R}_{PUCCH} mod 8\end{matrix} & if {Δ}_{PRI} \geq {R}_{PUCCH} mod 8\end{matrix} \}$$

In Equation (1), r_{PUCCH} is the index of the selected PUCCH resource in the PUCCH resource set, R_{PUCCH} is the number of PUCCH resources belonging to the PUCCH resource set, Δ_{PRI} is the PRI value, N_{CCE,p} is the total number of CCEs of the CORESET p to which the receiving DCI belongs, and n_{CCE,p} indicates the first CCE index for the reception DCI.

The time point at which the corresponding PUCCH resource is transmitted is after the K₁ slot from the TB transmission corresponding to the corresponding HARQ-ACK. The K₁ value candidate may be configured as a higher layer, and more specifically, may be configured in the dl-DataToUL-ACK parameter in the PUCCH-Config specified in Table 27. The K₁ value of one of these candidates may be selected by the PDSCH-to-HARQ feedback timing indicator in the DCI scheduling the TB, and may be specified as shown above in Table 5 or Table 6. The unit of the K₁ value may be a slot unit or a sub slot unit. A sub slot is a unit of a length lower than that of a slot, and one or a plurality of symbols may constitute one sub slot.

The terminal may transmit UCI through one or two PUCCH resources in one slot or sub slot. When UCI is transmitted through two PUCCH resources in one slot/sub slot, each PUCCH resource does not overlap in units of symbols, and at least one PUCCH resource may be a short PUCCH. The terminal may not expect to transmit a plurality of PUCCH resources for HARQ-ACK transmission within one slot.

PUCCH: Regarding Transmission Beam

If a terminal does not have a terminal-specific configuration for PUCCH resource configuration (dedicated PUCCH resource configuration), the PUCCH resource set is provided through the higher layer signaling, pucch-ResourceCommon. The beam configuration for PUCCH transmission follows the beam configuration used in PUSCH transmission scheduled through the random access response (RAR) UL grant. If a terminal has a terminal-specific configuration for PUCCH resource configuration (dedicated PUCCH resource configuration), the beam configuration for PUCCH transmission may be provided through pucch-spatialRelationInfold, which is the higher layer signaling shown above in Table 24. If the terminal has been configured with one pucch-spatialRelationInfold, beam configuration for PUCCH transmission of the terminal may be provided through one pucch-spatialRelationInfold. If the terminal is configured with a plurality of pucch-spatialRelationInfoIDs, the terminal may be instructed to activate one of the plurality of pucch-spatialRelationInfoIDs through a MAC control element (CE). The terminal may receive up to eight pucch-spatialRelationInfoIDs through higher layer signaling, and may receive an indication that only one pucch-spatialRelationInfoID among them is activated. In case that the terminal is instructed to activate any pucch-spatialRelationInfoID through the MAC CE, the terminal may apply pucch-spatialRelationInfoID activation through MAC CE from a slot that first appears after 3Nₛₗₒₜ^{subframe,μ} slot from a slot in which HARQ-ACK transmission for a PDSCH that transmits MAC CE including activation information for pucch-spatialRelationInfoID. In this slot, μ is a neurology applied to PUCCH transmission, and Nₛₗₒₜ^{subframe,μ} denotes the number of slots per subframe in a given neurology. The higher layer configuration for pucch-spatialRelationInfo is shown below in Table 30.

TABLE 30

| PUCCH-SpatialRelationInfo ::= | SEQUENCE { | |
|---|---|---|
| pucch-SpatialRelationInfoId | PUCCH-SpatialRelationInfold, | |
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | PUCCH-SRS |

},

| | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}

| | |
|---|---|
| PUCCH-SpatialRelationInfold ::= | INTEGER (1..maxNrofSpatialRelationInfos) |

In Table 30, one referenceSignal configuration may exist in a specific pucch-spatialRelationInfo configuration, and the referenceSignal may be ssb-Index indicating a specific SS/PBCH, csi-RS-Index indicating a specific CSI-RS, or srs indicating a specific SRS. If the referenceSignal is configured as ssb-Index, the terminal may configure the beam used when receiving the SS/PBCH corresponding to the ssb-Index among SS/PBCHs in the same serving cell as a beam for PUCCH transmission. If servingCellId is provided, the terminal may configure the beam used when receiving an SS/PBCH corresponding to an ssb-Index among SS/PBCHs in a cell indicated by servingCellId as abeam for pucch transmission. If the referenceSignal is configured as csi-RS-Index, the terminal may configure the beam used when receiving a CSI-RS corresponding to csi-RS-Index among CSI-RSs in the same serving cell as a beam for PUCCH transmission. If servingCellId is provided, the terminal may configure the beam used when receiving a CSI-RS corresponding to csi-RS-Index among CSI-RSs in a cell indicated by servingCellId as a beam for pucch transmission. If the referenceSignal is configured to srs, the terminal may configure the transmission beam used when transmitting the SRS corresponding to the resource index provided as an higher layer signaling resource in the same serving cell and/or in the activated uplink BWP as a beam for PUCCH transmission. If the servingCellID and/or uplinkBWP is provided, the terminal may configure the transmission beam used when transmitting the SRS corresponding to the resource index provided through the higher layer signaling resource in the cell indicated by the servingCellID and/or uplinkBWP and/or in the uplink BWP as a beam for PUCCH transmission. One pucch-PathlossReferenceRS-Id configuration may exist in a specific pucch-spatialRelationInfo configuration. PUCCH-PathlossReferenceRS as shown below in Table 31 may be mapped to pucch-PathlossReferenceRS-Id of Table 30 above, and up to 4 may be configured through pathlossReferenceRSs in the higher layer signaling PUCCH-PowerControl of Table 31. If the PUCCH-PathlossReferenceRS is connected to the SS/PBCH through the referenceSignal, ssb-Index may be configured, and if PUCCH-PathlossReferenceRS is connected to CSI-RS, csi-RS-Index may be configured.

TABLE 31

| PUCCH-PowerControl ::= | SEQUENCE { | |
|---|---|---|
| deltaF-PUCCH-f0 | INTEGER (−16..15) | OPTIONAL, -- Need R |
| deltaF-PUCCH-f1 | INTEGER (−16..15) | OPTIONAL, -- Need R |
| deltaF-RUCCH-f2 | INTEGER (−16..15) | OPTIONAL, -- Need R |
| deltaF-PUCCH-f3 | INTEGER (−16..15) | OPTIONAL, -- Need R |
| deltaF-PUCCH-f4 | INTEGER (−16..15) | OPTIONAL, -- Need R |

| | |
|---|---|
| p0-Set | SEQUENCE (SIZE (1..maxNrofPUCCH-P0-PerSet)) P0-PUCCH |

OPTIONAL, -- Need M

| pathlossReferenceRSs | SEQUENCE (SIZE (1..maxNrofPUCCH-PathlossReferenceRSs) OF | |
|---|---|---|
| PUCCH-PathlossReferenceRS | | OPTIONAL, -- Need M |
| twoPUCCH-PC-AdjustmentStates | ENUMERATED {twoStates} | OPTIONAL, -- Need S |

```
  ...,
  [[
```

| | | |
|---|---|---|
| pathlossReferenceRSs-v1610 | SetupRelease { PathlossReferenceRSs-v1610 } | OPTIONAL -- Need M |

]]
}

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |
| PathlossReferenceRSs-v1610 ::= | SEQUENCE (SIZE (1..maxNrofPUCCH-PathlossReferenceRSsDiff-r16) OF |

PUCCH-PathlossReferenceRS-r16

| | |
|---|---|
| PUCCH-PathlossReferenceRS ::= | SEQUENCE { |
| pucch-PathlossReferenceRS-Id | PUCCH-PathlossReferenceRS-Id, |
| referenceSignal | CHOICE { |
| ssb-Index | SSB-Index, |
| csi-RS-Index | NZP-CSI-RS-ResourceId |

}
}

| | |
|---|---|
| PUCCH-PathlossReferenceRS-r16 ::= | SEQUENCE { |
| pucch-PathlossReferenceRS-Id-r16 | PUCCH-PathlossReferenceRS-Id-v1610, |
| referenceSignal-r16 | CHOICE { |
| ssb-Index-r16 | SSB-Index, |
| csi-RS-Index-r16 | NZP-CSI-RS-ResourceId |

}
}

PUCCH: Group-Based Spatial Relation Activation

In NR Release 15 (Rel.15), if a terminal has configured with multiple pucch-spatialRelationInfoIDs, the terminal may receive a MAC CE to activate the spatial relation per PUCCH resource so as to determine the spatial relation of the corresponding PUCCH resource. However, this method has the disadvantage of requiring a large signaling overhead to activate the spatial relation of multiple PUCCH resources. Therefore, in NR Release 16 (Rel.16), PUCCH resource groups are added and a new MAC CE for activating spatial relations in the PUCCH resource group unit is introduced. Up to four PUCCH resource groups may be configured through the resourceGroupToAddModList shown above in Table 24, and each PUCCH resource group may configure, as a list, multiple PUCCH resource Ids within one PUCCH resource group as shown below in Table 32.

TABLE 32

| | |
|---|---|
| PUCCH-ResourceGroup-r16 ::= | SEQUENCE { |
| pucch-ResourceGroupId-r16 | PUCCH-ResourceGroupld-r16, |
| resourcePerGroupList-r16 | SEQUENCE (SIZE (1..maxNrofPUCCH-ResourcesPerGroup-r16) |

OF PUCCH-ResourceId
}

| | |
|---|---|
| PUCCH-ResourceGroupId-r16 ::= | INTEGER (0..maxNrofPUCCH-ResourceGroups-1-r16) |

In Rel-16, a base station may configure each PUCCH resource group in a terminal through the resourceGroupToAddModList shown above in Table 24 and the higher layer configuration of Table 32, and may configure a MAC CE for simultaneous activation of the spatial relations of all PUCCH resources in one PUCCH resource group.

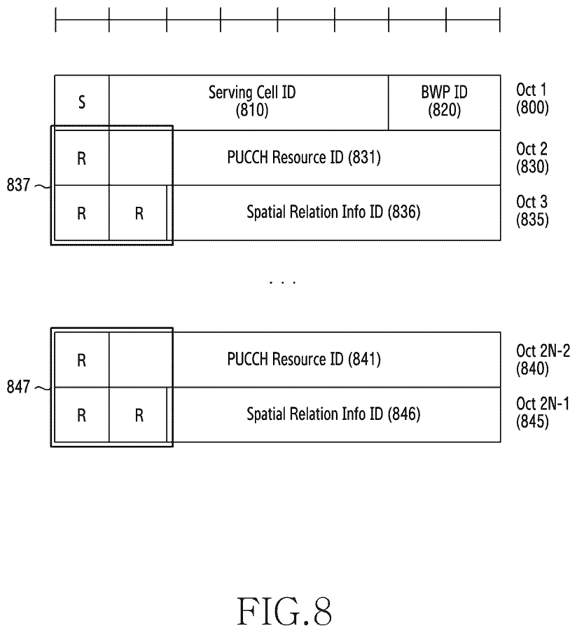

FIG. 8 illustrates a MAC CE for activating a PUCCH resource group-based spatial relation in a wireless communication system according to an embodiment.

Referring to FIG. 8, a support (serving) cell ID 810 and a bandwidth part ID 820, configured with PUCCH resources through which the corresponding MAC CE is to be applied, are indicated by octet (Oct) 1 800. PUCCH resource IDs 831 and 841 indicate the ID of the PUCCH resource, and each of PUCCH resource IDs 831 and 841 are included in Oct 2 830 and Oct 2N−2 840, respectively. If the indicated PUCCH resource is included in a PUCCH resource group according to the resourceGroupToAddModList, other PUCCH resource IDs in the same PUCCH resource group are not indicated by the same MAC CE, and all PUCCH resources in the same PUCCH resource group are activated with the same spatial relation info IDs 836 and 846 which include a value corresponding to PUCCH-SpatialRelationInfold−1 to be applied to the PUCCH resource group shown above in Table 30, and each of spatial relation info IDs 836 and 846 are included in Oct 3 835 and Oct 2N−1 845, respectively. 837 and 847 are reserved field.

SRS Related

A base station may configure at least one SRS configuration for each UL BWP to deliver configuration information for SRS transmission to the terminal, and may also configure at least one SRS resource set for each SRS configuration. For example, the base station and the terminal may exchange the following higher layer signaling information to deliver information about the SRS resource set.

srs-ResourceSetId: SRS resource set index

srs-ResourceIdList: A set of SRS resource indexes referenced in the SRS resource set

resourceType: This is the time axis transmission configuration of the SRS resource referenced in the SRS resource set, and may be configured as one of periodic, semi-persistent, and aperiodic. In case that the resourceType is configured as periodic or semi-persistent, associated CSI-RS information may be provided according to the usage of the SRS resource set. If the resourceType is configured as aperiodic, an aperiodic SRS resource trigger list and slot offset information may be provided, and associated CSI-RS information may be provided according to the usage of the SRS resource set.

usage: This is the configuration for the usage of the SRS resource referenced in the SRS resource set, and may be configured to one of beamManagement, codebook, nonCodebook, and antennaSwitching.

alpha, p0, pathlossReferenceRS, srs-PowerControlAdjustmentStates: This provides a parameter configuration for adjusting the transmit power of the SRS resource referenced in the SRS resource set.

The terminal may understand that the SRS resource included in the set of SRS resource indexes referenced in the SRS resource set follows information configured in the SRS resource set.

In addition, the base station and the terminal may transmit and receive higher layer signaling information to deliver individual configuration information for the SRS resource. For example, the individual configuration information for the SRS resource may include time-frequency domain mapping information within a slot of the SRS resource, which may include information about frequency hopping within a slot or between slots of the SRS resource. The individual configuration information for the SRS resource may include the time domain transmission configuration of the SRS resource, and may be configured to be one of periodic, semi-persistent, and aperiodic. This may be limited to have the same time domain transmission configuration as the SRS resource set including the SRS resource. In case that the time domain transmission configuration of the SRS resource is configured as periodic or semi-persistent, the SRS resource transmission period and slot offset (e.g., periodicityAndOffset) may be additionally included in the time domain transmission configuration.

The base station may activate, deactivate, or trigger the SRS transmission to the terminal through higher layer signaling including RRC signaling or MAC CE signaling, or L1 signaling (e.g., DCI). For example, the base station may activate or deactivate the periodic SRS transmission through higher layer signaling to the terminal. The base station may instruct, through higher layer signaling, to activate the SRS resource set in which the resourceType is configured as periodic, and the terminal may transmit the SRS resource referenced in the activated SRS resource set. The time-frequency domain resource mapping of the SRS resource transmitted in the slot follows the resource mapping information configured in the SRS resource, and the slot mapping including the transmission period and the slot offset follows the periodicityAndOffset configured in the SRS resource. The spatial domain transmission filter applied to the SRS resource transmitted may refer to the spatial relation info configured in the SRS resource or to the associated CSI-RS information configured in the SRS resource set including the SRS resource. The terminal may transmit the SRS resource in the UL BWP activated for the periodic SRS resource activated through higher layer signaling.

For example, the base station may activate or deactivate the semi-persistent SRS transmission through higher layer signaling to the terminal. The base station may instruct to activate the SRS resource set through MAC CE signaling, and the terminal may transmit the SRS resource referenced in the activated SRS resource set. The SRS resource set activated through MAC CE signaling may be limited to the SRS resource set in which the resourceType is configured as semi-persistent. The time-frequency domain resource mapping of the SRS resource transmitted in the slot follows the resource mapping information configured in the SRS resource, and the slot mapping including the transmission period and the slot offset follows the periodicityAndOffset configured in the SRS resource. The spatial domain transmission filter applied to the SRS resource transmitted may refer to the spatial relation info configured in the SRS resource or to the associated CSI-RS information configured in the SRS resource set including the SRS resource. In case that the spatial relation info is configured in the SRS resource, the spatial relation info configured in the SRS resource may not be used, and the spatial domain transmission filter may be determined by referring to the configuration information for the spatial relation info delivered through MAC CE signaling that activates the semi-persistent SRS transmission. The terminal may transmit the SRS resource within the UL BWP activated for the semi-persistent SRS resource activated through higher layer signaling.

For example, the base station may trigger the aperiodic SRS transmission to the terminal through the DCI. The base station may indicate one of aperiodic SRS resource triggers (aperiodicSRS-ResourceTrigger) through the SRS request field of the DCI. The terminal may understand, in the configuration information of the SRS resource set, that the SRS resource set including the aperiodic SRS resource trigger indicated through the DCI in the aperiodic SRS resource trigger list is triggered, and may transmit the SRS resource referenced in the triggered SRS resource set. The time-frequency domain resource mapping of the SRS resource transmitted in the slot follows the resource mapping information configured in the SRS resource. In addition, the slot mapping of the SRS resource transmitted may be determined through the slot offset between the PDCCH including DCI and the SRS resource, which may refer to the value(s) included in the slot offset set configured in the SRS resource set. Specifically, the slot offset between the PDCCH including DCI and the SRS resource may apply a value indicated in the time domain resource assignment field of the DCI among the offset value(s) included in the slot offset set configured in the SRS resource set. The spatial domain transmission filter applied to the SRS resource transmitted may refer to the spatial relation info configured in the SRS resource or to the associated CSI-RS information configured in the SRS resource set including the SRS resource. The terminal may transmit the SRS resource within the UL BWP activated for the aperiodic SRS resource triggered through the DCI.

In case that the base station triggers the aperiodic SRS transmission to the terminal through the DCI, in order for the terminal to transmit the SRS by applying the configuration information for the SRS resource, a minimum time interval may be required between the PDCCH including the DCI triggering the aperiodic SRS transmission and the transmitted SRS. The time interval for the SRS transmission of the terminal may be defined as the number of symbols between the last symbol of the PDCCH including the DCI triggering the aperiodic SRS transmission and the first symbol to which the SRS resource transmitted first among the transmitted SRS resource(s) is mapped. The minimum time interval may be determined with reference to the PUSCH preparation procedure time required for the terminal to prepare PUSCH transmission. The minimum time interval may have a different value depending on the usage of the SRS resource set including the transmitted SRS resource. For example, the minimum time interval may be determined as N2 symbols defined in consideration of the UE processing capability according to the UE capability by making reference to the PUSCH preparation procedure time of the UE. In consideration of the usage of the SRS resource set including the transmitted SRS resource, in case that the usage of the SRS resource set is configured as codebook or antennaSwitching, the minimum time interval may be determined as N2 symbols. In case that the usage of the SRS resource set is configured as nonCodebook or beamManagement, the minimum time interval may be determined as (N2+14) symbols. The UE may transmit the aperiodic SRS when the time interval for aperiodic SRS transmission is greater than or equal to the minimum time interval, and may ignore the DCI triggering the aperiodic SRS when the time interval for aperiodic SRS transmission is less than the minimum time interval.

TABLE 33

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

sequenceHopping },

| | |
|---|---|
| resourceType | CHOICE { |
| aperiodic | SEQUENCE ( |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

OPTIONAL, -- Need R
...
}

The spatialRelationInfo configuration information shown above in Table 33 refers to one reference signal and applies beam information of the reference signal to a beam used for the corresponding SRS transmission. For example, the configuration of spatialRelationInfo may include information as shown below in Table 34.

TABLE 34

| SRS-SpatialRelationInfo ::= | SEQUENCE { | |
|---|---|---|
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the spatialRelationInfo configuration, an SS/PBCH block index, a CSI-RS index, or an SRS index may be configured as an index of a reference signal to be referenced in order to use the beam information of a specific reference signal. The higher layer signaling referenceSignal is configuration information indicating which reference signal beam information is to be referred to for the corresponding SRS transmission, ssb-Index is the index of the SS/PBCH block, csi-RS-Index is the index of the CSI-RS, and srs is the index of the SRS. In case that the value of the higher layer signaling referenceSignal is configured as ssb-Index, the UE may apply the reception beam, having been used when receiving the SS/PBCH block corresponding to the ssb-Index, as the transmission beam of the corresponding SRS transmission. When the value of the higher layer signaling referenceSignal is configured as csi-RS-Index, the UE may apply the reception beam, having been used when receiving the CSI-RS corresponding to the csi-RS-Index, as the transmission beam of the corresponding SRS transmission. When the value of the higher layer signaling referenceSignal is configured as srs, the UE may apply the transmission beam, having been used when transmitting the SRS corresponding to srs, as the transmission beam of the corresponding SRS transmission.

PUSCH: Related to Transmission Scheme

The PUSCH transmission may be dynamically scheduled by a UL grant in the DCI or may be operated by configured grant Type 1 or Type 2. The dynamic scheduling indication for the PUSCH transmission is possible via DCI format 0_0 or 0_1.

The configured grant Type 1 PUSCH transmission may be semi-statically configured by receiving configuredGrantConfig including rrc-ConfiguredUplinkGrant shown below in Table 35 through higher layer signaling without receiving the UL grant in the DCI. The configured grant Type 2 PUSCH transmission may be semi-persistently scheduled by the UL grant in the DCI after receiving configuredGrantConfig that does not include rrc-ConfiguredUplinkGrant of Table 35 through higher layer signaling. In case that the PUSCH transmission is operated by the configured grant, parameters applied to the PUSCH transmission are applied through the higher layer signaling configuredGrantConfig shown below in Table 38 except for dataScramblingIdentityPUSCH, txConfig, codebookSubset, maxRank, and scaling of UCI-OnPUSCH provided as the higher layer signaling pusch-Config shown below in Table 36. In case that the UE is provided with transformPrecoder in the higher layer signaling configuredGrantConfig of Table 35, the UE applies tp-pi2BPSK in pusch-Config of Table 36 for the PUSCH transmission operated by the configured grant.

TABLE 35

| ConfiguredGrantConfig ::= | SEQUENCE { | |
|---|---|---|
| frequencyHopping | ENUMERATED {intraSlot, InterSlot} | OPTIONAL, -- Need S, |
| cg-DMRS-Configuration | DMRS-UplinkConfig, | |
| mcs-Table | ENUMERATED {qam256, qam64LowSE) | OPTIONAL, -- Need S |
| mcs-TableTransformPrecoder | ENUMERATED {qam256, qam64LowSE) | OPTIONAL, -- Need S |
| uci-OnPUSCH | SetupRelease { CG-UCI-OnPUSCH } | OPTIONAL, -- Need M |
| resourceAllocation | ENUMERATED { resourceAllocationType0, resourceAllocationType1, dynamicSwitch }, | |
| rbg-Size | ENUMERATED {config2} | OPTIONAL -- Need S |
| powerControlLoopToUse | ENUMERATED {n0, n1}, | |
| p0-PUSCH-Alpha | P0-PUSCH-AlphaSetId, | |
| transformPrecoder | ENUMERATED {enabled, disabled} | OPTIONAL, -- Need S |
| nrofHARQ-Processes | INTEGER(1..16), | |
| repK | ENUMERATED {n1, n2, n4, n8}, | |
| repK-RV | ENUMERATED {s1-0231, s2-0303, s3-0000} | OPTIONAL, -- Need R |

| | |
|---|---|
| periodicity | ENUMERATED {sym2, sym7, sym1x14, sym2x14, sym4x14, sym5x14, |

sym8x14, sym10x14, sym16x14, sym20x14, sym32x14, sym40x14, sym64x14, sym80x14, sym 128x14, sym160x14,
sym256x14, sym320x14, sym512x14, sym640x14; sym1024x14, sym1280x14, sym2560x14, sym5120x14, sym6,
sym1x12, sym2x12, sym4x12, sym5x12, sym8x12, sym10x12, sym16x12, sym20x12, sym32x12, sym40x12,
sym64x12, sym80x12, sym128x12, sym160x12, sym256x12, sym320x12, sym512x12, sym640x12, sym1280x12,
sym2560x12
},

| configuredGrantTimer | INTEGER (1..64) | OPTIONAL, -- Need R |
|---|---|---|
| rrc-ConfiguredUplinkGrant | SEQUENCE { | |
| timeDomainOffset | INTEGER (0..5119), | |
| timeDomainAllocation | INTEGER (0..15), | |
| frequencyDomainAllocation | BIT STRING (SIZE(18)), | |
| antennaPort | INTEGER (0..31), | |
| dmrs-SeqInitialization | INTEGER (0..1) | OPTIONAL, -- Need R |
| precodingAndNumberOfLayers | INTEGER (0, 63), | |
| srs-ResourceIndicator | INTEGER (0..15) | OPTIONAL, -- Need R |
| mcsAndTBS | INTEGER (0..31), | |
| frequencyHoppingOffset | INTEGER (1..maxNrofPhysicalResourceBlocks−1) | OPTIONAL, -- Need R |

| | |
|---|---|
| pathlossReferenceIndex | INTEGER (0..maxNrofPUSCH-PathlossReferenceRSs−1) |

...

| | |
|---|---|
| } | OPTIONAL, -- Need R |

...
}

A DMRS antenna port for PUSCH transmission is the same as an antenna port for SRS transmission. The PUSCH transmission may follow a codebook-based transmission method and a non-codebook-based transmission method, respectively, depending on whether the value of txConfig in pusch-Config of Table 36, which is higher layer signaling, is codebook or nonCodebook.

As described above, the PUSCH transmission may be dynamically scheduled via DCI format 0_0 or 0_1 and may be semi-statically configured via a configured grant. If the UE receives scheduling for the PUSCH transmission via the DCI format 0_0, the UE performs beam configuration for the PDSCH transmission by using pucch-spatialRelationInfoID corresponding to the UE-specific PUCCH resource corresponding to the minimum ID in the UL BWP activated in the serving cell. In this case, the PUSCH transmission is based on a single antenna port. The UE does not expect scheduling for the PUSCH transmission via the DCI format 0_0 within the BWP in which the PUCCH resource including pucch-spatialRelationInfo is not configured. In case that the UE is not configured with txConfig in pusch-Config of Table 36, the UE does not expect to be scheduled via the DCI format 0_1.

TABLE 36

| PUSCH-Config ::= | SEQUENCE { | |
|---|---|---|
| dataScramblingIdentityPUSCH | INTEGER (0..1023) | OPTIONAL, -- Need S |
| txConfig | ENUMERATED {codebook, nonCodebook} | OPTIONAL, -- Need S |
| dmrs-UplinkForPUSCH-MappingTypeA | SetupRelease { DMRS-UplinkConfig } | OPTIONAL, -- Need M |
| dmrs-UplinkForPUSCH-MappingTypeB | SetupRelease { DMRS-UplinkConfig } | OPTIONAL, -- Need M |
| pusch-PowerControl | PUSCH-PowerControl | OPTIONAL, -- Need M |
| frequencyHopping | ENUMERATED {intraSlot, interSlot} | OPTIONAL, -- Need S |

| | |
|---|---|
| frequencyHoppingOffsetLists | SEQUENCE (SIZE (1..4)) OF INTEGER (1.. |

| | |
|---|---|
| maxNrofPhysicalResourceBlocks−1) | OPTIONAL, -- Need M |

| | |
|---|---|
| resourceAllocation | ENUMERATED { resourceAllocationType0, resourceAllocationType1, |

dynamicSwitch},

| | |
|---|---|
| pusch-TimeDomainAllocationList | SetupRelease { PUSCH-TimeDomainResourceAllocationList } |

OPTIONAL, -- Need M

| pusch-AggregationFactor | ENUMERATED { n2, n4, n8 } | OPTIONAL, -- Need S |
|---|---|---|
| mcs-Table | ENUMERATED {qam256, qam64LowSE} | OPTIONAL, -- Need S |
| mcs-TableTransformPrecoder | ENUMERATED {gam256, qam64LowSE} | OPTIONAL, -- Need S |
| transformPrecoder | ENUMERATED {enabled, disabled} | OPTIONAL, -- Need S |
| codebookSubset | ENUMERATED {fullyAndPartialAndNonCoherent, | |
| partialAndNonCoherent,nonCoherent} | | OPTIONAL, -- Cond codebookBased |
| maxRank | INTEGER (1..4) | OPTIONAL, -- Cond codebookBased |
| rbg-Size | ENUMERATED { config2} | OPTIONAL, -- Need S |
| uci-OnPUSCH | SetupRelease { UCI-OnPUSCH} | OPTIONAL, -- Need M |
| tp-pi2BPSK | ENUMERATED {enabled} | OPTIONAL, -- Need S |

...
}

The codebook-based PUSCH transmission may be dynamically scheduled via DCI format 0_0 or 0_1 and may operate semi-statically via a configured grant. When the codebook-based PUSCH is dynamically scheduled via the DCI format 0_1 or semi-statically configured via the configured grant, the UE determines a precoder for the PUSCH transmission, based on an SRS resource indicator (SRI), a transmission precoding matrix indicator (TPMI), and a transmission rank (the number of PUSCH transmission layers).

In this case, the SRI may be given through the SRS resource indicator field in the DCI or configured through higher layer signaling, srs-ResourceIndicator. Upon the codebook-based PUSCH transmission, the UE is configured with at least one SRS resource and may be configured with up to two SRS resources. When the UE is provided with the SRI through the DCI, the SRS resource indicated by the SRI refers to the SRS resource corresponding to the SRI from among SRS resources transmitted before the PDCCH including the SRI. The TPMI and the transmission rank may be given through the precoding information and number of layers field in the DCI or configured through higher layer signaling, precodingAndNumberOfLayers. The TPMI is used to indicate a precoder applied to the PUSCH transmission. In case that the UE is configured with one SRS resource, the TPMI is used to indicate the precoder to be applied in one configured SRS resource. When the UE is configured with a plurality of SRS resources, the TPMI is used to indicate a precoder to be applied in the SRS resource indicated through the SRI.

The precoder to be used for the PUSCH transmission is selected in an UL codebook having the same number of antenna ports as the value of nrofSRS-Ports in SRS-Config, which is higher layer signaling. In the codebook-based PUSCH transmission, the UE determines a codebook subset, based on the TPMI and codebookSubset in the higher layer signaling, pusch-Config. The CodebookSubset in the pusch-Config, which is higher layer signaling, may be configured with one of fullyAndPartialAndNonCoherent, partialAndNonCoherent, or nonCoherent, based on the UE capability reported by the UE to the base station. In case that the UE reports partialAndNonCoherent as the UE capability, the UE does not expect that the value of higher layer signaling codebookSubset is configured as fullyAndPartialAndNonCoherent. If the UE reports nonCoherent as the UE capability, the UE does not expect that the value of higher layer signaling codebookSubset is configured to fullyAndPartialAndNonCoherent or partialAndNonCoherent. In case that nrofSRS-Ports in the higher layer signaling SRS-ResourceSet indicates two SRS antenna ports, the UE does not expect that the value of higher layer signaling codebookSubset is configured as partialAndNonCoherent.

The UE may be configured with one SRS resource set in which the value of usage in higher layer signaling SRS-ResourceSet is configured as codebook, and one SRS resource in the SRS resource set may be indicated through the SRI. When several SRS resources are configured in the SRS resource set in which the usage value in higher layer signaling SRS-ResourceSet is configured as codebook, the UE expects that the value of nrofSRS-Ports in higher layer signaling SRS-Resource is configured as the same value for all SRS resources.

The UE transmits, to the base station, one or a plurality of SRS resources contained in the SRS resource set in which the value of usage is configured as codebook according to higher layer signaling, and the base station selects one of the SRS resources transmitted by the UE and instructs the UE to perform PUSCH transmission by using the transmission beam information of the selected SRS resource. In this case, in the codebook-based PUSCH transmission, the SRI is used as information for selecting an index of one SRS resource and is contained in the DCI. The base station includes, in the DCI, information indicating the TPMI and rank to be used by the UE for the PUSCH transmission. Using the SRS resource indicated by the SRI, the UE performs the PUSCH transmission by applying the precoder indicated by the rank and TPMI indicated based on the transmit beam of the SRS resource.

The non-codebook-based PUSCH transmission may be dynamically scheduled via DCI format 0_0 or 0_1 and may operate semi-statically via a configured grant. In case that at least one SRS resource is configured in the SRS resource set in which the value of usage in higher layer signaling SRS-ResourceSet is configured as nonCodebook, the UE may receive scheduling of the non-codebook-based PUSCH transmission via the DCI format 0_1.

For the SRS resource set in which the value of usage in higher layer signaling SRS-ResourceSet is configured as nonCodebook, the UE may be configured with one linked NZP CSI-RS resource. The UE may perform the calculation of the precoder for SRS transmission through measurement for the NZP CSI-RS resource linked to the SRS resource set. When a difference between the last received symbol of the aperiodic NZP CSI-RS resource linked to the SRS resource set and the first symbol of the aperiodic SRS transmission in the UE is less than 42 symbols, the UE does not expect that information on the precoder for the SRS transmission is updated.

When the value of resourceType in higher layer signaling SRS-ResourceSet is configured as aperiodic, the linked NZP CSI-RS is indicated by the SRS request, which is a field in DCI format 0_1 or 1_1. If the linked NZP CSI-RS resource is the aperiodic NZP CSI-RS resource, the existence of the linked NZP CSI-RS is indicated when the value of the SRS request field in the DCI format 0_1 or 1_1 is not 00. In this case, the DCI should not indicate cross carrier or cross BWP scheduling. If the value of the SRS request indicates the existence of the NZP CSI-RS, the corresponding NZP CSI-RS is located in a slot in which the PDCCH including the SRS request field is transmitted. In this case, the TCI states configured in the scheduled subcarriers are not configured with QCL-TypeD.

If the periodic or semi-persistent SRS resource set has been configured, the linked NZP CSI-RS may be indicated through the associated CSI-RS in the SRS-ResourceSet, which is higher layer signaling. For the non-codebook-based transmission, the UE does not expect that spatialRelationInfo, which is higher layer signaling for the SRS resource, and associated CSI-RS in SRS-ResourceSet, which is higher layer signaling, are configured together.

In case that a plurality of SRS resources are configured, the UE may determine the precoder and the transmission rank to be applied to the PUSCH transmission, based on the SRI indicated by the base station. In this case, the SRI may be indicated through the SRS resource indicator field in the DCI or configured through higher layer signaling, srs-ResourceIndicator. As with the above-described codebook-based PUSCH transmission, when the UE is provided with the SRI through the DCI, the SRS resource indicated by the SRI refers to the SRS resource corresponding to the SRI from among SRS resources transmitted before the PDCCH including the SRI. The UE may use one or a plurality of SRS resources for SRS transmission, and the maximum number of SRS resources that can be simultaneously transmitted in the same symbol in one SRS resource set is determined by the UE capability reported by the UE to the base station. The SRS resources simultaneously transmitted by the UE occupy the same RB. The UE configures one SRS port for each SRS resource. The SRS resource set in which the value of usage in higher layer signaling SRS-ResourceSet is configured as nonCodebook may be configured with only one, and the SRS resource for the non-codebook-based PUSCH transmission may be configured with up to four.

The base station transmits one NZP-CSI-RS linked to the SRS resource set to the UE, and the UE calculates a precoder to be used when transmitting one or a plurality of SRS resources in the corresponding SRS resource set, based on the result measured upon receiving the corresponding NZP-CSI-RS. The UE applies the calculated precoder when transmitting one or a plurality of SRS resources in the SRS resource set in which usage is configured as nonCodebook to the base station, and the base station selects one or more of the received one or plurality of SRS resources. In the non-codebook-based PUSCH transmission, the SRI indicates an index capable of expressing one of or a combination of a plurality of SRS resources, and the SRI is contained in the DCI. The number of SRS resources indicated by the SRI transmitted by the base station may be the number of PUSCH transmission layers, and the UE transmits the PUSCH by applying the precoder applied to the SRS resource transmission to each layer.

PUSCH: Preparation Procedure Time

In case that the base station schedules the UE to transmit the PUSCH by using DCI format 0_0, 0_1, or 0_2, the UE may need the PUSCH preparation procedure time for transmitting the PUSCH by applying a transmission method (transmission precoding method of SRS resource, number of transmission layers, spatial domain transmission filter) indicated via DCI. In the NR, the PUSCH preparation procedure time is defined in consideration of the above. The PUSCH preparation procedure time of the UE may follow Equation (2) as follows.

T_{proc,2}=max((N₂+d_{2,1}+d₂)(2048+144)κ2^{-μ}T_{c}+Tₑₓₜ+T_{switch},d_{2,2}) (2)

In Equation (2), N₂ indicates the number of symbols determined according to UE processing capability 1 or 2 and numerology μ depending on the UE capability. In case that UE processing capability 1 is reported according to a capability report of the UE, N₂ may have the value shown below in Table 37. In case that UE processing capability 2 is reported and it is configured through higher layer signaling that UE processing capability 2 is available, N₂ may have the value shown below in Table 38.

TABLE 37

| μ | PUSCH preparation time N₂ [symbols] |
|---|---|
| 0 | 10 |
| 1 | 12 |
| 2 | 23 |
| 3 | 36 |

TABLE 38

| μ | PUSCH preparation time N₂ [symbols] |
|---|---|
| 0 | 5 |
| 1 | 5.5 |
| 2 | 11 for frequency range 1 |

Further in Equation (2), d_{2,1} indicates the number of symbols determined as 0 if all resource elements of the first OFDM symbol of PUSCH transmission are configured to include only DM-RS, and determined as 1 otherwise, κ is 64, and μ follows one of μ_{DL} or μ_{UL}, at which T_{proc,2} has a greater value. μ_{DL} denotes a numerology of a downlink in which a PDCCH including DCI for scheduling of a PUSCH is transmitted, and μ_{UL} denotes a numerology of an uplink in which a PUSCH is transmitted.

T_{c} is 1/(Δfₘₐₓ·N_{f}), Δfₘₐₓ=480·10³ Hz, N_{f}=4096

d_{2,2} follows a BWP switching time when DCI for scheduling of the PUSCH indicates BWP switching, and is 0 otherwise.

For the value d₂, if OFDM symbols of a PUCCH having a low priority index and a PUSCH having a high priority index and a PUCCH overlap in time, a d₂ value of the PUSCH having the high priority index is used. Otherwise, d₂ is 0.

For the value Tₑₓₜ, if the terminal uses a shared spectrum channel access scheme, the terminal calculates Tₑₓₜ to apply the same to the PUSCH preparation procedure time. Otherwise, Tₑₓₜ is assumed to be 0.

For the value T_{switch}, in case that an uplink switching interval is triggered, T_{switch} is assumed to be a switching interval time. Otherwise, Tswitch is assumed to be 0.

Considering the influence of the time domain resource mapping information of the PUSCH scheduled via the DCI and the UL-DL timing advance, in case that the first symbol of the PUSCH starts earlier than the first UL symbol where the CP starts after T_{proc,2} from the last symbol of the PDCCH including the DCI scheduling the PUSCH, the base station and the UE determine that the PUSCH preparation procedure time is insufficient. Otherwise, the base station and the UE determine that the PUSCH preparation procedure time is sufficient. The UE may transmit the PUSCH only when the PUSCH preparation procedure time is sufficient, and may ignore the DCI scheduling the PUSCH when the PUSCH preparation procedure time is insufficient.

PUSCH: Related to Repetitive Transmission

The 5G system supports two types of UL data channel repetitive transmission method, i.e., a PUSCH repetitive transmission type A and a PUSCH repetitive transmission type B. The UE may be configured with either PUSCH repetitive transmission type A or PUSCH repetitive transmission B via higher layer signaling.

PUSCH Repetitive Transmission Type A

As described above, a symbol length and the location a start symbol of a UL data channel may be determined in a time domain resource allocation method within one slot, and the base station may notify the UE of the number of repetitive transmissions via higher layer signaling (e.g., RRC signaling) or L1 signaling (e.g., DCI).

The UE may repetitively transmit, in consecutive slots, UL data channels having the same length and start symbol of the UL data channel configured based on the number of repetitive transmissions received from the base station. In this case, when at least one symbol among symbols of a slot that is configured for the UE as DL by the base station or a UL data channel that is configured for the UE is configured as DL, the UE skips transmission of the UL data channel, but counts the number of repeated transmissions of the uplink data channel.

PUSCH Repetitive Transmission Type B

As described above, a length and a start symbol of a UL data channel may be determined in a time domain resource allocation method within one slot, and the base station may notify the UE of the number of repetitive transmissions, numberofrepetitions, via higher layer signaling (e.g., RRC signaling) or L1 signaling (e.g., DCI).

Based on the length and start symbol of the UL data channel configured earlier, nominal repetition of the UL data channel is determined as follows. A slot in which an n-th nominal repetition starts is given by

$${K}_{s} + ⌊ \frac{S + n \cdot L}{{N}_{symb}^{slot}} ⌋ ,$$

and a start symbol in the slot is given by mod(S+n·L, N_{symb}^{slot}). A slot in which the n-th nominal repetition ends is given by

$${K}_{s} + ⌊ \frac{S + ( n + 1 ) \cdot L - 1}{{N}_{symb}^{slot}} ⌋$$

and an end symbol in the slot is given by mod(S+(n+1)·L−1, N_{symb}^{slot}). In this case, n=0, . . . , numberofrepetitions-1, S denotes a start symbol of the configured UL data channel, and L denotes a symbol length of the configured UL data channel. K_{S} indicates a slot in which PUSCH transmission starts, and N_{symb}^{slot} indicates the number of symbols per slot.

The UE determines invalid symbols for the PUSCH repetitive transmission type B. A symbol configured as DL by tdd-UL-DL-ConfigurationCommon or tdd-UL-DL-ConfigurationDedicated is determined as an invalid symbol for the PUSCH repetitive transmission type B. Additionally, the invalid symbol may be configured in a higher layer parameter (e.g., InvalidSymbolPattern). The higher layer parameter (e.g., InvalidSymbolPattern) may provide a symbol-level bitmap spanning one or two slots to configure invalid symbols. In a bitmap, “1” represents an invalid symbol. A period and pattern of the bitmap may be configured in a higher layer parameter (e.g., periodicityAndPattern). When the higher layer parameter (e.g., InvalidSymbolPattern) is configured and parameter InvalidSymbolPatternIndicator-ForDCIFormat0_1 or InvalidSymbolPatternIndicator-ForDCIFormat0_2 indicates 1, the UE applies an invalid symbol pattern. When the parameter indicates 0, the UE does not apply the invalid symbol pattern. When the higher layer parameter (e.g., InvalidSymbolPattern) is configured and the InvalidSymbolPatternIndicator-ForDCIFormat0_1 or InvalidSymbolPatternIndicator-ForDCIFormat0_2 parameter is not configured, the UE applies the invalid symbol pattern.

After an invalid symbol is determined, the UE may, for each nominal repetition, consider symbols other than invalid symbols as valid symbols. When one or more valid symbols are included in each nominal repetition, the nominal repetition may include one or more actual repetitions. In this case, each actual repetition includes a consecutive set of valid symbols available for PUSCH repetitive transmission type B within one slot.

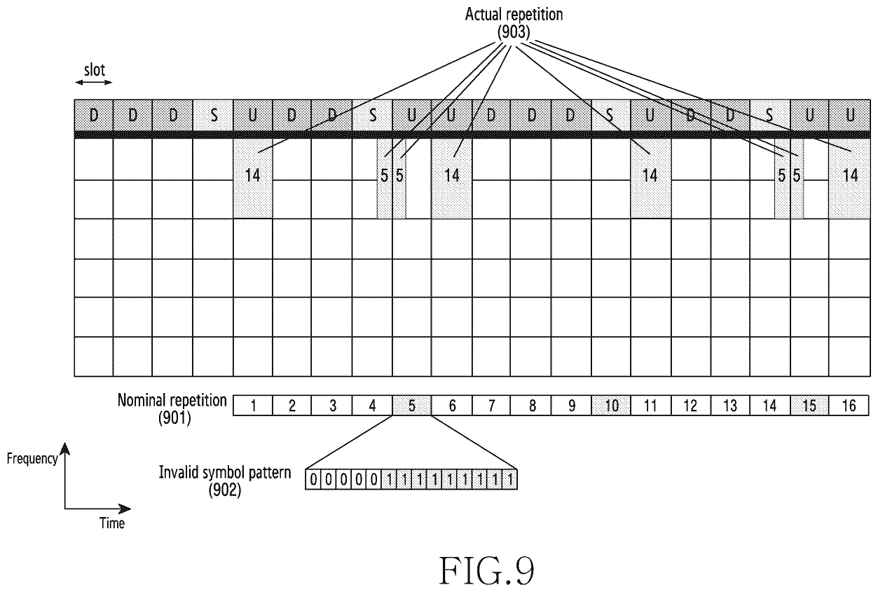

FIG. 9 illustrates the PUSCH repetitive transmission type B in a wireless communication system according to an embodiment.

The UE may be configured with a start symbol S of the UL data channel as 0, a length L of the UL data channel as 14, and the number of repetitive transmissions as 16. In this case, a nominal repetition is shown in 16 consecutive slots (indicated by reference numeral 901). Thereafter, the UE may determine, as invalid symbols, symbols configured as DL symbols in each nominal repetition 901 and symbols configured as 1 in an invalid symbol pattern 902. In each nominal repetition, when valid symbols, not invalid symbols, are composed of one or more consecutive symbols in one slot, the symbols are configured as an actual repetition and transmitted (indicated by reference numeral 903).

In addition, for the PUSCH repetition, in Rel.16, additional methods may be defined for UL grant-based PUSCH transmission and configured grant-based PUSCH transmission beyond the slot boundary, as follows:

Method 1 (mini-slot level repetition): Through one UL grant, two or more PUSCH repetitive transmissions are scheduled within one slot or beyond the boundary of consecutive slots. Time domain resource assignment information in the DCI indicates a resource of the first repetitive transmission. Time domain resource information of the first repetitive transmission and time domain resource information of the remaining repetitive transmissions may be determined according to the UL or DL direction determined per symbol of each slot. Each repetitive transmission occupies consecutive symbols.

Method 2 (multi-segment transmission): Through one UL grant, two or more PUSCH repetitive transmissions are scheduled in consecutive slots. In this case, one transmission is designated for each slot, and a starting point or repetition length may be different for each transmission. Time domain resource assignment information in the DCI indicates the start points and repetition lengths of all repetitive transmissions. In case of performing repetitive transmissions in a single slot through method 2, if there are multiple bundles of consecutive UL symbols in the corresponding slot, each repetitive transmission is performed for each bundle of UL symbols. In case that there is only one bundle of consecutive UL symbols in the slot, one PUSCH repetitive transmission is performed according to Rel. 15.

Method 3: Through two or more UL grants, two or more PUSCH repetitive transmissions are scheduled in consecutive slots. In this case, one transmission is designated for each slot, and the n-th UL grant may be received before PUSCH transmission scheduled with the (n−1)-th UL grant ends.

Method 4: Through one UL grant or one configured grant, one or several PUSCH repetitive transmissions in a single slot, or two or more PUSCH repetitive transmissions across the boundary of consecutive slots may be supported. The number of repetitions indicated by the base station to the UE is only a nominal value, and the number of PUSCH repetitive transmissions actually performed by the UE may be greater than the nominal number of repetitions. The time domain resource assignment information in the DCI or in the configured grant refers to the resource of the first repetitive transmission indicated by the base station. The time domain resource assignment information of the remaining repetitive transmissions may be determined by referring to at least resource information of the first repetitive transmissions and the UL or DL direction of the symbols. In case that the time domain resource assignment information of the repetition indicated by the base station spans the slot boundary or includes a UL/DL switching point, the corresponding repetitive transmission may be divided into a plurality of repetitive transmissions. In this case, one repetitive transmission may be included for each UL period in one slot.

PUSCH: Frequency Hopping Process

In the 5G system, as the frequency hopping method of the UL data channel, two methods are supported for each PUSCH repetition transmission type. PUSCH repetition transmission type A supports intra-slot frequency hopping and inter-slot frequency hopping, and PUSCH repetition transmission type B supports inter-repetition frequency hopping and inter-slot frequency hopping.

The intra-slot frequency hopping method supported by the PUSCH repetition transmission type A is a method in which the UE changes the allocated resources of the frequency domain by a configured frequency offset in two hops within one slot and transmits the same. In the intra-slot frequency hopping, the start RB of each hop can be expressed as shown below in Equation (3).

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad ( 3 )$$

In Equation (3), i=0 and i=1 indicate a first hop and a second hop, respectively, and RBₛₜₐᵣₜ indicates a start RB in the UL BWP and is calculated based on the frequency resource allocation method. RB_{offset} indicates a frequency offset between two hops through a higher layer parameter. The number of symbols in the first hop may be represented by └N_{symb}^{PUSCH,s}/2┘, and the number of symbols in the second hop may be represented by N_{symb}^{PUSCH,s}−└N_{symb}^{PUSCH,s}/2┘. N_{symb}^{PUSCH,s} is the length of PUSCH transmission in one slot, and is represented by the number of OFDM symbols.

the inter-slot frequency hopping method supported by the PUSCH repetition transmission types A and B is a method in which the UE changes the allocated resource of the frequency domain for each slot by a configured frequency offset and transmits the same. In the inter-slot frequency hopping, a start RB during a nₛ^{μ} slot may be expressed as shown below in Equation (4).

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad ( 4 )$$

In Equation (4), nₛ^{μ} denotes a current slot number in multi-slot PUSCH transmission, RBₛₜₐᵣₜ denotes a start RB in the UL BWP, and is calculated from the frequency resource allocation method. RB_{offset} indicates a frequency offset between two hops through a higher layer parameter.

The inter-repetition frequency hopping method supported by the PUSCH repetition transmission type B is performed to transmit a resource allocated in the frequency domain for one or a plurality of actual repetitions within each nominal repetition by moving the same by a configured frequency offset. RBₛₜₐᵣₜ(n), which is the index of the start RB on the frequency domain for one or a plurality of actual repetitions within the n-th nominal repetition, is shown below in Equation (5).

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad ( 5 )$$

In Equation (5), n denotes an index of nominal repetition, and RB_{offset} denotes an RB offset between two hops through a higher layer parameter.

Rate Matching for UCI Multiplexed on PUSCH

Prior to explaining rate matching for UCI, a case in which UCI is multiplexed on PUSCH will be explained. The terminal transmits multiple overlapping PUCCH(s) or overlapping PUCCH(s) and PUSCH(s) for one slot, and is configured to multiplex different UCI types on one PUCCH. If at least one of multiple overlapping PUCCH(s) or PUSCH(s) is a signal transmitted upon the UE receiving the DCI format, the UE may multiplex all applicable UCI types that satisfy a timeline condition as specifically described in the clause 9.2.5 of the 3GPP standard TS 38.213. As a timeline condition for UCI multiplexing, if either PUCCH transmission or PUSCH transmission is scheduled through DCI, the UE can perform UCI multiplexing only when the first symbol S₀ of the earliest PUCCH or PUSCH among the PUCCHs and PUSCHs overlapping in the slot satisfies the following conditions:

S₀ is not a symbol transmitted earlier than a symbol including a CP starting after T_{proc,1}^{mux} from after the last symbol of the corresponding PDSCH, where T_{proc,1}^{mux} is the maximum value among {T_{proc,1}^{mux,1}, . . . T_{proc,1}^{mux,i}, . . . } for the i-th PDSCH associated with HARQ-ACK transmitted through the PUCCH within a group of overlapping PUCCHs and PUSCHs. T_{proc,1}^{mux,i} is defined as T_{proc,1}^{mux,i}=(N₁+d_{1,1})·(2048+144)·κ·2^{-μ}·T_{C} that is the processing procedure time for the i-th PDSCH, where d_{1,1} is the value determined for the i-th PDSCH by referring to 3GPP standard TS 38.214 clause 5.3, and N₁ is the PDSCH processing time value according to the PDSCH processing capability. In addition, μ is the smallest subcarrier configuration value among the SCS configuration values of the PUCCH scheduling the i-th PDSCH, the i-th PDSCH, PUCCHs containing the HARQ-ACK for the i-th PDSCH, and all PUSCHs in the group of overlapping PUCCHs and PUSCHs. T_{C} is 1/(Δfₘₐₓ·N_{f}), Δfₘₐₓ=480·10³ Hz, N_{f}=4096 and κ is 64.

This is part of the timeline condition for UCI multiplexing, and when the timeline condition is satisfied by referring to clause 9.2.5 of the 3GPP standard TS 38.213, the UE may perform UCI multiplexing on PUSCH. When PUCCH and PUSCH overlap and the timeline conditions for UCI multiplexing specified in clause 9.2.5 of 3GPP standard TS 38.213, including the example described above, are met, the UE may multiplex the HARQ-ACK and/or CSI information contained in PUCCH on PUSCH and not transmit PUCCH, depending on the UCI information contained in PUSCH.

Thereafter, if the PUCCH and PUSCH are overlapped, the timeline conditions for UCI multiplexing are met, and the UE determines to multiplex the UCI contained in the PUCCH on the PUSCH, the UE performs UCI rate matching to multiplex the UCI. UCI multiplexing is performed in the order of HARQ-ACK and configured grant-uplink control information (CG-UCI), CSI part 1, and CSI part 2. The UE performs rate matching by considering the UCI multiplexing order. Therefore, the UE calculates and considers the coded modulation symbols per layer for HARQ-ACK and CG-UCI to calculate the coded modulation symbol per layer for CSI part 1. Thereafter, the UE calculates the coded modulation symbol per layer for CSI part 2 by considering the coded modulation symbols per layer for HARQ-ACK, CG-UCI, and CSI part1.

When performing rate matching for each UCI type, the method for calculating the number of coded modulation symbols per layer differs depending on the type of repetitive transmission of PUSCH over which the UCI is multiplexed and whether uplink data (uplink shared channel, hereinafter, UL-SCH) is included. For example, when performing rate matching for HARQ-ACK, the formula for coded modulation symbols per layer depending on the PUSCH over which the UCI is multiplexed in Equations (6), (7) and (8) as follows.

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ \} \qquad ( 6 )$$

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \} \qquad ( 7 )$$

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \} \qquad ( 8 )$$

Equation (6) is a formula for the coded modulation symbol per layer for HARQ-ACK being multiplexed on PUSCH in the case of non-PUSCH repetitive transmission type B including UL-SCH. Equation (7) is a formula for the coded modulation symbol per layer for HARQ-ACK multiplexed on PUSCH repetitive transmission type B including UL-SCH. Equation (8) is a formula for the coded modulation symbol per layer for HARQ-ACK multiplexed on PUSCH not including UL-SCH.

In Equation (6), O_{ACK} is the number of HARQ-ACK bits. L_{ACK} is the number of CRC bits for the HARQ-ACK. β_{offset}^{PUSCH} is the beta offset for the HARQ-ACK, which is equal to β_{offset}^{HARQ-ACK}. C_{UL-SCH} is the number of code blocks of the UL-SCH for the PUSCH transmission, and Kᵣ is the code block size of the rth code block. M_{sc}^{UCI}(l) is the number of resource elements that can be utilized for UCI transmission in symbol l, the number being determined by the existence or not of DMRS and PTRS of symbol l. If the symbol l contains DMRS, M_{sc}^{UCI}(l)=0. For symbol l that do not contain DMRS, M_{sc}^{UCI}(l)=M_{sc}^{PUSCH}−M_{sc}^{PT-RS}(l). M_{sc}^{PUSCH} is the number of subcarriers for the bandwidth on which the PUSCH transmission is scheduled, and M_{sc}^{PT-RS}(l) is the number of subcarriers containing PTRS within the symbol l. N_{symb,all}^{PUSCH} is the total number of symbols of the PUSCH. α is the higher layer parameter scaling, which implies a ratio of resources through which UCI can be multiplexed among total resources for PUSCH transmission. l₀ denotes the index of the first symbol that does not contain a DMRS after the first DMRS.

In Equation (7), M_{sc,nominal}^{UCI}(l) is the number of resource elements that can be utilized for UCI transmission for a nominal repetition, and is zero for symbols containing DMRS and equal to M_{sc,nominal}^{UCI}(l)=M_{sc}^{PUSCH}−M_{sc,nominal}^{PT-RS}(l) for symbols not containing DMRS. MP_{sc,nominal}^{PT-RS}(l) is the number of subcarriers containing PTRS in a symbol l for PUSCH assuming nominal repetition. N_{symb,nominal}^{PUSCH} denotes the total number of symbols for the nominal repetition of the PUSCH. M_{sc,actual}^{UCI}(l) indicates the number of resource elements that can be utilized for UCI transmission for the actual repetition, and is zero for symbols including DMRS and equal to M_{sc,actual}^{UCI}(l)=M_{sc}^{PUSCH}−M_{sc,actual}^{PT-RS}(l) for symbols not including DMRS. M_{sc,actual}^{PT-RS}(l) is the number of subcarriers containing a PTRS in the symbol l for the actual repetition of the PUSCH. N_{symb,actual}^{PUSCH} denotes the total number of symbols for the actual repetition of PUSCH.

In Equation (8), R is the code rate of the PUSCH and Qₘ is the modulation order of the PUSCH.

The number of coded modulation symbols per layer that has performed rate matching for CSI part 1 may be calculated similarly to that for the HARQ-ACK, but the maximum number of resources that can be allocated among total resources is decreased to a value obtained by excluding the number of coded modulation symbols for HARQ-ACK/CG-UCI. The calculation formula for coded modulation symbols per layer of CSI part 1 is shown below in Equations (9), <(10), (11), and (12) depending on the repetitive transmission type of PUSCH and whether UL-SCH is included.

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \} \qquad ( 9 )$$

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} \} \qquad ( 10 )$$

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \} \qquad ( 11 )$$

$${Q}_{CSI - 1}^{′} = {\sum }_{l = 0}^{{N}_{symb , all}^{PUSCH} - 1} {M}_{sc}^{UCI} ( l ) - {Q}_{ACK}^{′} \qquad ( 12 )$$

Equation (9) is a formula for the coded modulation symbol per layer for CSI part 1 being multiplexed on PUSCH in the case of non-PUSCH repetitive transmission type B including UL-SCH. Equation (10) is a formula for the coded modulation symbol per layer for CSI part 1 multiplexed on PUSCH repetitive transmission type B including UL-SCH. Equation (11) is, when CSI part 1 and CSI part 2 are multiplexed on PUSCH not including UL-SCH, a formula for the coded modulation symbol per layer for CSI part 1 being multiplexed. Equation (12) is the formula for the coded modulation symbol per layer for CSI part 1 being multiplexed when CSI part 2 is not being multiplexed on a PUSCH that does not include UL-SCH. In Equation (9), O_{CSI-1} and L_{CSI-1} are the number of bits for CSI part 1 and the number of CRC bits for CSI part 1, respectively. β_{offset}^{PUSCH} is the beta offset for CSI part 1, which is equal to β_{offset}^{CSI-part1}. Q_{ACK/CG-UCI}′ is the number of coded modulation symbols per layer calculated for HARQ-ACK and/or CG-UCI. The other parameters are the same as those described above to calculate the number of coded modulation symbols per layer for HARQ-ACK.

The number of coded modulation symbols per layer having performed rate matching for CSI part 2 may be calculated similarly to that for CSI part 1, the maximum number of resources that can be allocated among the total resources is decreased to a value obtained by excluding the number of coded modulation symbols for HARQ-ACK/CG-UCI and the number of coded modulation symbols for CSI part 2. The formula for coded modulation symbols per layer for CSI part 1 is shown below in Equations (13), (14), and (15) depending on the repetitive transmission type of PUSCH and whether UL-SCH is included.

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \} \qquad ( 13 )$$

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \} \qquad ( 14 )$$

$${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′} \qquad ( 15 )$$

Equation (13) is a formula for the coded modulation symbol per layer for CSI part 2 being multiplexed on PUSCH in the case of non-PUSCH repetitive transmission type B including UL-SCH. Equation (14) is a formula for the coded modulation symbol per layer for CSI part 2 being multiplexed on PUSCH repetitive transmission type B including UL-SCH. Equation (15) is a formula for the coded modulation symbol per layer for CSI part 2 being multiplexed on PUSCH that does not include UL-SCH. In Equation (13>), O_{CSI-2} and L_{CSI-2} are the number of bits for CSI part 2 and the number of CRC bits for CSI part 2, respectively. β_{offset}^{PUSCH} is the beta offset for CSI part 2, which is equal to β_{offset}^{CSI-part2}. The other parameters are the same as those described above to calculate the number of coded modulation symbols per layer for HARQ-ACK and CSI part 1.

The number of coded modulation symbols per layer having performed rate matching for GU-UCI may be calculated similarly to HARQ-ACK. The formula for the number of coded modulation symbols per layer of CG-UCI multiplexed on PUSCH including UL-SCH is shown below in Equation (16).

$${Q}_{CG - UCI}^{′} = min \{ ⌈ \frac{( {O}_{CG - UCI} + {L}_{CG - UCI} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ \} \qquad ( 16 )$$

In Equation (16), O_{CG-UCI} and L_{CG-UCI} are the number of bits of the CG-UCI and the number of CRC bits for the CG-UCI, respectively. β_{offset}^{PUSCH} is the beta offset for the CG-UCI, which is equal to β_{offset}^{CG-UCI}. The other parameters are the same as those described above to calculate the number of coded modulation symbols per layer for HARQ-ACK.

When HARQ-ACK and CG-UCI are multiplexed on a PUSCH containing UL-SCH, the number of coded modulation symbols per layer having performed rate matching of HARQ-ACK and CG-UCI may be calculated as shown below in Equation (17).

$${Q}_{CG - UCI}^{′} = min \{ ⌈ \frac{( {O}_{ACK} + {O}_{CG - UCI} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ \} \qquad ( 17 )$$

In Equation (17), β_{offset}^{PUSCH} is the beta offset for HARQ-ACK and is equal to β_{offset}^{HARQ-ACK}, and the other parameters are the same as those described above to calculate the number of coded modulation symbols per layer for HARQ-ACK.

After calculating the number of coded modulation symbols per layer for each UCI type as above, E_{UCI} which is the number of bits for the entire UCI may be calculated as E_{UCI}=N_{L}·Q′·Qₘ, where N_{L} is the number of transmission layers of PUSCH, Qₘ is the modulation order, and Q′ is the number of coded modulation symbols per layer based on UCI type and may be Q_{ACK}′, Q_{CSI-1}′, Q_{CSI-2}′, or Q_{CG-UCI}′.

Related to UE Capability Report

In LTE and NR systems, a UE may perform a procedure of reporting the capability supported by the UE to the corresponding base station while being connected to a serving base station, referred to herein as a UE capability report.

The base station may transmit a UE capability enquiry message for requesting a capability report to the UE in the connected state. The message may include a UE capability request for each radio access technology (RAT) type of the base station. The request per RAT type may include supported frequency band combination information and the like. In case of the UE capability enquiry message, UE capability for a plurality of RAT types may be requested through one RRC message container transmitted by the base station, or the base station may transfer the UE capability enquiry message including the UE capability request per RAT type to the UE by including the same multiple times. That is, the UE capability enquiry is repeated a plurality of times within one message, and the UE may configure a UE capability information message corresponding thereto and report the same a plurality of times. In the next-generation mobile communication system, the UE capability request for multi-RAT dual connectivity (MR-DC) including NR, LTE, and E-UTRA-NR dual connectivity (EN-DC) is possible. The UE capability enquiry message is generally transmitted initially after the UE is connected to the base station, but the message can be requested under any conditions when the base station is needed.

In the above stage, the UE receiving the UE capability report request from the base station configures the UE capability according to the RAT type and band information requested from the base station. A method of configuring UE capability by a UE in the NR system is summarized as follows.

When a UE receives a list of LTE and/or NR bands from a base station according to a UE capability request, the UE configures a band combination (BC) for EN-DC and NR stand-alone (SA). That is, the UE configures a candidate list of BC for EN-DC and NR SA based on the bands requested from FreqBandList of the base station. The priorities of the bands have priorities in the order described in the FreqBandList.

In case that a base station requests a UE capability report by setting the eutra-nr-only flag or eutra flag, the UE completely removes NR SA BCs from the configured BC candidate list. This operation may occur only when an LTE base station (eNB) requests eutra capability.

Thereafter, the UE removes fallback BCs from the candidate list of BCs configured in the above stage. The fallback BC refers to BC obtained by removing the band corresponding to at least one SCell from any BC. Since BC before removing the band corresponding to at least one SCell can already cover the fallback BC, the fallback BC can be omitted. This stage also is applied to MR-DC, that is, LTE bands are also applied. The BCs remaining after this stage are the final candidate BC list.

The UE selects BCs to be reported by selecting BCs suitable for the requested RAT type from the final candidate BC list. In this stage, the UE configures the supportedBandCombinationList in a predetermined order. That is, the UE configures the BC and UE capability to be reported according to a preconfigured rat-Type order (nr→eutra-nr→eutra). The UE configures featureSetCombination for the configured supportedBandCombinationList, and configures a list of candidate feature set combination from the candidate BC list from which the list of fallback BCs (including the capability of the same or lower level) has been removed. The candidate feature set combination includes the feature set combination for both NR and EUTRA-NR BC, and may be obtained from the feature set combination of UE-NR-Capabilities and UE-MRDC-Capabilities containers.

If the requested RAT Type is EUTRA-NR and affects, featureSetCombinations is included in both containers of UE-MRDC-Capabilities and UE-NR-Capabilities. However, the feature set of NR includes only UE-NR-Capabilities.

After the UE capability is configured, the UE transmits the UE capability information message including the UE capability to the base station. The base station then performs scheduling and transmission/reception management appropriate for the UE, based on the UE capability received from the UE.

Carrier Aggregation Dual Connectivity (CA/DC Related

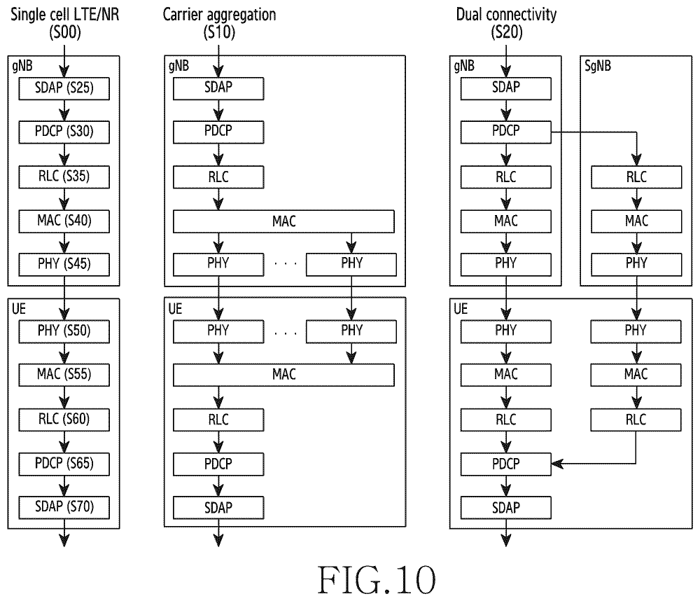

FIG. 10 illustrates radio protocol structures of a base station and a UE in single cell, carrier aggregation, and dual connectivity situations according to an embodiment.

In FIG. 10, in each of a UE and an NR base station, the radio protocol of the next-generation mobile communication system is configured by NR service data adaption protocol (SDAP) S25 or S70, NR packet data convergence protocol (PDCP) S30 or S65, NR radio link control (RLC) S35 or S60, and NR MAC S40 or S55.

Main functions of the NR SDAP S25 or S70 may include transfer of user plane data, mapping between a quality of service (QoS) flow and a data bearer (DRB) for both DL and UL, marking QoS flow ID in both DL and UL packets, and mapping reflective QoS flow to DRB for the UL SDAP PDUs.

For the SDAP layer device, the UE may receive an RRC message for configuring whether to use the header of the SDAP layer device or the function of the SDAP layer device for each PDCP layer device, for each bearer, or for each logical channel. In case that the SDAP header is configured, a 1-bit NAS reflective QoS indicator of the SDAP header and a 1-bit AS reflective QoS indicator may be instructed to enable the UE to update or reconfigure mapping information for QoS flow of UL and DL and data bearer. The SDAP header may include QoS flow ID information indicating QoS. The QoS information may be used as data processing priority and scheduling information to support a smooth service.

Main functions of the NR PDCP S30 or S65 may include: header compression and decompression (ROHC only), transfer of user data, in-sequence delivery of upper layer PDUs, out-of-sequence delivery of upper layer PDUs, PDCP PDU reordering for reception, duplicate detection of lower layer SDUs, retransmission of PDCP SDUs, ciphering and deciphering, and timer-based SDU discard in the UL.

The reordering function of the NR PDCP device refers to reordering PDCP PDUs received from a lower layer, based on a PDCP sequence number (SN), and may include delivering data to an upper layer in the reordered order. Alternatively, the reordering function of the NR PDCP device may include directly delivering without considering the order, and recording PDCP PDUs lost by reordering. The reordering function of the NR PDCP device may include reporting the status of the lost PDCP PDUs to a transmitting side, and requesting retransmission of the lost PDCP PDUs.

Main functions of the NR RLC S35 or S60 may include: transfer of upper layer PDUs, in-sequence delivery of upper layer PDUs, out-of-sequence delivery of upper layer PDUs, an ARQ function (error correction through ARQ), concatenation, segmentation and reassembly of RLC SDUs, re-segmentation of RLC data PDUs, reordering of RLC data PDUs, duplicate detection, protocol error detection, RLC SDU discard, and RLC re-establishment.

The in-sequence delivery function of the NR RLC device refers to sequentially delivering RLC SDUs received from a lower layer to an upper layer. The in-sequence delivery of the NR RLC device may include reassembling and delivering received several RLC SDUs divided from one RLC SDU, rearranging the received RLC PDUs, based on RLC sequence number (SN) or PDCP SN, recording RLC PDUs lost by reordering, reporting the status of the lost RLC PDUs to a transmitting side, and requesting retransmission of the lost RLC PDUs. The in-sequence delivery of the NR RLC device may include, when there is a lost RLC SDU, sequentially delivering only RLC SDUs before the lost RLC SDU to a higher layer, or even if there is a lost RLC SDU but a certain timer has expired, sequentially transferring all RLC SDUs received before the timer starts to a higher layer. Alternatively, even if there is a lost RLC SDU but a certain timer has expired, the in-sequence delivery function of the NR RLC device may include sequentially delivering all currently received RLC SDUs to a higher layer. The RLC PDUs may be processed in the order of reception (in the order of arrival, regardless of the sequence number) and delivered to the PDCP device regardless of order (i.e., out-of-sequence delivery). The segments stored in the buffer or to be received later are reconstructed into one complete RLC PDU, processed, and delivered to the PDCP device. The NR RLC layer may not include a concatenation function, and this function may be performed by the NR MAC layer or replaced with a multiplexing function of the NR MAC layer.

The out-of-sequence delivery function of the NR RLC device refers to directly delivering RLC SDUs received from a lower layer to a higher layer regardless of order, and if one RLC SDU is divided into several RLC SDUs and then received, a function of reassembling and transmitting them may be included. A function of storing the RLC SNs or PDCP SNs of the received RLC PDUs, arranging the order, and recording the lost RLC PDUs may be included.

The NR MAC S40 or 555 may be connected to several NR RLC layer devices configured in one UE, and the main function of the NR MAC may include some or all of mapping between logical channels and transport channels, multiplexing/demultiplexing of MAC SDUs, scheduling information reporting, error correction through HARQ, priority handling between logical channels of one UE, priority handling between UEs by means of dynamic scheduling, MBMS service identification, transport format selection, and a padding function.

The NR PHY layer S45 or 550 may perform an operation of channel-coding and modulating upper layer data, generating the data into an OFDM symbol and transmitting the OFDM symbol to a radio channel, demodulating and channel-decoding the OFDM symbol received through the radio channel, and delivering the same to the upper layer.

A detailed structure of the radio protocol structure may be variously changed according to a carrier (or cell) operating scheme. For example, in case that the base station transmits data to the UE based on a single carrier (or cell), the base station and the UE use a protocol structure having a single structure for each layer, as indicated by reference numeral 500. In case that the base station transmits data to the UE based on carrier aggregation (CA) using multiple carriers in a single transmission reception point (TRP), the base station and the UE have a single structure up to RLC, but they use a protocol structure of multiplexing the PHY layer through the MAC layer, as indicated by reference numeral S10. In case that the base station transmits data to the UE based on DC using multiple carriers in multiple TRP, the base station and the UE have a single structure up to RLC, but they use a protocol structure for multiplexing the PHY layer through the MAC layer, as indicated by reference numeral S20.

Non-Coherent Joint Transmission (NC-JT) Related

The NC-JT may be used for a UE to receive a PDSCH from a plurality of TRPs.

The 5G wireless communication system can support all of a service requiring a high transfer rate, having a very low latency, and requiring a high connection density. In a wireless communication network including a plurality of cells, transmission and reception points (TRPs), or beams, coordinated transmission between cells, TRPs, and/or beams may satisfy various service requirements by increasing the strength of a signal received by the UE or efficiently performing control of interference between cells, TRPs, and/or beams.

The JT, which is a representative transmission technology for the above-mentioned cooperative communication (or coordinated transmission), is a technique to increase the strength of a signal received by the UE or throughput by transmitting a signal to one UE through a plurality of different cells, TRPs, and/or beams. In this case, a channel between the UE and the cell, TRP, and/or beam may have significantly different characteristics. In particular, the NC-JT that supports NC precoding between cells, TRPs, and/or beams may require individual precoding, MCS, resource allocation, TCI indication, etc., according to the channel characteristics for each link between the UE and the cell, TRP, and/or beam.

The above-described NC-JT transmission may be applied to at least one channel of a DL data channel (PDSCH), a DL control channel (PDCCH), a UL data channel (PUSCH), and a UL control channel (PUCCH). During PDSCH transmission, transmission information such as precoding, MCS, resource allocation, and TCI is indicated by DL DCI. For the NC-JT transmission, the transmission information should be independently indicated for each cell, TRP, and/or beam. This is a major factor in increasing a payload required for DL DCI transmission, which may adversely affect reception performance of the PDCCH transmitting the DCI. Therefore, it is necessary to carefully design a tradeoff between the amount of DCI information and the control information reception performance to support the JT of the PDSCH.

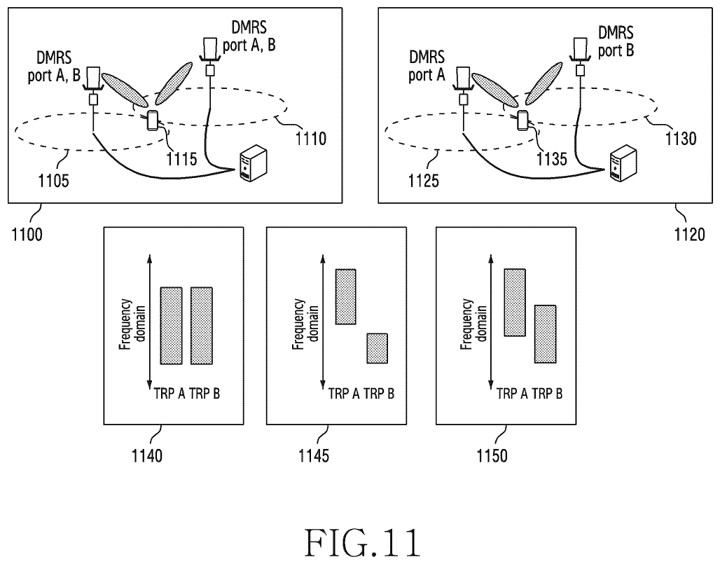

FIG. 11 illustrates antenna port configuration and resource allocation for cooperative communication in a wireless communication system according to an embodiment.

Specifically, FIG. 11 illustrates an example for PDSCH transmission for each technique of JT, and examples for allocating radio resources for each TRP.

In FIG. 11, an example 1100 of coherent joint transmission (C-JT) supporting coherent precoding between cells, TRPs, and/or beams is shown.

In case of C-JT, TRP A 1105 and TRP B 1110 transmit a single data (PDSCH) to a UE 1115, and joint precoding may be performed in a plurality of TRPs. This may imply that DMRS is transmitted through the same DMRS ports so that TRP A 1105 and TRP B 1110 transmit the same PDSCH. For example, each of TRP A 1105 and TRP B 1110 may transmit the DRMS to the UE through DMRS port A and DMRS B. In this case, the UE may receive one piece of DCI information for receiving one PDSCH demodulated based on the DMRS transmitted through DMRS port A and DMRS B.

FIG. 11 illustrates an example 1120 of NC-JT supporting non-coherent precoding between cells, TRPs, and/or beams for PDSCH transmission.

In NC-JT, the PDSCH is transmitted to a UE 1135 for each cell, TRP, and/or beam, and individual precoding may be applied to each PDSCH. Each cell, TRP, and/or beam transmits a different PDSCH or a different PDSCH layer to the UE, thereby improving throughput compared to single cell, TRP, and/or beam transmission, and repeatedly transmits the same PDSCH to the UE, thereby improving reliability compared to single cell, TRP, and/or beam transmission. For convenience of description, the cell, TRP, and/or beam is hereinafter collectively referred to as a TRP.

For PDSCH transmission, various radio resource allocation cases may be considered such as case 1140 in which the frequency and time resources used by a plurality of TRPs are all the same, case 1145 in which the frequency and time resources used by the plurality of TRPs do not overlap at all, and case 1150 in which the frequency and time resources used by the plurality of TRPs partially overlap.

To simultaneously allocate a plurality of PDSCHs to one UE for NC-JT support, DCIs of various types, structures, and relationships may be considered.

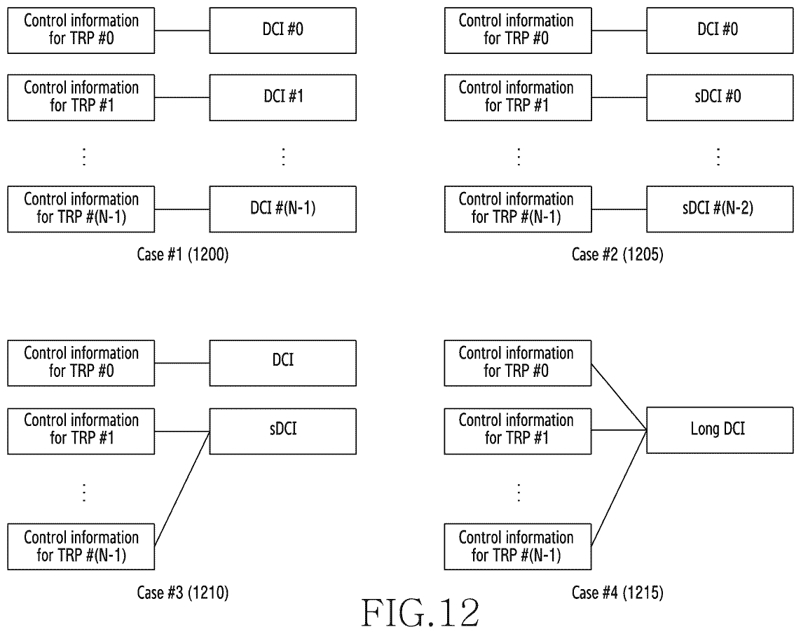

FIG. 12 illustrates a configuration of DCI for NC-JT in which respective TRPs transmit different PDSCHs or different PDSCH layers to a UE in a wireless communication system according to an embodiment.

in FIG. 12, in case #1 1200, different (N−1) PDSCHs are transmitted from (N−1) additional TRPs (TRP #1 to TRP #(N−1)) in addition to a serving TRP (TRP #0) used for single PDSCH transmission, control information for the PDSCHs transmitted in the (N−1) additional TRPs is transmitted independently of control information for the PDSCHs transmitted in the serving TRP. That is, the UE may obtain control information for PDSCHs transmitted from different TRPs (TRP #0 to TRP #(N−1)) through independent DCIs (DCI #0 to DCI #(N−1)). The format between the independent DCIs may be identical with or different from each other, and the payload between the DCIs may also be identical with or different from each other. In case #1, each PDSCH control or allocation freedom may be completely guaranteed, but when each DCI is transmitted in different TRPs, a coverage difference for each DCI may occur and reception performance may deteriorate.

In case #2 1205, when different (N−1) PDSCHs are transmitted from (N−1) additional TRPs (TRP #1 to TRP #(N−1)) in addition to a serving TRP (TRP #0) used for single PDSCH transmission, respective pieces of DCI for the PDSCH of (N−1) additional TRPs are transmitted, and each of these DCIs is dependent on the control information for the PDSCH transmitted from the serving TRP.

For example, in DCI #0, which is control information for PDSCH transmitted from the serving TRP (TRP #0), all information elements of DCI format 10, DCI format 11, and DCI format 1_2 are included, but in case of shortened DCI (hereinafter, sDCI (sDCI #0 to sDCI #(N−2)), which is control information for PDSCHs transmitted from cooperative TRPs (TRP #1 to TRP #(N−1)), only some of the information elements of format 10, DCI format 11, and DCI format 1_2 may be included. Therefore, in the sDCI transmitting control information for PDSCHs transmitted from cooperative TRPs, since the payload is small compared to normal DCI (nDCI) for transmitting PDSCH-related control information transmitted from the serving TRP, it is possible to include reserved bits compared to nDCI.

In case #2, each PDSCH control or allocation freedom may be limited according to the content of the information element included in sDCI. However, since the reception performance of sDCI is superior to that of nDCI, a probability of occurrence of a coverage difference for each DCI may be reduced.

In case #3 1210, when different (N−1) PDSCHs are transmitted from (N−1) additional TRPs (TRP #1 to TRP #(N−1)) in addition to a serving TRP (TRP #0) used for single PDSCH transmission, one control information for the PDSCH of (N−1) additional TRPs is transmitted. This DCI is dependent on the control information for the PDSCH transmitted from the serving TRP.

For example, in DCI #0, which is control information for PDSCH transmitted from the serving TRP (TRP #0), all information elements of DCI format 10, DCI format 11, and DCI format 1_2 are included. In case of control information for PDSCHs transmitted from cooperative TRPs (TRP #1 to TRP #(N−1)), only some of the information elements of DCI format 10, DCI format 1_1, and DCI format 1_2 can be collected as one ‘secondary DCI’ (Sdci) and transmitted. For example, the Sdci may include at least one of HARQ-related information such as frequency domain resource assignment, time domain resource assignment, and MCS of cooperative TRPs. In case of information not included in the Sdci, such as a BWP indicator or carrier indicator, information such as a BWP indicator or carrier indicator may follow DCI (DCI #0, normal DCI, nDCI) of the serving TRP.

In case #3 1210, each PDSCH control or allocation freedom may be limited according to the content of the information element included in the sDCI, but the sDCI reception performance can be adjusted and, compared to case #1 1200 or case #2 1205, the complexity of DCI blind decoding of the UE may be reduced. DCI blind decoding is an operation performed by the UE throughout search space for finding PDCCH data.

In case #4 1215, when different (N−1) PDSCHs are transmitted from (N−1) additional TRPs (TRP #1 to TRP #(N−1)) in addition to a serving TRP (TRP #0) used for single PDSCH transmission, control information for PDSCH transmitted from (N−1) additional TRPs is transmitted in the same DCI (long DCI) as control information for PDSCH transmitted from the serving TRP. That is, the UE may obtain control information for PDSCHs transmitted from different TRPs (TRP #0 to TRP #(N−1)) through single DCI. In case #4 1215, the complexity of DCI blind decoding of the UE may not increase, but the PDSCH control or freedom of allocation may be low, such as the number of cooperative TRPs is limited according to long DCI payload restrictions.

Herein, the sDCI may refer to various auxiliary DCIs, such as shortened DCI, secondary DCI, or normal DCI (the above-described DCI formats 1_0 to 1_1) including PDSCH control information transmitted in cooperative TRP. In case that no particular limitation is specified, the description is similarly applicable to the various auxiliary DCIs.

In FIG. 12, case #1 1200, case #2 1205, and case #3 1210 in which one or more DCI (PDCCH) are used for NC-JT support may be referred to as multiple PDCCH-based NC-JT, and the above-described case #4 1215 in which a single DCI (PDCCH) is used for NC-JT support may be referred to as a single PDCCH-based NC-JT. In multiple PDCCH-based PDSCH transmission, the CORESET in which the DCI of the serving TRP (TRP #0) is scheduled and the CORESET in which the DCI of the cooperative TRPs (TRP #1 to TRP #(N−1)) are scheduled can be distinguished. To distinguish CORESETs, there may be a method for distinguishing through a higher layer indicator for each CORESET, a method for distinguishing through a beam configuration for each CORESET, and the like. In a single PDCCH-based NC-JT, instead of a single DCI scheduling a plurality of PDSCHs, a single PDSCH having a plurality of layers is scheduled, and the plurality of layers described above may be transmitted from a plurality of TRPs. A connection relationship between a layer and a TRP for transmitting the layer may be indicated through a TCI indication for the layer.

Herein, cooperative TRP may be replaced with various terms such as cooperative panel or cooperative beam when applied in practice.

In addition, the phrase “a case where NC-JT is applied” may be interpreted in various manners depending on the situation, such as a case where the UE receives one or more PDSCHs at the same time in one BWP, a case where the UE receives the PDSCH based on indication of two or more TCIs simultaneously in one BWP, and a case where the PDSCH received by the UE is associated with one or more DMRS port groups. However, one expression is used herein for the sake of convenience.

In the disclosure, the radio protocol structure for NC-JT may be used in various manners depending on TRP deployment scenarios. For example, when there is little or no backhaul delay between cooperative TRPs, a CA-like method using a structure based on MAC layer multiplexing similar to S10 of FIG. 10 is possible. When the backhaul delay between cooperative TRPs is so large that it must be addressed, such as when information exchange of CSI, scheduling, HARQ-ACK, etc. between cooperative TRPs requires 2 ms or more, a DC-like method of securing a characteristic strong against delay is possible by using an independent structure for each TRP from the RLC layer similar to S20 of FIG. 10.

The UE supporting C-JT/NC-JT may receive a C-JT/NC-JT related parameter or setting value from higher layer configuration, and may set an RRC parameter of the UE based on the received parameter or value. For higher layer configuration, the UE may use a UE capability parameter tci-StatePDSCH. The UE capability parameter tci-StatePDSCH, may define TCI states for the purpose of PDSCH transmission, and the number of TCI states may be configured as 4, 8, 16, 32, 64, or 128 in FR1, and as 64 or 128 in FR2, and in the configured number, a maximum of 8 states that can be indicated by 3 bits of the TCI field of DCI through the MAC CE message may be configured. The maximum value of 128 refers to a value indicated by maxNumberConfiguredTCIstatesPerCC in the tci-StatePDSCH parameter included in capability signaling of the UE. As such, a series of configuration procedures from higher layer configuration to MAC CE configuration may be applied to a beamforming indication or a beamforming change command for at least one PDSCH in one TRP.

Multi-TRP Based on Multi-DCI

The multi-DCI-based multi-TRP transmission method may be configured through a DL control channel for NC-JT transmission based on multi-PDCCH.

In NC-JT based on multiple PDCCH, upon DCI transmission for PDSCH scheduling of each TRP, it may have a CORESET or search space distinguished for each TRP. The CORESET or search space for each TRP can be configured as at least one of the following cases.

Higher Layer Index Configuration for Each CORESET

The CORESET configuration information configured as the higher layer may include an index value, and the TRP for transmitting the PDCCH in the corresponding CORESET may be distinguished by the configured index value for each CORESET. That is, in a set of CORESETs having the same higher layer index value, it may be considered that the same TRP transmits the PDCCH or that the PDCCH scheduling the PDSCH of the same TRP is transmitted. The above-described index for each CORESET may be referred to as CORESETPoolIndex. For CORESETs for which the same CORESETPoolIndex value is configured, it may be considered that the PDCCH is transmitted from the same TRP. In case of CORESET in which the CORESETPoolIndex value is not configured, it may be considered that the default value of CORESETPoolIndex has been configured, and the above-described default value may be 0.

In the disclosure, when the type of CORESETPoolIndex of each of a plurality of CORESETs included in the higher layer signaling PDCCH-Config exceeds one, that is, if each CORESET has a different CORESETPoolIndex, the UE may consider that the base station uses the multi-DCI based multi-TRP transmission method.

Alternatively, if the type of CORESETPoolIndex of each of a plurality of CORESETs included in the higher layer signaling PDCCH-Config is one, that is, in case that all CORESETs have the same CORESETPoolIndex of 0 or 1, the UE may consider that the base station performs transmission by using single-TRP instead of using the multi-DCI based multi-TRP transmission method.

Multiple PDCCH-Config Configurations

Multiple PDCCH-Configs are configured in one BWP, and each PDCCH-Config may include PDCCH configuration for each TRP. That is, a list of CORESETs per TRP and/or a list of search spaces per TRP may be configured in one PDCCH-Config, and one or more CORESETs and one or more search spaces contained in one PDCCH-Config may be considered to correspond to a specific TRP.

CORESET Beam/Beam Group Configuration

Through a beam or beam group configured for each CORESET, the TRP corresponding to the CORESET may be distinguished. For example, when the same TCI state is configured in a plurality of CORESETs, it may be considered that the CORESETs are transmitted through the same TRP or that the PDCCH scheduling the PDSCH of the same TRP is transmitted in the CORESETs.

Search Space Beam/Beam Group Configuration

A beam or beam group is configured for each search space, and the TRP for each search space can be distinguished through this configuration. For example, when the same beam/beam group or TCI state is configured in a plurality of search spaces, it may be considered that the same TRP transmits the PDCCH in the search spaces or that the PDCCH scheduling the PDSCH of the same TRP is transmitted in the search spaces.

By distinguishing the CORESET or search space by TRP, as described above, it is possible to classify PDSCH and HARQ-ACK information for each TRP. Through this classification, it is possible to generate an independent HARQ-ACK codebook for each TRP and use an independent PUCCH resource.

The above configuration may be independent for each cell or for each BWP. For example, while two different CORESETPoolIndex values are configured in the PCell, the CORESETPoolIndex value may not be configured in a specific SCell. In this case, it may be considered that the NC-JT transmission is configured in the PCell, whereas the NC-JT transmission is not configured in the SCell in which the CORESETPoolIndex value is not configured.

The PDSCH TCI state activation/deactivation MAC-CE applicable to the multi-DCI based multi-TRP transmission method may follow the process described above in FIG. 7. That is, when the UE is not configured with CORESETPoolIndex for each of all CORESETs in the higher layer signaling PDCCH-Config, the UE may ignore a CORESET Pool ID field 755 in the corresponding MAC-CE 750. In case that the UE can support the multi-DCI based multi-TRP transmission method, that is, if the UE has a different CORESETPoolIndex for each CORESET in the higher layer signaling PDCCH-Config, the UE may activate the TCI state in the DCI contained in the PDCCH transmitted in CORESETs having the same CORESETPoolIndex value as the CORESET Pool ID field 755 value in the corresponding MAC-CE 750. For example, if the value of the CORESET Pool ID field 7-55 in the MAC-CE 750 is 0, the TCI state in the DCI contained in the PDCCH transmitted in CORESETs having the CORESETPoolIndex of 0 may follow the activation information of the corresponding MAC-CE.

When the UE is configured to use the multi-TRP transmission method based on the multi-DCI from the base station, that is, when the type of CORESETPoolIndex of each of a plurality of CORESETs included in the higher layer signaling PDCCH-Config exceeds one, or when each CORESET has different CORESETPoolIndexes, the UE may know that the following restrictions exist for PDSCHs scheduled from the PDCCH in each CORESET having two different CORESETPoolIndexes.
1. In case that PDSCHs indicated from the PDCCH in each CORESET having two different CORESETPoolIndexes completely or partially overlap, the UE may apply the TCI states indicated by each PDCCH to different CDM groups, respectively. That is, two or more TCI states may not be applied to one CDM group.
2. In case that PDSCHs indicated from the PDCCH in each CORESET having two different CORESETPoolIndexes completely or partially overlap, the UE may expect that the actual number of front loaded DMRS symbols, the actual number of additional DMRS symbols, the actual position of the DMRS symbols, and the DMRS type are indifferent for each PDSCH.
3. The UE may expect the same bandwidth part and the same subcarrier spacing are indicated from the PDCCH in each CORESET having two different CORESETPoolIndexes.
4. The UE may expect that each PDCCH completely includes information about the PDSCH scheduled from the PDCCH in each CORESET having two different CORESETPoolIndexes.

Multi-TRP Based on Single-DCI

The multi-TRP transmission method based on single-DCI may be configured through a DL control channel for the NC-JT transmission based on a single-PDCCH.

In the multi-TRP transmission method based on the single-DCI, the PDSCH transmitted by multiple TRPs may be scheduled with one DCI. In this case, the number of TCI states may be used as a method of indicating the number of TRPs transmitting the corresponding PDSCH. That is, if the number of TCI states indicated in the DCI for scheduling the PDSCH is two, it can be regarded as single PDCCH based NC-JT transmission, and if the number of TCI states is one, it can be regarded as single-TRP transmission. The TCI states indicated in the DCI may correspond to one or two TCI states among TCI states activated with MAC-CE. When the TCI states of the DCI correspond to two TCI states activated with MAC-CE, a correspondence relationship between the TCI codepoint indicated in the DCI and the TCI states activated with the MAC-CE is established, and the relationship may be established when the TCI states activated with the MAC-CE corresponding to the TCI codepoint are two.

In another example, if at least one codepoint among all codepoints of the TCI state field in the DCI indicates two TCI states, the UE may consider that the base station can perform transmission based on the single-DCI based multi-TRP method. In this case, at least one codepoint indicating two TCI states in the TCI state field may be activated through the enhanced PDSCH TCI state activation/deactivation MAC-CE.

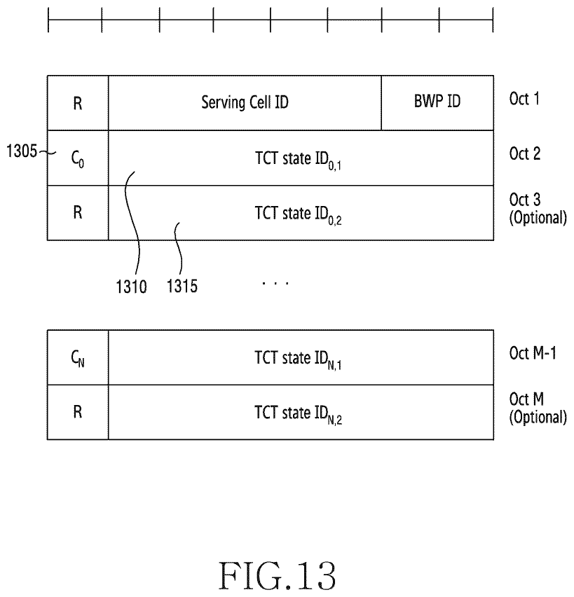

FIG. 13 illustrates an enhanced PDSCH TCI state activation/deactivation MAC-CE structure according to an embodiment. The meaning of each field in the MAC CE and the values configurable for each field are shown below in Table 39.

TABLE 39

| | |
|---|---|
| - | Serving Cell ID: This field indicates the identity of the Serving Cell for which the MAC CE applies. The |

length of the field is 5 bits. If the indicated Serving Cell is configured as part of a simultaneousTCI-UpdateList1 or
simultaneousTCI-UpdateList2 as specified in TS 38.331 [5], this MAC CE applies to all the Serving Cells configured
in the set simultaneousTCI-UpdateList1 of simultaneousTCI-UpdateList2, respectively;

| | |
|---|---|
| - | BWP ID: This field indicates a DL BWP for which the MAC CE applies as the codepoint of the DCI |

bandwidth part indicator field as specified in TS 38.212 [9]. The length of the BWP ID field is 2 bits;

| | |
|---|---|
| - | Cᵢ: This field indicates whether the octet containing TCI state IDᵢ₂ is present. If this field is set to “1”, the |

octet containing TCI state ID_{i,2} is present, If this field is set to “0”, the octet containing TCI state ID_{i,2} is not present;

| | |
|---|---|
| - | TCI state ID_{i,j}: This field indicates the TCI state identified by TCI-Stateld as specified in TS 38.331 [5], where |

i is the index of the codepoint of the DCI Transmission configuration indication field as specified in TS 38.212 [9]
and TCI state ID_{i,j} denotes the j-th TCI state indicated for the i-th codepoint in the DCI Transmission Configuration
Indication field. The TCI codepoint to which the TCI States are mapped is determined by its ordinal position among
all the TCI codepoints with sets of TCI state ID_{i,j} fields, i.e. the first TCI codepoint with TCI state ID_{0,1} and TCI state
ID_{0,2} shall be mapped to the codepoint value 0, the second TCI codepoint with TCI state ID_{1,1} and TCI state ID_{1,2}
shall be mapped to the codepoint value 1 and so on, The TCI state ID_{i,2} is optional based on the indication of the
Ci field. The maximum number of activated TCI codepoint is 8 and the maximum number of TCI states mapped to
a TCI codepoint is 2.

| | |
|---|---|
| - | R: Reserved bit, set to “0”. |

In FIG. 13, if the value of a C₀ field 13-05 is 1, the corresponding MAC-CE may include a TCI state ID_{0,2} field 1315 in addition to a TCI state ID_{0,1} field 1310. This implies that TCI state ID_{0,1} and TCI state ID_{0,2} are activated for the 0th codepoint of the TCI state field included in the DCI, and the UE may be indicated with two TCI states if the base station indicates the corresponding codepoint to the UE. If the value of the C₀ field 1305 is 0, the corresponding MAC-CE may not include the TCI state ID_{0,2} field 1315. This implies that one TCI state corresponding to TCI state ID_{0,1} is activated for the 0th codepoint of the TCI state field included in the DCI.

The above configuration may be independent for each cell or for each BWP. For example, the PCell may have a maximum of two activated TCI states corresponding to one TCI codepoint, whereas a specific SCell may have a maximum of one activated TCI state corresponding to one TCI codepoint. In this case, it may be considered that the NC-JT transmission is configured in the PCell, whereas the NC-JT transmission is not configured in the aforementioned SCell.

### Distinguishing Multi-TRP PDSCH Repetitive Transmission Schemes Based on Single-DCI (TDM/FDM/SDM)

A UE may be instructed with different multi-TRP PDSCH repetitive transmission schemes based on single-DCI (e.g., time division multiplexing (TDM), frequency division multiplexing (FDM), space division multiplexing (SDM) according to a value indicated via a DCI field from a base station and a higher layer signaling configuration. Table 40 below shows a method for distinguishing between single or multiple TRP-based schemes indicated to the UE according to the value of a specific DCI field and higher layer signaling configuration.

TABLE 40

| | | | repetitionNumber | | Transmission |
|---|---|---|---|---|---|
| | Number | Number | configuration | repetitionScheme | scheme |
| | of TCI | of CDM | and indication | configuration | indicated |
| Combination | states | groups | condition | related | to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP TDM |
| | | | | not configured | scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 2 | Condition 3 | Configured | Multi-TRP |
| | | | | | FDM scheme A/ |
| | | | | | FDM scheme B/ |
| | | | | | TDM scheme A |
| 9 | 2 | 2 | Condition 1 | Not configured | Multi-TRP TDM |
| | | | | | scheme B |

In Table 40, each column may be described as follows:

Number of TCI states (column 2): this denotes the number of TCI states indicated by the TCI state field in the DCI, and may be one or two.

Number of CDM groups (column 3): this denotes the number of different CDM groups of DMRS ports indicated by the antenna port field in the DCI. The number may be 1, 2 or 3.

The repetitionNumber configuration and indication condition (column 4): There may be three conditions depending on whether repetitionNumber is configured for all TDRA entries that can be indicated by the time domain resource allocation field in the DCI and whether the actually indicated TDRA entry has repetitionNumber configuration.

Condition 1 requires that at least one of all TDRA entries that can be indicated by the time domain resource allocation field includes configuration for repetitionNumber, and the TDRA entry indicated by the time domain resource allocation field in the DCI includes configuration for repetitionNumber greater than 1.

Condition 2 requires that at least one of all TDRA entries that can be indicated by the time domain resource allocation field includes configuration for repetitionNumber, and the TDRA entry indicated by the time domain resource allocation field in the DCI does not includes configuration for repetitionNumber.

Condition 3 requires that all TDRA entries that can be indicated by the time domain resource allocation field do not include configuration for repetitionNumber.

The repetitionScheme configuration related (column 5) indicates whether repetitionScheme, which is a higher layer signaling, is configured. One of ‘tdmSchemeA’, ‘fdmSchemeA’, and ‘fdmSchemeB’ may be configured for the higher layer signaling repetitionScheme.

The transmission scheme indicated to the UE (column 6) refers to single or multiple TRP schemes indicated according to each combination (column 1) shown above in Table 40.

A single-TRP denotes single-TRP based PDSCH transmission. If the UE is configured with pdsch-AggegationFactor in the higher layer signaling PDSCH-config, the UE may be scheduled with single-TRP based PDSCH repetitive transmission as many times as the configured number of times. Otherwise, the UE may be scheduled with a single-TRP based PDSCH single transmission.

A single-TRP TDM scheme B denotes PDSCH repetitive transmission based on time resource division between slots based on single TRP. According to the above-described Condition 1, the UE repeatedly transmits the PDSCH on time resources by the number of slots having the repetitionNumber greater than 1 configured in the TDRA entry indicated by the TDRA field. The same start symbol and symbol length of the PDSCH indicated by the TDRA entry are applied to each slot as many times as repetitionNumber, and the same TCI state is applied to each PDSCH repetition. This scheme is similar to the slot aggregation scheme in that the scheme performs PDSCH repetitive transmission between slots on time resources, but is different from the slot aggregation in that it is possible to dynamically determine whether to indicate repetitive transmission based on the time domain resource allocation field in the DCI.

The multi-TRP SDM denotes a PDSCH transmission scheme based on multi-TRP based spatial resource division. This is a method of performing reception from each TRP by dividing layers. Although it is not a repetition method, it is possible to increase the reliability of PDSCH transmission in that transmission is possible at a lower coding rate by increasing the number of layers. The UE may receive the PDSCH by applying two TCI states indicated through the TCI state field in the DCI to two CDM groups indicated by the base station, respectively.

The multi-TRP FDM scheme A denotes a PDSCH transmission scheme based on multi-TRP based frequency resource division. Although it is not a repetition method like multi-TRP SDM because it has one PDSCH transmission occasion, it is a scheme capable of transmission with high reliability by increasing the frequency resource amount and lowering the coding rate. Multi-TRP FDM scheme A may apply two TCI states indicated through the TCI state field in the DCI to frequency resources that do not overlap each other, respectively. In case that the PRB bundling size is determined to be wideband, and if the number of RBs indicated by the frequency domain resource allocation (FDRA) field is N, the UE receives the first ceil(N/2) RBs by applying the first TCI state and the remaining floor(N/2) RBs by applying the second TCI state. The ceil(.) and floor(.) are operators for rounding up and rounding off the first decimal place. In case that the PRB bundling size is determined to be 2 or 4, the UE receives even-numbered PRGs by applying the first TCI state and receives odd-numbered PRGs by applying the second TCI state.

The multi-TRP FDM scheme B denotes a PDSCH repetition scheme based on multi-TRP based frequency resource division, and is capable of repeatedly transmitting the PDSCH at two PDSCH transmission occasions. The multi-TRP FDM scheme B, like A, may also apply two TCI states indicated through the TCI state field in the DCI to non-overlapping frequency resources, respectively. In case that the PRB bundling size is determined to be wideband, and if the number of RBs indicated by the FDRA field is N, the UE receives the first ceil(N/2) RBs by applying the first TCI state and the remaining floor(N/2) RBs by applying the second TCI state. The ceil(.) and floor(.) are operators for rounding up and rounding off the first decimal place. In case that the PRB bundling size is determined to be 2 or 4, the UE receives even-numbered PRGs by applying the first TCI state and receives odd-numbered PRGs by applying the second TCI state.

The multi-TRP TDM scheme A denotes a PDSCH repetition scheme in a multi-TRP based time resource division slot. The UE has two PDSCH transmission occasions in one slot, and the first reception occasion may be determined based on the start symbol and symbol length of the PDSCH indicated through the time domain resource allocation field in the DCI. The start symbol of the second reception occasion of the PDSCH may be a position to which a symbol offset is applied as much as StartingSymbolOffsetK, which is higher layer signaling, from the last symbol of the first transmission occasion, and the transmission occasion may be determined by the symbol length indicated therefrom. If the higher layer signaling, StartingSymbolOffsetK, is not configured, the symbol offset may be regarded as 0.

The multi-TRP TDM scheme B denotes a PDSCH repetition scheme between multi-TRP based time resource division slots. The UE has one PDSCH transmission occasion in one slot, and may receive repetition transmission based on the start symbol and symbol length of the same PDSCH for a slot as many as the number of repetitionNumber times indicated through the time domain resource allocation field in the DCI. If repetitionNumber is 2, the UE may receive PDSCH repetition transmission in the first and second slots by applying the first and second TCI states, respectively. In case that repetitionNumber is greater than 2, the UE may use different TCI state applying schemes depending on which higher layer signaling tciMapping is configured. In case that tciMapping is configured as cyclicMapping, the first and second TCI states are applied to the first and second PDSCH transmission occasions, respectively, and this TCI state applying method is equally applied to the remaining PDSCH transmission occasions. In case that tciMapping is configured as sequentialMapping, the first TCI state is applied to the first and second PDSCH transmission occasions, and the second TCI state is applied to the third and fourth PDSCH transmission occasions. This TCI state applying method is applied to the remaining PDSCH transmission occasions in the same manner.

Radio Link Monitoring Reference Signal (RLM RS) Related

A UE may be configured with a set of RLM RSs from a base station through RadioLinkMonitoringRS in RadioLinkMonitoringConfig, which is higher layer signaling, for each DL BWP of SpCell, and a specific higher layer signaling structure is shown below in Table 41.

TABLE 41
RadioLinkMonitoringConfig ::= SEQUENCE {
failureDetectionResourcesToAddModList SEQUENCE (SIZE(1..maxNrofFailureDetectionResources)) OF

| | |
|---|---|
| RadioLinkMonitoringRS | OPTIONAL, -- Need N |

```
  failureDetectionResourcesToReleaseList SEQUENCE (SIZE(1..maxNrofFailureDetectionResources)) OF
RadioLinkMonitoringRS-Id OPTIONAL, -- Need N
  beamFailureInstanceMaxCount ENUMERATED {n1, n2, n3, n4, n5, n6, n8, n10}
OPTIONAL, -- Need R
  beamFailureDetection Timer ENUMERATED {pbfd1, pbfd2, pbfd3, pbfd4, pbfd5, pbfd6, pbfd8, pbfd10}
      OPTIONAL, -- Need
...
}
RadioLinkMonitoringRS ::= SEQUENCE {
  radioLinkMonitoringRS-Id  RadioLinkMonitoringRS-Id,
```

| | |
|---|---|
| purpose | ENUMERATED {beamfailure, rIf, both}, |
| detectionResource | CHOICE { |
| ssb-index | SSB-Index, |
| csi-RS-Index | NZP-CSI-RS-ResourceId |

},
...
}

Table 42 below may indicate the configurable or selectable number of RLM RSs for each specific use according to the maximum number of SSBs (Lₘₐₓ) per half frame. According to the Lₘₐₓ value, N_{LR-RLM} RSs may be used for link recovery or radio link monitoring, and N_{RLM} RSs among N_{LR-RLM} RSs may be used for radio link monitoring.

TABLE 42
Table 5-1: N_{LR-RLM} and N_{RLM} as a function of maximum
number Lₘₐₓ of SS/PBCH blocks per half frame

| Lₘₐₓ | N_{LR-RLM} | N_{RLM} |
|---|---|---|
| 4 | 2 | 2 |
| 8 | 6 | 4 |
| 64 | 8 | 8 |

In case that the UE is not configured with RadioLinkMonitoringRS, which is higher layer signaling, in case that the UE is configured with a TC state for receiving the PDCCH in the control resource set, and in case that at least one CSI-RS is included in the TCI state, the RLM RS may be selected according to the following RLM RS selection methods.

RLM RS Selection Method 1

In case that the activated TCI state to be used for PDCCH reception has one reference RS (i.e., one activated TCI state has only one of QCL-TypeA, B, or C), the UE may select the reference RS of the activated TCI state to be used for PDCCH reception as the RLM RS.

RLM RS Selection Method 2

In case that the activated TCI state to be used for PDCCH reception has two reference RSs (i.e., one activated TCI state has one of QCL-TypeA, B, or C, and further has QCL-TypeD), the UE may select the reference RS of QCL-TypeD as the RLM-RS. The UE does not expect that two QCL-TypeDs are configured in one activated TCI state.

RLM RS Selection Method 3

The UE does not expect that an aperiodic or semi-persistent RS is selected as the RLM RS.

RLM RS Selection Method 4

When Lₘₐₓ is 4, the UE may select N_{RLM} RSs (because Lₘₐₓ is 4, two can be selected).

The selection of the RLM RS is performed from among the reference RSs of the TCI state configured in the control resource set for PDCCH reception, based on the RLM RS selection methods 1 to 3. The short period of the search space to which the control resource set is linked is determined as high priority, and the RLM RS is selected from the reference RS of the TCI state configured in the control resource set linked to the search space of the shortest period. If there is a plurality of control resource sets linked to a plurality of search spaces having the same period, the RLM RS selection is performed from the reference RS of the TCI state configured in the high control resource set index.

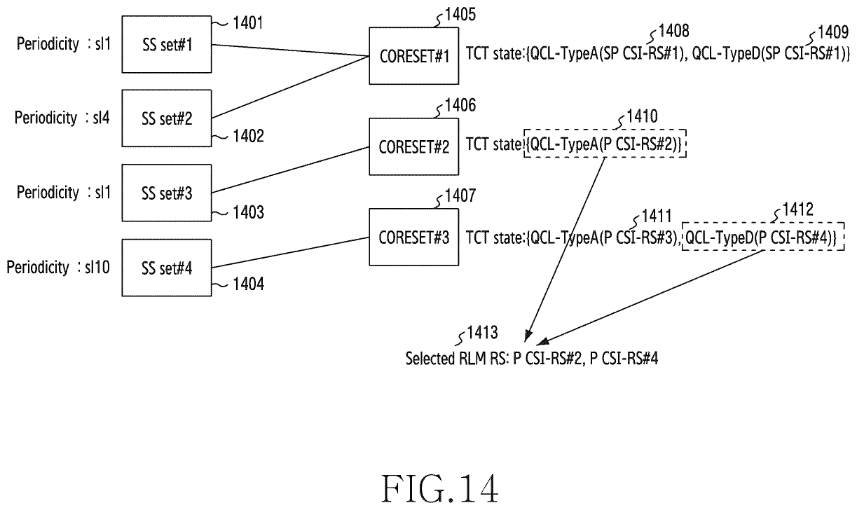

FIG. 14 illustrates an RLM RS selection process according to an embodiment. FIG. 14 illustrates a CORESET #1 14-05 to a CORESET #3 1407 linked to search space #1 1401, search space #2 1402, search space #3 1403 and search space to #4 1404 having different periods within the activated DL BWP, and the reference RS of the TCI state configured in each CORESET. Based on the RLM RS selection method 4, the RLM RS selection uses the TCI state configured in the CORESET linked to the search space of the shortest period. However, since the search space #1 1401 and the search space #3 1403 have the same period, the reference RS of the TCI state configured in CORESET #2 having a higher index between CORESET #1 1405 and CORESET #2 1406 linked to respective search spaces may be used as the highest priority in the RLM RS selection. In addition, since the TCI state configured in CORESET #2 has only QCL-TypeA, and the reference RS thereof is a periodic RS, the P CSI-RS #2 1410 may be first selected as the RLM RS by the RLM RS selection methods 1 and 3. The reference RS of QCL-TypeD may be a selection candidate by the RLM RS selection method 2 among the reference RSs 1408, 1409 of the TCI state configured in CORESET #1 having the next priority, but this RS is a semi-persistent RS 1409, and thus is not selected as the RLM RS by the RLM RS selection method 3. Therefore, the reference RSs 1411, 1412 of the TCI state configured in CORESET #3 may be considered as the next priority, and the reference RS of QCL-TypeD may be a selection candidate by the RLM RS selection method 2. Since this reference RS is a periodic RS, the P CSI-RS #4 1412 may be selected as the second RLM RS by the RLM RS selection method 3. Therefore, the finally selected RLM RS 1413 may be the P CSI-RS #2 and the P CSI-RS #4.

### Single TCI State Activation and Indication Method Based on Unified TCI Scheme

The unified TCI scheme may be for unifying and managing, as the TCI state, the transmission and reception beam management scheme divided into the TCI state scheme used in the DL reception and the spatial relation information scheme used in the UL transmission of the UE in the existing Rel-15 and 16. Hence, in case of being indicated from a base station with the TCI state based on the unified TC scheme, the UE may perform beam management using the TCI state even for the UL transmission. If the UE is configured with higher layer signaling TCI-State having higher layer signaling tci-stateId-r17 from the base station, the UE may perform an operation based on the unified TC scheme by using the corresponding TCI-State, which may include two types of a joint TCI state or a separate TCI state.

The first type is the joint TCI state, and the UE may be indicated from the base station with the TCI state to apply for the UL transmission and the DL reception through one TCI-State. If the UE is indicated with TCI-State based on the joint TCI state, the UE may be indicated with a parameter to use for DL channel estimation using an RS corresponding to qcl-Type1 of the corresponding joint TCI state based TCI-State, and a parameter to use as a DL reception beam or a reception filter using an RS corresponding to qcl-Type2. If the UE is indicated with TCI-State based on the joint TCI state, the UE may be indicated with a parameter to use as an UL transmission beam or a transmission filter using the RS corresponding to qcl-Type2 of the corresponding joint DL/UL TCI state-based TCI-State. In case that the UE is indicated with the joint TCI state-based TCI-State, the UE may apply the same beam to the UL transmission and the DL reception.

The second type is the separate TCI state, and the UE may be indicated from the base station individually with a UL TCI state to apply for the UL transmission and a DL TCI state to apply for the DL reception. If the UE is indicated with the UL TCI state, the UE may be indicated with a parameter to use as a UL transmission beam or a transmission filter using a reference RS or a source RS configured in the corresponding UL TCI state. If the UE is indicated with the DL TCI state, the UE may be indicated with a parameter to use for DL channel estimation using the RS corresponding to qcl-Type1 configured in the corresponding DL TCI state, and a parameter to use as a DL reception beam or a reception filter using the RS corresponding to qcl-Type2.

If the UE is indicated with the DL TCI state and the UL TCI state together, the UE may be indicated with the parameter to use as the UL transmission beam or the transmission filter using the reference RS or the source RS configured in the corresponding UL TCI state. If the UE is indicated with the DL TCI state and the UL TCI state together, the UE may be indicated with the parameter to use for the DL channel estimation using the RS corresponding to qcl-Type1 configured in the corresponding DL TCI state, and the parameter to use as the DL reception beam or the reception filter using the RS corresponding to qcl-Type2. In case that the reference RSs or the source RSs configured in the DL TCI state and the UL TCI state indicated to the UE are different, the UE may apply the UL transmission beam based on the indicated UL TCI state and apply the DL reception beam based on the DL TCI state.

The UE may be configured from the base station with up to 128 joint TCI states for each specific BWP in a specific cell through higher layer signaling. In addition, up to 64 or 128 DL TCI states of the separate TCI state may be configured for each specific BWP in a specific cell through higher layer signaling based on a UE capability report. The DL TCI state of the separate TCI state and the joint TCI state may use the same higher layer signaling structure. For example, if 128 joint TCI states are configured and 64 DL TCI states are configured in the separate TCI state, 64 DL TCI states may be included in 128 joint TCI states.

Up to 32 or 64 UL TCI states of the separate TCI state may be configured for each specific BWP in a specific cell through higher layer signaling based on a UE capability report, the UL TCI state of the separate TCI state and the joint TCI state may use the same higher layer signaling structure, in the manner of the relationship of the DL TCI state of the separate TCI state and the joint TCI state. The UL TCI state of the separate TCI state may use a different higher layer signaling structure from the joint TCI state and the DL TCI state of the separate TCI state. As such, using the different or the same higher layer signaling structure may be defined in the standard, and may be distinguished through yet another higher layer signaling configured by the base station, based on a UE capability report containing information of whether to use one of the two types supported by the UE.

The UE may receive a transmission and reception beam-related indication in the unified TCI manner using one of the joint TCI state and the separate TCI state configured from the base station. The UE may be configured from the base station whether to use one of the joint TCI state and the separate TCI state through higher layer signaling.

The UE may receive the transmission and reception beam-related indication using one scheme selected from the joint TCI state and the separate TCI state through higher layer signaling. The transmission and reception beam indication method from the base station may include two methods of a MAC-CE based indication method and a MAC-CE based activation and DCI based indication method.

In case that the UE receives the transmission and reception beam-related indication using the joint TCI state through higher layer signaling, the UE may perform a transmission and reception beam application operation by receiving a MAC-CE indicating the joint TCI state from the base station, and the base station may schedule reception of the PDSCH including the corresponding MAC-CE to the UE via PDCCH. If the MAC-CE includes one joint TCI state, the UE may transmit PUCCH including HARQ-ACK information indicating whether the PDSCH including the corresponding MAC-CE is successfully received to the base station, and may determine a UL transmission beam or a transmission filter and a DL reception beam or a reception filter using the joint TCI state indicated from a specific time point (e.g., 3 ms) after transmission of the PUCCH. If the MAC-CE includes two or more joint TCI states, the UE may transmit, to the base station, a PUCCH including HARQ-ACK information indicating whether the PDSCH including the corresponding MAC-CE is successfully received, may identify that the plurality of the joint TCI states indicated from 3 ms after the PUCCH transmission corresponds to respective codepoints of the TCI state field of DCI format 1_1 or 1_2, and may activate the joint TCI state indicated by the MAC-CE. Thereafter, the UE may receive DCI format 1_1 or 1_2 and apply one joint TCI state indicated by the TCI state field of the corresponding DCI to the UL transmission and DL reception beams. DCI format 1_1 or 1_2 may include DL data channel scheduling information (with DL assignment), or may not include the same (without DL assignment).

In case that the UE receives the transmission and reception beam-related indication using the separate TCI state through higher layer signaling, the UE may perform the transmission and reception beam application operation by receiving the MAC-CE indicating the separate TCI state from the base station, and the base station may schedule, to the UE, PDSCH including the corresponding MAC-CE via the PDCCH. If the MAC-CE includes one separate TCI state set, the UE may transmit PUCCH including HARQ-ACK information indicating whether the PDSCH is successfully received to the base station, and may determine a UL transmission beam or a transmission filter and a DL reception beam or a reception filter using the separate TCI state included in the separate TCI state set indicated from 3 ms after transmission of the PUCCH. The separate TCI state set may imply a single or multiple separate TCI states that one codepoint in the TCI state field within DCI format 1_1 or 1_2 can have, and one separate TCI state set may include one DL TCI state, one UL TCI state, or may include one DL TCI state and one UL TCI state. If the MAC-CE includes two or more separate TCI state sets, the UE may transmit, to the base station, a PUCCH including HARQ-ACK information indicating whether the corresponding PDSCH is successfully received, may identify that the plurality of the separate TCI state sets indicated by the MAC-CE correspond to respective codepoints of the TCI state field of DCI format 1_1 or 1_2 from 3 ms after the PUCCH transmission, and may activate the indicated separate TCI state set. Each codepoint of the TCI state field of DCI format 1_1 or 1_2 may indicate one DL TCI state, one UL TCI state, or one DL TCI state and one UL TCI state. The UE may receive DCI format 1_1 or 1_2 and apply the separate TCI state set indicated by the TCI state field of the corresponding DCI to the UL transmission and DL reception beams. DCI format 1_1 or 1_2 may or may not include DL data channel scheduling information (with or without DL assignment).

The above MAC-CE used to activate or indicate the single joint TCI state and the separate TCI state may exist per joint and separate TCI state scheme, and the TCI state may be activated or indicated based on one of the joint or separate TCI state scheme using one MAC-CE. Various MAC-CE structures for activating and indicating the joint or separate TCI state may be considered.

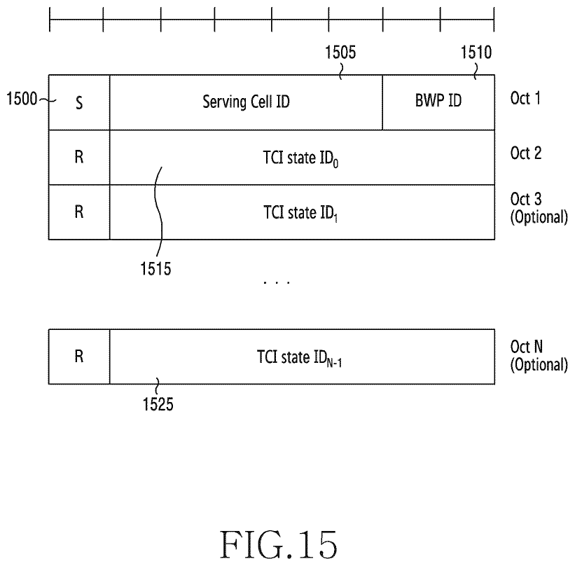

FIG. 15 illustrates a MAC-CE structure for joint TCI state activation and indication in a wireless communication system according to an embodiment.

Referring to FIG. 15, an S field 1500 may indicate the number of joint TCI state information included in a MAC-CE. If a value of the S field 1500 is 1, the corresponding MAC-CE may indicate one joint TCI state, and may have the length only up to a second octet. If the value of the S field 1500 is 0, the corresponding MAC-CE may include two or more joint TCI state information, each joint TCI state may be activated at each codepoint of the TCI state field of DCI format 1_1 or 1_2, and up to eight joint TCI states may be activated. The configuration of the 0 and 1 values of the S field 1500 is not limited to the above configuration method, and a value of 0 may indicate inclusion of one joint TCI state, and a value of 1 may indicate inclusion of two or more joint TCI state information. This interpretation of the S field may also be applied to other embodiments herein. The TCI states indicated via TCI state ID₀ field 1515 to TCI state ID_{N-1} field 1525 may correspond to the 0th to (N−1)th codepoints of the TCI state field in DCI format 1_1 or 1_2, respectively. A serving Cell ID field 1505 may indicate a serving cell ID, and a BWP ID field 1510 may indicate a bandwidth part ID. An R field may be a 1-bit reserved field that does not include indication information.

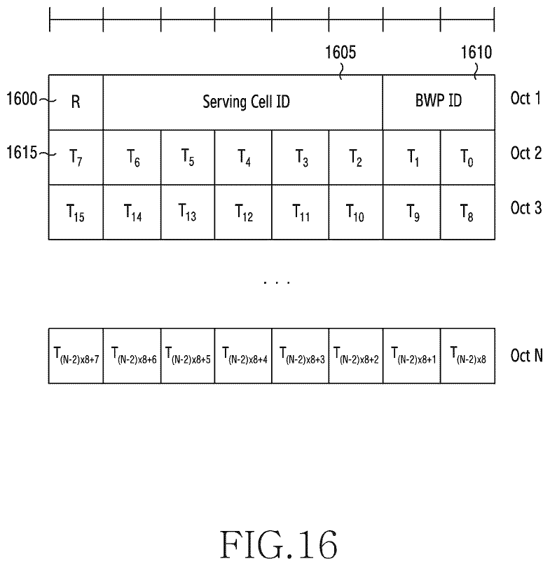

FIG. 16 illustrates a MAC-CE structure for joint TCI state activation and indication in a wireless communication system according to an embodiment.

In FIG. 16, a serving cell ID field 1605 may indicate a serving cell ID and a BWP ID field 1610 may indicate a BWP ID. An R field 1600 may be a 1-bit reserved field without indication information. Each field existing in second to N-th octets is a bitmap indicating the joint TCI state configured with higher layer signaling. For example, T₇ 1615 may indicate an eighth joint TCI state configured with the higher layer signaling. If the T_{N} value is 1, the corresponding joint TCI state may be interpreted as being indicated or activated, and if the T_{N} value is 0, the corresponding joint TCI state may be interpreted as not being indicated or deactivated. Configuration of the 0 and 1 values is not limited to the above configuration method. In case that the MAC-CE structure of FIG. 16 delivers one joint TCI state, the UE may apply the joint TCI state indicated by the MAC-CE to UL transmission and DL reception beams. If the MAC-CE structure delivers two or more joint TCI state, the UE may identify that each joint TCI state indicated by the MAC-CE corresponds to each codepoint of the TCI state field of DCI format 1_1 or 1_2, and may activate each joint TCI state. If the MAC-CE structure delivers two or more joint TCI states, the UE may correspond and activate the indicated joint TCI states to the codepoints of the TCI state field of DCI format 1_1 or 1_2 in ascending order of index.

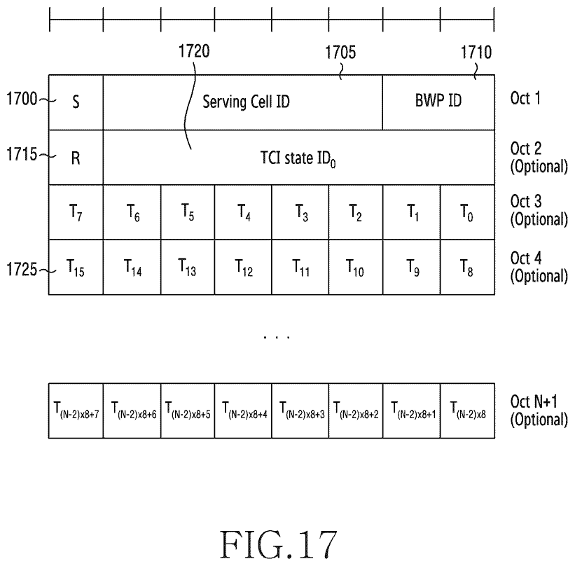

FIG. 17 illustrates a third MAC-CE structure for joint TCI state activation and indication in a wireless communication system according to an embodiment.

Referring to FIG. 17, a serving cell ID field 1705 may indicate a serving cell ID, and a BWP ID field 1710 may indicate a BWP ID.

An S field 1700 may indicate the number of joint TCI state information included in a MAC-CE. If a value of the S field 1700 is 1, the corresponding MAC-CE may indicate one joint TCI state, and may include only up to a second octet, and the joint TCI state may be indicated to a UE through a TCI state ID₀ field 1720. For example, if the value of the S field 1700 is 0, the corresponding MAC-CE may include two or more joint TCI state information. If the value of the S field 1700 is 0, each joint TCI state may be activated at each codepoint of the TCI state field of DCI format 1_1 or 1_2, up to eight joint TCI states may be activated, the second octet does not exist, and a first octet and a third octet to an (N+1)-th octet may exist in the MAC-CE structure of FIG. 17. Each field existing in the third octet to the (N+1)-th octet is a bitmap indicating the joint TCI state configured with higher layer signaling. For example, T₁₅ 1725 may indicate whether to indicate a sixteenth joint TCI state configured with the higher layer signaling. An R field 1715 may be a 1-bit reserved field that does not include indication information.

In case that the MAC-CE structure of FIG. 17 delivers one joint TCI state, the UE may apply the joint TCI state indicated by the MAC-CE to UL transmission and DL reception beams. In case that the MAC-CE structure of FIG. 17 delivers two or more joint TCI states, the UE may identify that each joint TCI state indicated by the MAC-CE corresponds to each codepoint of the TCI state field of DCI format 1_1 or 1_2, activate each joint TCI state, and correspond and activate the indicated joint TCI states to the codepoints of the TCI state field of DCI format 1_1 or 1_2 in ascending order of index.

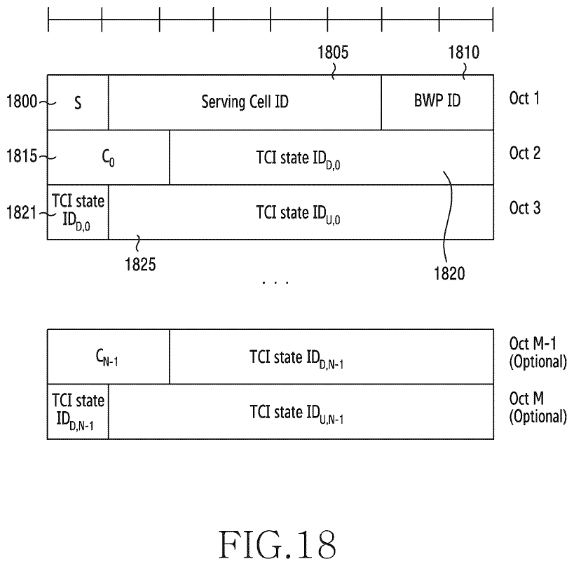

FIG. 18 illustrates a MAC-CE structure for separate TCI state activation and indication in a wireless communication system according to an embodiment.

In FIG. 18, a serving cell ID field 1805 may indicate a serving cell ID, and a BWP ID field 1810 may indicate a BWP ID.

An S field 1800 may indicate the number of separate TCI state set information included in a MAC-CE. For example, if a value of the S field 1800 is 1, the corresponding MAC-CE may indicate one separate TCI state set, and include only up to a third octet. For example, if the value of the S field 1800 is 0, the corresponding MAC-CE may include two or more separate TCI state set information, each codepoint of the TCI state field of DCI format 1_1 or 1_2 may activate each separate TCI state set, and up to eight separate TCI state sets may be activated. A C₀ field 1815 may indicate which separate TCI states are included in the indicated separate TCI state set. For example, the C₀ field value 00 may indicate reserve, 01 may indicate one DL TCI state, 10 may indicate one UL TCI state, and 11 may indicate one DL TCI state and one UL TCI state, but this is the interpretation of C₀ field 1815 and does not limit the interpretation of C₀ field 1815. A TCI state ID_{D,0} field 1820 and a TCI state ID_{U,0} field 1825 may indicate the DL TCI state and the UL TCI state respectively included and indicated in a 0-th separate TCI state set. If the C₀ field value is 01, the TCI state ID_{D,0} field 1820 may indicate the DL TCI state and the TCI state ID_{U,0} field 1825 may be disregarded. If the C₀ field value is 10, the TCI state ID_{D,0} field 1820 may be disregarded and the TCI state ID_{U,0} field 1825 may indicate the UL TCI state. If the C₀ field value is 11, the TCI state ID_{D,0} field 1820 may indicate the DL TCI state and the TCI state ID_{U,0} field 1825 may indicate the UL TCI state.

FIG. 18 illustrates the MAC-CE in case that the UL TCI state of the separate TCI state uses the same higher layer signaling structure as the DL TCI state of the separate TCI state and the joint TCI state. Accordingly, the length of the TCI state ID_{D,0} field 1820 and the TCI state ID_{U,0} field 1825 may be 7 bits for representing up to 128 TCI states. Hence, 6 bits 1820 may be allocated to the second octet and one bit 1821 may be allocated to the third octet to use 7 bits as the TCI state ID_{D,0} field 1820. In addition, FIG. 18 illustrates that the UL TCI state of the separate TCI state uses a different higher layer signaling structure from the DL TCI state of the separate TCI state and the joint TCI state. Accordingly, since the UL TCI state requires 6 bits to represent up to 64 states, a first bit of the TCI state ID_{U,0} field 1825 may be fixed to 0 or 1 and actual bits representing the UL TCI state may correspond to only 6 bits in total from the second bit to the seventh bit.

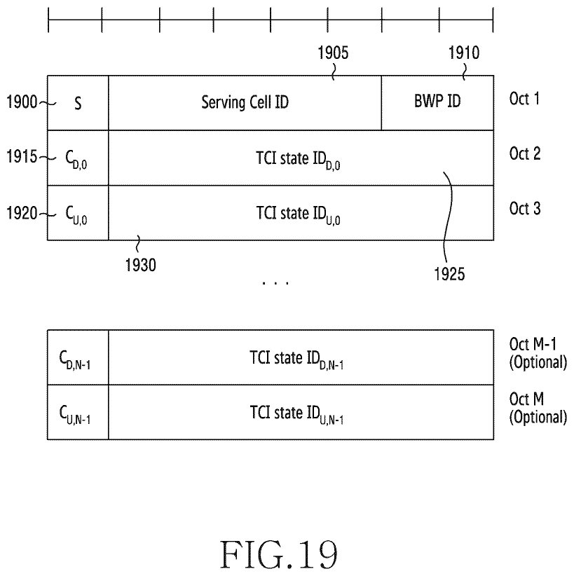

FIG. 19 illustrates a MAC-CE structure for separate TCI state activation and indication in a wireless communication system according to an embodiment.

Referring to FIG. 19, a serving cell ID field 1905 may indicate a serving cell ID, and a BWP ID field 1910 may indicate a BWP ID. An S field 1900 may indicate the number of separate TCI state set information included in a MAC-CE. For example, if a value of the S field 1900 is 1, the corresponding MAC-CE may indicate one separate TCI state set, and include only up to a third octet. If the value of the S field 1900 is 0, the corresponding MAC-CE may include two or more separate TCI state set information, each codepoint of the TCI state field of DCI format 1_1 or 1_2 may correspond to each separate TCI state set to activate each separate TCI state set, and up to eight separate TCI state sets may be activated. A C_{D,0} field 1915 may indicate whether the indicated separate TCI state set includes the DL TCI state, and if a value of the C_{D,0} field 1915 is 1, the DL TCI state may be included and the DL TCI state may be indicated by a TCI state ID_{D,0} field 1925. If the value of the C_{D,0} field 1915 is 0, the DL TCI state may not be included and the TCI state ID_{D,0} field 1925 may be disregarded. A C_{U,0} field 1920 may indicate whether the indicated separate TCI state set includes the UL TCI state, and if the value of C_{U,0} field 1920 is 1, the UL TCI state may be included and the UL TCI state may be indicated by a TCI state ID_{U,0} field 1930. If the value of the C_{U,0} field value 1920 is 0, the UL TCI state may not be included and the TCI state Duo field 1930 may be disregarded.

FIG. 19 illustrates the MAC-CE in case that the UL TCI state of the separate TCI state uses the same higher layer signaling structure as the DL TCI state of the separate TCI state and the joint TCI state. Accordingly, the length of the TCI state ID_{D,0} field 1925 and the TCI state ID_{U,0} field 1930 may be 7 bits for representing up to 128 TCI states. In addition, FIG. 19 may show the MAC-CE in case that the UL TCI state of the separate TCI state uses a different higher layer signaling structure from the DL TCI state of the separate TCI states and the joint TCI state. Accordingly, since the UL TCI state requires 6 bits to represent up to 64 states, a first bit of the TCI state ID_{U,0} field 1930 may be fixed to 0 or 1 and actual bits representing the UL TCI state may correspond to only 6 bits in total from the second bit to the seventh bit.

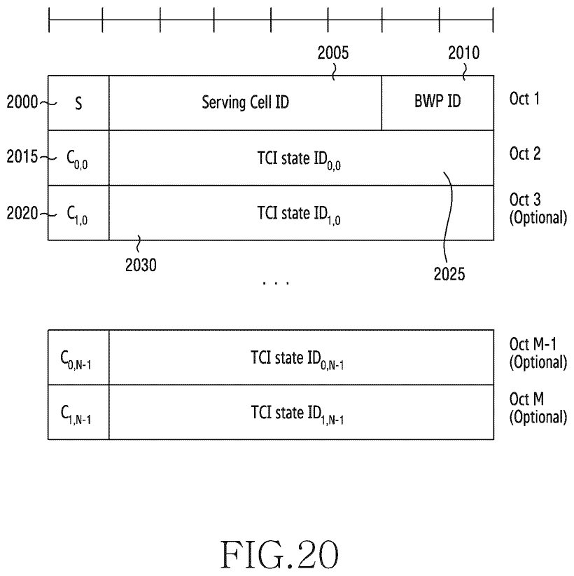

FIG. 20 illustrates a MAC-CE structure for separate TCI state activation and indication in a wireless communication system according to an embodiment.

In FIG. 20, a serving cell ID field 2005 may indicate a serving cell ID, and a BWP ID field 2010 may indicate a BWP ID. An S field 2000 may indicate the amount of separate TCI state set information included in a MAC-CE. For example, if a value of the S field 2000 is 1, the corresponding MAC-CE may indicate one separate TCI state set, and include only up to a third octet. The MAC-CE structure of FIG. 20 may indicate one separate TCI state set using two octets, and if the corresponding separate TCI state set includes the DL TCI state, a first octet of the two octets may indicate the DL TCI state and a second octet may indicate the UL TCI state. The above sequence may be changed.

For example, if the value of the S field 2000 is 0, the corresponding MAC-CE may include two or more separate TCI state set information, each codepoint of the TCI state field of DCI format 1_1 or 1_2 may activate each separate TCI state set, and up to eight separate TCI state sets may be activated. A C_{0,0} field 2015 may distinguish whether the TCI state indicated by a TCI state ID_{0,0} field 2025 is the DL TCI state or the UL TCI state. The value of the C_{0,0} field 2015 is 1, the TCI state may indicate the DL TCI state, the DL TCI state may be indicated through the TCI state ID_{0,0} field 2025, and a third octet may exist. If the value of a C_{1,0} field 2020 is 1, the UL TCI state may be indicated by a TCI state ID_{1,0} field 2030. In case that the value of the C_{1,0} field 2020 is 0, the TCI state ID_{1,0} field 2030 may be disregarded. In case that the value of the C_{0,0} field 2015 is 0, the TCI state ID_{0,0} field 2025 may indicate the UL TCI state, and the third octet may not exist. This interpretation of the C_{0,0} field 2015 and C_{1,0} field 2020 is only an example and does not exclude a different interpretation of the 0, 1 values of the C_{0,0} field 2015, or a different interpretation of the DL TCI state and UL TCI state values.

FIG. 20 illustrates the MAC-CE in case that the UL TCI state of the separate TCI state uses the same higher layer signaling structure as the DL TCI state of the separate TCI state and the joint TCI state. Accordingly, the length of the TCI state ID_{0,0} field 2025 and the TCI state ID_{1,0} field 2030 may be 7 bits for representing up to 120 TCI states. In addition, FIG. 20 illustrates the MAC-CE in case that the UL TCI state of the separate TCI state uses a different higher layer signaling structure from the DL TCI state of the separate TCI state and the joint TCI state as mentioned above. Accordingly, the TCI state ID_{0,0} field 2025 may include 7 bits for representing 6 bits to represent up to 64 UL TCI states and 7 bits to represent up to 120 DL TCI states. In case that the value of the C_{0,0} field 2015 is 1 and the TCI state ID_{0,0} field 2025 indicates the UL TCI state, a first bit of the TCI state ID_{0,0} field 2025 may be fixed to 0 or 1 and actual bits representing the UL TCI state may correspond to only 6 bits in total from the second bit to the seventh bit.

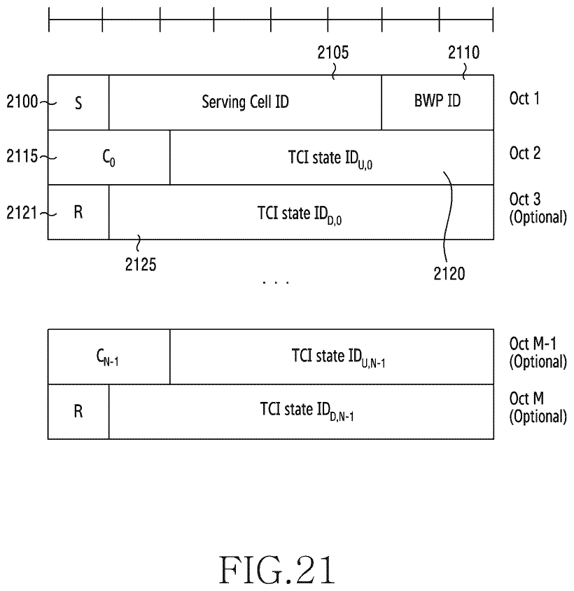

FIG. 21 illustrates a MAC-CE structure for separate TCI state activation and indication in a wireless communication system according to an embodiment.

In FIG. 21, a serving cell ID field 2105 and a BWP ID field 2110 may indicate a serving cell ID and a BWP ID, respectively. An S field 2000 may indicate the number of separate TCI state set information included in a MAC-CE. For example, if a value of the S field 2100 is 1, the corresponding MAC-CE may indicate one separate TCI state set, and include only up to a third octet.

For example, if the value of the S field 2100 is 0, the corresponding MAC-CE may include two or more separate TCI state set information, each codepoint of the TCI state field of DCI format 1_1 or 1_2 may activate each separate TCI state set, and up to eight separate TCI state sets may be activated. A C₀ field 2115 may indicate which separate TCI states are included in the indicated separate TCI state set. For example, the C₀ field value 00 may indicate reserve, 01 may indicate one DL TCI state, 10 may indicate one UL TCI state, and 11 may indicate one DL TCI state and one UL TCI state, but this does not limit the interpretation of C₀ field 2115. A TCI state ID_{U,0} field 2120 and a TCI state ID_{D,0} field 2125 may indicate the UL TCI state and the DL TCI state respectively included and indicated in a 0-th separate TCI state set. If the value of the C₀ field 2115 is 01, the TCI state ID_{D,0} field 2125 may indicate the DL TCI state and the TCI state ID_{U,0} field 2120 may be disregarded. If the value of the C₀ field 2115 is 10, the third octet may be disregarded and the TCI state ID_{U,0} field 2120 may indicate the UL TCI state. In case that the value of the C₀ field 2115 is 11, the TCI state ID_{D,0} field 2125 may indicate the DL TCI state and the TCI state ID_{U,0} field 2120 may indicate the UL TCI state.

FIG. 21 illustrates the MAC-CE used if the UL TCI state of the separate TCI state uses a different higher layer signaling structure from the DL TCI state of the separate TCI state and the joint TCI state. Accordingly, the length of the TCI state ID_{D,0} field 2125 may use 7 bits for representing up to 128 TCI states, and the length of the TCI state ID_{U,0} field 2120 may use 6 bits for representing up to 64 TCI states.

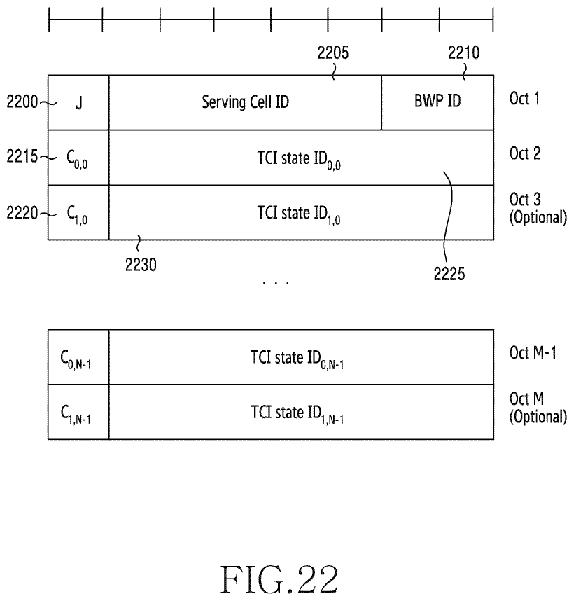

FIG. 22 illustrates a MAC-CE structure for joint and separate TCI state activation and indication in a wireless communication system according to an embodiment.

In FIG. 22, a serving cell ID field 2205 may indicate a serving cell ID, and a BWP ID field 2210 may indicate a BWP ID. The J field 2200 may indicate whether the TCI state indicated by the MAC CE is a joint TCI state or a separate TCI state set. For example, if the value of the J field 2200 is 1, the corresponding MAC-CE may indicate the joint TCI state, and if the value of the J field 2200 is 0, the corresponding MAC-CE may indicate the separate TCI state set. The above interpretation of the J field 2200 is only an example, and does not exclude a different interpretation.

In case that the corresponding MAC-CE indicates the joint TCI state, every odd-numbered octet (third, fifth, . . . ) excluding a first octet may be disregarded. A C_{0,0} field 2215 may indicate whether the corresponding MAC-CE indicates one joint TCI state. The C_{0,0} field 2215 may include two or more TCI state information, and indicate whether to activate each TCI state at each codepoint of the TCI state field of DCI format 1_1 or 1_2. In case that a value of the C_{0,0} field 2215 is 1, the corresponding MAC-CE may indicate one joint TCI state, and octets from the third octet may not exist. In case that the value of the C_{0,0} field 2215 is 0, the two or more joint TCI states indicated by the corresponding MAC-CE may correspond to each codepoint of the TCI state field of DCI format 1_1 or 1_2 and may be activated. A TCI state ID_{0,0} may indicate a first joint TCI state.

In case that the corresponding MAC-CE indicates the separate TCI state set the C_{0,0} field 2215 may distinguish whether the TCI state indicated by the TCI state ID_{0,0} 2225 is the DL TCI state or the UL TCI state. If a value of the C_{0,0} field is 1, the TCI state ID_{0,0} 2225 may indicate the DL TCI state through the TCI state ID_{0,0} field and the third octet may exist. In this case, if a value of a C_{1,0} field 2220 is 1, the UL TCI state may be indicated by a TCI state ID_{1,0} 2230, and if the value of the C_{1,0} field 2220 is 0, the TCI state ID_{1,0} 2230 may be disregarded. If the value of the C_{0,0} field 2215 is 0, the UL TCI state may be indicated by the TCI state ID_{0,0} 2225 and the third octet may not exist. FIG. 22 may show the MAC-CE used if the UL TCI state of the separate TCI state uses the same higher layer signaling structure as the DL TCI state of the separate TCI state and the joint TCI state. Accordingly, the length of the TCI state ID_{0,0} field 2225 and the TCI state ID_{1,0} field 2230 may be 7 bits for representing up to 128 TCI states. In addition, FIG. 22 may show the MAC-CE used in case that the UL TCI state of the separate TCI state uses a different higher layer signaling structure from the DL TCI state of the separate TCI state and the joint TCI state. Accordingly, the TCI state ID_{0,0} field 2225 may use 7 bits for representing 6 bits to represent up to 64 UL TCI states and 7 bits to represent up to 128 DL TCI states. If the value of the C_{0,0} field 2215 is 1 and the TCI state ID_{0,0} field 2225 indicates the UL TCI state, the first bit of the TCI state ID_{0,0} field 2225 may be fixed to 0 or 1 and actual bits representing the UL TCI state may correspond to only 6 bits in total from the second bit to the seventh bit.

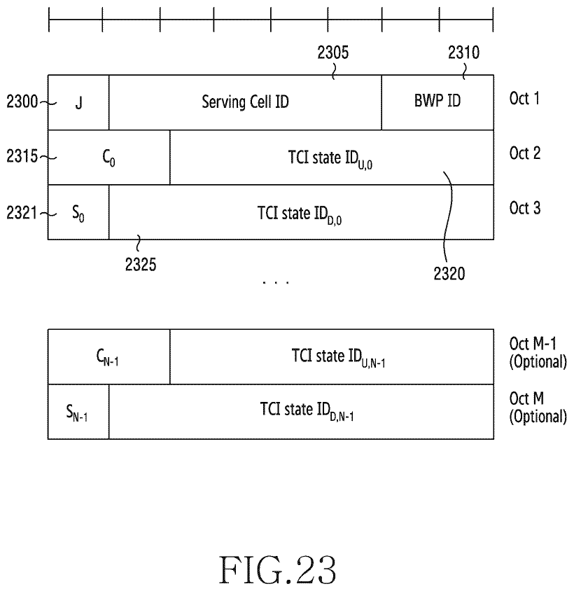

FIG. 23 illustrates a MAC-CE structure for joint and separate TCI state activation and indication in a wireless communication system according to an embodiment.

In FIG. 23, a serving cell ID field 2305 and a BWP ID field 2310 may indicate a serving cell ID and a BWP ID, respectively. The J field 2300 may indicate whether a TCI state indicated through a MAC CE is a joint TCI state or a separate TCI state set. For example, if a value of the J field 2300 is 1, the corresponding MAC-CE may indicate the joint TCI state, and the value of the J field is 0, the corresponding MAC-CE may indicate the separate TCI state set. The above interpretation of the J field 2300 is only an example, and does not exclude an opposite interpretation.

If the corresponding MAC-CE indicates the joint TCI state, every even-numbered octet (second, fourth, . . . ) excluding a first octet may be disregarded. An S₀ field 2321 may indicate whether the corresponding MAC-CE indicates one joint TCI state, and whether two or more TCI states correspond to respective codepoints of the TCI state field of DCI format 1_1 or 1_2 and activated. If a value of the S₀ field 2321 is 1, the corresponding MAC-CE may indicate one joint TCI state, and may not exist from the third octet. If the value of the S₀ field 2321 is 0, the corresponding MAC-CE may include two or more joint TCI state information, and activate each joint TCI state at each codepoint of the TCI state field of DCI format 1_1 or 1_2. A TCI state ID_{D,0} 2325 may indicate a first joint TCI state.

If the corresponding MAC-CE indicates the separate TCI state set, a C₀ field 2315 may indicate which separate TCI states are included in the indicated separate TCI state set. For example, a value of the C₀ field 2315 of 00 may indicate reserve, 01 may indicate one DL TCI state, 10 may indicate one UL TCI state, and 11 may indicate one DL TCI state and one UL TCI state. These values are merely examples and the disclosure is not limited by these examples. A TCI state ID_{U,0} field 2320 and a TCI state ID_{D,0} field 2325 may indicate the UL TCI state and the DL TCI state respectively included and indicated in a 0-th separate TCI state set. If the value of the C₀ field 2315 is 01, the TCI state ID_{D,0} field 2325 may indicate the DL TCI state and the TCI state ID_{U,0} field 2320 may be disregarded. If the value of the C₀ field 2315 is 10, the TCI state ID_{U,0} field 2320 may indicate the UL TCI state. If the value of the C₀ field 2315 is 11, the TCI state ID_{D,0} field 2325 may indicate the DL TCI state and the TCI state ID_{U,0} field 2320 may indicate the UL TCI state. If a value of the S0 field 2321 is 1, the corresponding MAC-CE may indicate one separate TCI state set, and may not exist from a fourth octet. If the value of the S₀ field 2321 is 0, the corresponding MAC-CE may include two or more separate TCI state set information, activate each separate TCI state set at each codepoint of the TCI state field of DCI format 1_1 or 1_2, and activate up to 8 separate TCI state sets. If the value of the S₀ field 2321 is 0 and a value of C₁, . . . , C_{N-1} field is 10, this implies that only the UL TCI state is indicated, and thus the fifth, seventh, . . . , M-th octets may be disregarded. Alternatively, the S₀ field may indicate whether there exists an octet for a next separate TCI state set. For example, if a value of the S₀ field is 1, the next octet may not exist, and if a value of the S₀ field is 0, the next octet including C₁+ and a TCI state ID_{U,n+1} may exist. This value of the S₀ field is only an example, and the disclosure is not limited thereto.

FIG. 23 illustrates the MAC-CE used in case that the UL TCI state of the separate TCI state uses a different higher layer signaling structure from the DL TCI state of the separate TCI state and the joint TCI state. Accordingly, the length of the TCI state ID_{D,0} field 2325 may use 7 bits for representing up to 128 TCI states, and the length of the TCI state ID_{U,0} field 2320 may use 6 bits for representing up to 64 TCI states.

In case that the UE receives the transmission and reception beam-related indication using the joint TCI state scheme or the separate TCI state scheme through higher layer signaling, the UE may perform transmission and reception beam application by receiving the PDSCH including the MAC-CE indicating the joint TCI state or the separate TCI state from the base station. If the MAC-CE includes two or more joint TCI state or separate TCI state sets, the UE may identify that the plurality of joint TCI state or separate TCI state sets indicated by the MAC-CE corresponds to respective codepoints of the TCI state field of DCI format 1_1 or 1_2, and activate the indicated joint TCI state or separate TCI state sets from 3 ms after PUCCH transmission including HARQ-ACK information indicating whether corresponding PDSCH is successfully received. Thereafter, the UE may receive DCI format 1_1 or 1_2 and apply one joint TCI state or separate TCI state set indicated by the TCI state field of the corresponding DCI to the UL transmission and DL reception beams. DCI format 1_1 or 1_2 may or may not include DL data channel scheduling information (that is, with or without DL assignment).

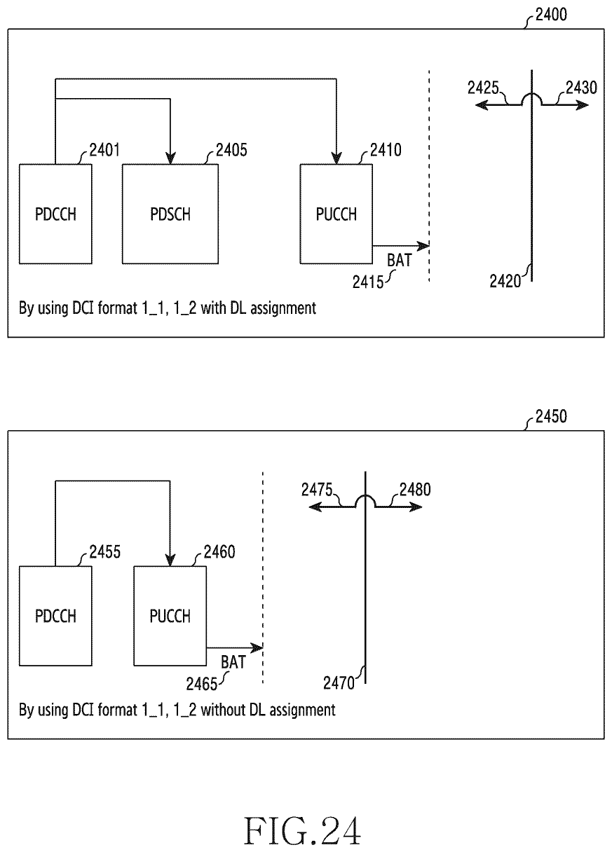

FIG. 24 illustrates a beam application time that can be considered in case of using a unified TCI scheme in a wireless communication system according to an embodiment.

The UE may receive DCI format 1_1 or 1_2 with or without DL data channel scheduling information (DL assignment) from the base station, and may apply one joint TCI state or separate TCI state set indicated by the TCI state field of the corresponding DCI to the UL transmission and DL reception beams.

For DCI format 1_1 or 1_2 with DL assignment 2400, in case that the UE receives DCI format 1_1 or 1_2 including the DL data channel scheduling information (PDCCH) 2401 from the base station to indicate one joint TCI state or separate TCI state set based on the unified TC scheme, the UE may receive a PDSCH 2405 scheduled based on the received DCI, and may transmit, to the base station, a PUCCH 2410 including HARQ-ACK indicating reception success or failure of the DCI and the PDSCH. The HARQ-ACK may include success or failure of the DCI and the PDSCH, the UE may transmit a negative acknowledgement (NACK) in case of not receiving at least one of the DCI and the PDSCH, and the UE may transmit an ACK in case of successfully receiving both the DCI and the PDSCH.

For DCI format 1_1 or 1_2 without the DL assignment 2450, in case that the UE receives DCI format 1_1 or 1_2 not including the DL data channel (PDCCH) 2455 scheduling information from the base station to indicate one joint TCI state or separate TCI state set based on the unified TCI scheme, the UE may assume that for the corresponding DCI, a CRC is included and is scrambled by using CS-RNTI, every bit value allocated to fields used as redundancy version (RV) fields is 1, every bit value allocated to fields used as MCS fields is 1, every bit value allocated to fields used as new data indication (NDI) fields is 1, and every bit value allocated to a FDRA field is 0 for FDRA type 0, every bit value allocated to the FDRA field is 1 for FDRA type 1, and every bit value allocated to the FDRA field is 0 for FDRA scheme dynamicSwitch.

The UE may transmit, to the base station, a PUCCH 2460 including the HARQ-ACK indicating reception success or failure of DCI format 1_1 or 1_2 for which the above details are assumed.

With respect to DCI format 1_1 or 1_2 with the DL assignment 2400 and without the DL assignment 2450, if a new TCI state indicated by the DCI 2401 and the 2455 is already indicated and identical to the TCI state applied to the UL transmission and DL reception beams, the UE may maintain the existing TCI state. If the new TCI state is different from the existing TCI state, the UE may determine an application time of the joint TCI state or separate TCI state set indicated from the TCI state field of the DCI, as an application time 2430 or 2480 from the start time 2420 or 2470 of an initial slot after a time corresponding to a beam application time (BAT) 2415 or 2465 after the PUCCH transmission, and may use the previously indicated TCI-state until a previous section 2425 or 2475 before the start time 2420 or 2470 of the slot.

With respect to DCI format 1_1 or 1_2 with the DL assignment 2400 and without the DL assignment 2450, the BAT may be configured with higher layer signaling based on UE capability report information using a specific number of OFDM symbols. Numerology of the BAT and the first slot after the BAT may be determined based on the smallest numerology among numerologies of all the cells to which the joint TCI state or separate TCI state set indicated by the DCI is applied.

The UE may apply one joint TCI state indicated by the MAC-CE or the DCI with regard to receiving CORESETs connected to every UE-specific search space, receiving the PDSCH scheduled with the PDSCCH transmitted from the corresponding CORESET and transmitting the PUSCH, and transmitting every PUCCH resource.

In case that one separate TCI state set indicated by the MAC-CE or the DCI includes one DL TCI state, the UE may apply the one separate TCI state set to receiving CORESETs connected to every UE-specific search space, receiving the PDSCH scheduled with the PDCCH transmitted from the corresponding CORESET, and the UE may apply the one separate TCI state set to every PUSCH and PUCCH resource based on the existing UL TCI state indicated.

If one separate TCI state set indicated by the MAC-CE or the DCI includes one UL TCI state, the UE may apply the one separate TCI state set to every PUSCH and PUCCH resource, and may apply, based on the existing DL TCI state indicated, with regard to receiving CORESETs connected to every UE-specific search space, and may receive the PDSCH scheduled with the PDCCH transmitted from the corresponding CORESET.

If one separate TCI state set indicated by the MAC-CE or the DCI includes one DL TCI state and one UL TCI state, the UE may apply the DL TCI state to receiving CORESETs connected to every UE-specific search space, receive the PDSCH scheduled with the PDCCH transmitted from the corresponding CORESET, and apply the UL TCI state to every PUSCH and PUCCH resource.

Some or all of the MAC CEs according to the embodiments of FIGS. 15 to 23 described above may be performed in combination with some or all of the other one or more embodiments.

Hereinafter, for convenience of explanation in the disclosure, cells, transmission points, panels, beams and/or transmission directions, which can be distinguished through higher layer/L1 parameters such as TCI state or spatial relation information, or indicators such as cell ID, TRP ID, panel ID, etc., are unified and described as a TRP, a beam, or a TCI state. Therefore, in actual application, it is possible to appropriately replace a TRP, a beam, or a TCI state with one of the above terms.

Herein, when the UE determines whether cooperative communication is applied, it is possible to use various methods, such as when PDCCH(s) for allocation of PDSCH to which the cooperative communication is applied has a specific format, PDCCH(s) for allocation of PDSCH to which the cooperative communication is applied include a specific indicator indicating whether cooperative communication is applied, PDCCH(s) for allocation of PDSCH to which cooperative communication is applied is scrambled by a specific RNTI, or cooperative communication is assumed to be applied in a specific interval indicated by a higher layer. Hereinafter, for convenience of description, a case in which a UE receives a PDSCH to which cooperative communication is applied based on conditions similar to the above will be referred to as an NC-JT case.

### First Embodiment: Multi-TCI State Indication and Activation Method Based on the Unified TCI Scheme

In the first embodiment, the multi-TCI state indication and activation method based on the unified TCI scheme is described. The multi-TCI state indication and activation method may indicate expanding the number of indicated joint TCI states to two or more, and expanding DL TCI states and UL TCI states included in one separate TCI state set to up to two or more. If one separate TCI state set includes up to two DL TCI states and two UL TCI states, the one separate TCI state set may have eight combinations in total of the DL TCI state and the UL TCI state (e.g., (DL, UL)={0,1}, {0,2}, {1,0}, {1,1}, {1,2}, {2,0}, {2,1}, {2,2}, wherein the number denotes the number of the TCI states).

If the UE is indicated with the multi-TCI state from the base station based on a MAC-CE, the UE may receive from the base station two or more joint TCI states or one separate TCI state set through the corresponding MAC-CE. The base station may schedule the UE to receive a PDSCH including the corresponding MAC-CE through the PDCCH. The UE may determine the uplink transmission beam or transmission filter and the downlink reception beam or reception filter based on the two or more joint TCI states or one separate TCI state set, indicated from 3 ms after PUCCH transmission including HARQ-ACK information indicating whether the PDSCH including the corresponding MAC-CE is successfully received.

In case that the UE is indicated with the multi-TCI state from the base station based on DCI format 1_1 or 1_2, each codepoint of one TCI state field of the corresponding DCI format 1_1 or 1_2 may indicate two or more joint TCI states or two or more separate TCI state sets. The UE may receive a MAC-CE from the base station and activate two or more joint TCI states or two or more separate TCI state sets corresponding to each codepoint of one TCI state field of the corresponding DCI format 1_1 or 1_2. The base station may schedule the UE to receive a PDSCH including the corresponding MAC-CE through the PDCCH. The UE may activate TCI state information included in the MAC-CE from 3 ms after PUCCH transmission including HARQ-ACK information indicating whether the PDSCH including the corresponding MAC-CE is successfully received.

If the UE is indicated with the multi-TCI state from the base station based on DCI format 1_1 or 1_2, the corresponding DCI format 1_1 or 1_2 may include two or more TCI state fields, and one of two or more joint TCI states or two or more separate TCI state sets may be indicated based on each TCI state field. The UE may receive a MAC-CE from the base station and activate two or more joint TCI states or separate TCI state sets corresponding to each codepoint of TCI state fields of the corresponding DCI format 1_1 or 1_2. The base station may schedule the UE to receive a PDSCH including the corresponding MAC-CE through the PDCCH. The UE may activate TCI state information included in the MAC-CE from 3 ms after PUCCH transmission including HARQ-ACK information indicating whether the PDSCH including the corresponding MAC-CE is successfully received or not. The UE may be configured with or without one or more additional TCI state fields through higher layer signaling, a bit length of the additional TCI state field may be equal to the existing TCI state field, and its length may be adjusted based on higher layer signaling.

The UE may receive transmission and reception beam-related indication in the unified TC manner using one of the joint TCI state and the separate TCI state configured from the base station. The UE may be configured with respect to using one of the joint TCI state and the separate TCI state from the base station through higher layer signaling. With respect to the separate TCI state, the UE may be configured through higher layer signaling to cause the bit length of the TCI state field of DCI format 1_1 or 1_2 to be up to 4.

The MAC-CE used to activate or indicate the multiple joint TCI states and separate TCI state states may individually exist for each joint and separate TCI state scheme, may activate or indicate the TCI state based on one of the joint or separate TCI state schemes using one MAC-CE, may share one MAC-CE structure used in the MAC-CE based indication scheme and the MAC-CE based activation scheme, and may use individual MAC-CE structures. Various MAC-CE structures may be considered to activate and indicate multiple joint or separate TCI state states.

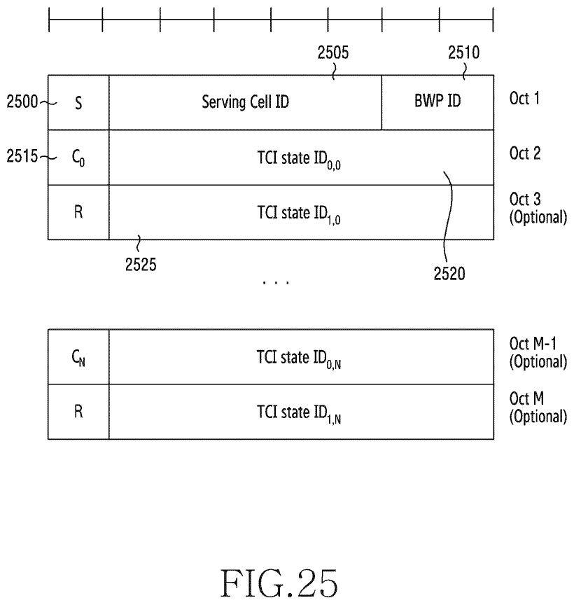

FIG. 25 illustrates a MAC-CE structure for multi-joint TCI state activation and indication in a wireless communication system according to an embodiment.

In FIG. 25, a serving cell ID field 2505 may indicate a serving cell ID and a BWP ID field 2510 may indicate a BWP ID. An R field may be a 1-bit reserve field that does not contain indication information. An S field 2500 may indicate the number of joint TCI state set information included in the MAC-CE. For example, if a value of the S field 2500 is 1, a corresponding MAC-CE may indicate one or two joint TCI states, and have a length only up to a third octet. If a value of a C₀ field 2515 is 0, the third octet does not exist, and one joint TCI state may be indicated through a TCI state ID_{0,0} field 2520. If the value of the C₀ field 2515 is 1, the third octet exists, and two joint TCI states may be indicated by the TCI state ID_{0,0} field 2520 and a TCI state ID_{1,0} field 2525.

For example, if the value of the S field 2500 is 0, the corresponding MAC-CE may activate one or two joint TCI states corresponding to respective codepoints of the TCI state field of DCI format 1_1 or 1_2, may activate one joint TCI state corresponding to each codepoint of two TCI state fields of DCI format 1_1 or 1_2, and may activate joint TCI states for up to 8 codepoints. In case that one or two joint TCI states are activated for one codepoint of one TCI state field, a TCI state ID_{0,Y} field and a TCI state ID_{1,Y} field may indicate first and second joint TCI states of the two joint TCI states activated at a Y-th codepoint of the TCI state field. In case that one joint TCI state is activated for one codepoint of two TCI state fields, the TCI state ID_{0,Y} field and the TCI state ID_{1,Y} field may indicate each joint TCI state activated at the Y-th codepoint of the first and second TCI state fields.

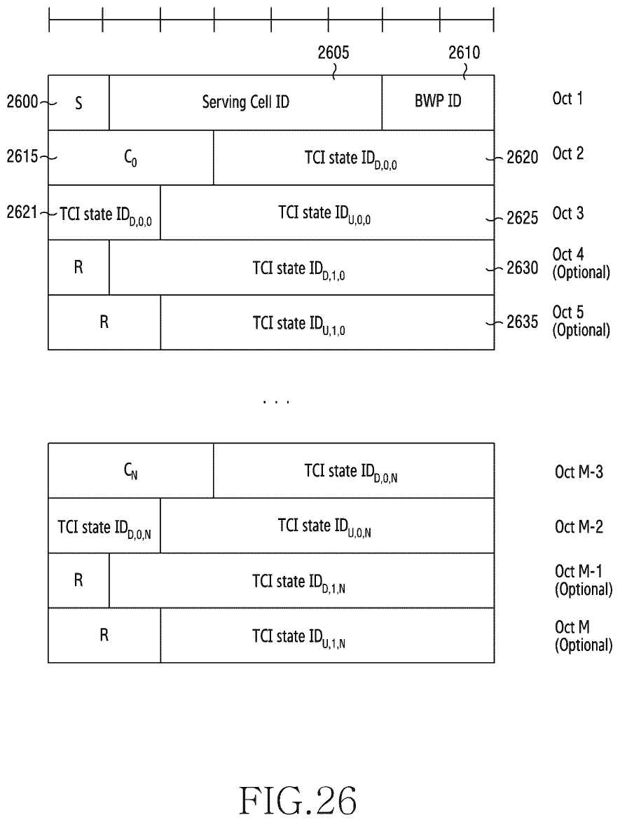

FIG. 26 illustrates a MAC-CE structure for multi-separate TCI state activation and indication in a wireless communication system according to an embodiment.

Referring to FIG. 26, a serving cell ID field 2605 may indicate a serving cell ID, and a BWP ID field 2610 may activate a BWP ID. An R field may be a 1-bit reserve field that does not contain indication information. An S field 2600 may indicate the number of separate TCI state set information included in the MAC-CE. For example, if a value of the S field 2600 is 1, a corresponding MAC-CE may indicate one separate TCI state set, and have a length only up to a fifth octet. If the value of the S field 2600 is 0, the corresponding MAC-CE may include information of multiple separate TCI state sets, and the corresponding MAC-CE may activate one separate TCI state set corresponding to each codepoint of the TCI state field of DCI format 1_1 or 1_2 or one separate TCI state set corresponding to each codepoint of two TCI state fields of DCI format 1_1 or 1_2. In case that the value of the S field 2600 is 0, the separate TCI state for up to 8 or 16 codepoints may be activated by higher layer signaling as mentioned above.

The MAC-CE structure of FIG. 26 may correspond to one separate TCI state set every four octets from the second octet. For example, a C₀ field 2615 may have eight values in total from 000 to 111, corresponding to eight cases of one separate TCI state set as described above.

In case that the C₀ field 2615 has the value 000, one separate TCI state set may indicate that one UL TCI state is included, TCI state ID_{D,0,0} fields 2620 and 2621 may be disregarded, and a TCI state ID_{U,0,0} field 2625 may include one UL TCI state information. The fourth and fifth octets may be disregarded.

In case that the C₀ field 2615 has the value 001, one separate TCI state set may indicate that two UL TCI states are included, and the TCI state ID_{D,0,0} fields 2620 and 2621 may be disregarded. The TCI state ID_{U,0,0} field 2625 may include first UL TCI state information of the two UL TCI states. The fourth octet may be disregarded, and a TCI state ID_{U,1,0} field 2635 may include second UL TCI state information of the two UL TCI states.

In case that the C₀ field 2615 has the value 010, one separate TCI state set may indicate that one DL TCI state is included. The TCI state ID_{D,0,0} fields 2620 and 2621 may include one DL TCI state information, and the TCI state ID_{U,0,0} field 2625 and the fourth and fifth octets may be disregarded.

In case that the C₀ field 2615 has the value 011, one separate TCI state set may indicate that one DL TCI state and one UL TCI state are included. The TCI state ID_{D,0,0} fields 2620 and 2621 may include one DL TCI state information, and the TCI state ID_{U,0,0} field 2625 may include one UL TCI state information. The fourth and fifth octets may be disregarded.

In case that the C₀ field 2615 has the value 100, one separate TCI state set may indicate that one DL TCI state and two UL TCI states are included. The TCI state ID_{D,0,0} fields 2620 and 2621 may include one DL TCI state information. The TCI state ID_{U,0,0} field 2625 may include first UL TCI state information of the two UL TCI states. The fourth octet may be disregarded, and the TCI state ID_{U,1,0} field 2635 may include second UL TCI state information of the two UL TCI states.

In case that the C₀ field 2615 has the value 101, one separate TCI state set may indicate that two DL TCI states are included. The TCI state ID_{D,0,0} fields 2620 and 2621 may include first DL TCI state information of the two DL TCI states. The TCI state ID_{U,0,0} field 2625 and the fifth octet may be disregarded. The TCI state ID_{D,1,0} field 2630 may include second DL TCI state information of the two DL TCI states.

In case that the C₀ field 2615 has the value 110, one separate TCI state set may indicate that two DL TCI states and one UL TCI state are included. The TCI state ID_{D,0,0} fields 2620 and 2621 may include first DL TCI state information of the two DL TCI states. The TCI state ID_{U,0,0} field 2625 may include one UL TCI state information. A TCI state ID_{D,1,0} field 2630 may include second DL TCI state information of the two DL TCI states, and the fifth octet may be disregarded.

In case that the C₀ field 2615 has the value 111, one separate TCI state set may indicate that two DL TCI states and two UL TCI states are included. The TCI state ID_{D,0,0} fields 2620 and 2621 may include first DL TCI state information of the two DL TCI states. The TCI state ID_{U,0,0} field 2625 may include first UL TCI state information of the two UL TCI states. The TCI state ID_{D,1,0} field 2630 may include second DL TCI state information of the two DL TCI states. The TCI state ID_{U,1,0} field 2635 may include second UL TCI state information of the two UL TCI states.

FIG. 26 illustrates the MAC CE used when the UL TCI state of the separate TCI states uses a different higher layer signaling structure from the DL TCI state of the separate TCI states and the joint TCI state, as described above. Accordingly, the UL TCI state requires 6 bits to represent up to 64, and thus the TCI state ID_{D,0,0} to TCI state ID_{D,1,N} fields indicating the DL TCI state may be represented with 7 bits, whereas the TCI state ID_{U,0,0} to TCI state ID_{U,1,N} fields indicating the UL TCI state may be represented with 6 bits.

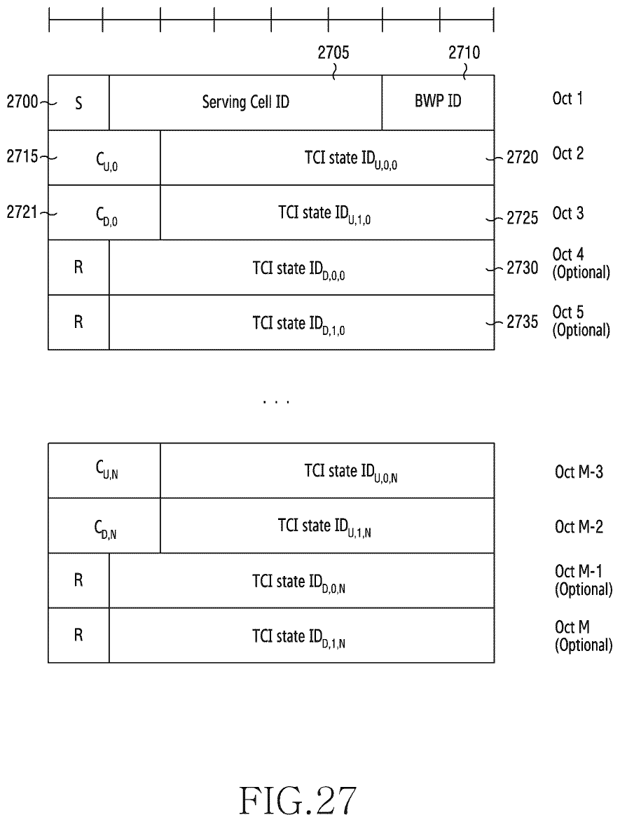

FIG. 27 illustrates a MAC-CE structure for multi-separate TCI state activation and indication in a wireless communication system according to an embodiment.

In FIG. 27, a serving cell ID field 2705 may indicate a serving cell ID and a BWP ID field 2710 may indicate a BWP ID. An R field may be a 1-bit reserve field that does not contain indication information. An S field 2700 may indicate the number of separate TCI state set information included in the MAC-CE. If a value of an S field 2700 is 1, a corresponding MAC-CE may indicate one separate TCI state set, and have the length only up to a fifth octet.

For example, if the value of the S field 2700 is 0, the corresponding MAC-CE may include information of multiple separate TCI state sets, and the corresponding MAC-CE may activate one separate TCI state set corresponding to each codepoint of the TCI state field of DCI format 1_1 or 1_2, or activate one separate TCI state set corresponding to each codepoint of two TCI state fields of DCI format 1_1 or 1_2, and may activate the separate TCI state set corresponding to up to 8 or 16 codepoints by higher layer signaling as mentioned above.

The MAC-CE structure of FIG. 27 may correspond to one separate TCI state set every four octets from the second octet. For example, a C_{U,0} field 2715 and a C_{D,0} field 2721 may indicate the number of UL TCI states and the number of DL TCI states respectively included in one separate TCI state set, and may have meaning per codepoint as follows.

In case that the C_{U,0} field 2715 has the value 00, this may indicate that no UL TCI state is included. A TCI state ID_{U,0,0} field 2720 and a TCI state ID_{U,1,0} field 2725 may be disregarded.

In case that the C_{U,0} field 2715 has the value 01, this may indicate that one UL TCI state is included. The TCI state ID_{U,0,0} field 2720 may include one UL TCI state information, and the TCI state ID_{U,1,0} field 2725 may be disregarded.

In case that the C_{U,0} field 2715 has the value 10, this may indicate that two UL TCI states are included. The TCI state ID_{U,0,0} field 2720 may include first UL TCI state information of the two UL TCI states. The TCI state ID_{U,1,0} field 2725 may include second UL TCI state information of the two UL TCI states.

In case that the C_{D,0} field 2721 has the value 00, this may indicate that no DL TCI state is included. The fourth and fifth octets may be disregarded.

In case that the C_{D,0} field 2721 has the value 01, this may indicate that one DL TCI state is included. A TCI state ID_{D,0,0} field 2730 may include one DL TCI state information, and the fifth octet may be disregarded.

In case that the C_{D},O field 2721 has the value 10, this may indicate that two DL TCI states are included. The TCI state ID_{D,0,0} field 2730 may include first DL TCI state information of the two DL TCI states, and a TCI state ID_{D,1,0} field 2735 may include second DL TCI state information of the two DL TCI states.

FIG. 27 may illustrate the MAC CE used when the UL TCI state of the separate TCI states uses a different higher layer signaling structure from the DL TCI state of the separate TCI states and the joint TCI state, as described above. Accordingly, the UL TCI state requires 6 bits to represent up to 64, and thus the TCI state ID_{D,0,0} 2730 to TCI state ID_{D,1,N} fields indicating the DL TCI state may be represented with 7 bits, whereas the TCI state ID_{U,0,0} 2720 to TCI state ID_{U,1,N} fields indicating the UL TCI state may be represented with 6 bits.

### Second Embodiment: Additional Single and Multiple TCI State Indication and Activation Method Based on Unified TCI Method

A UE may receive, from a base station, a scheduled PDSCH containing a MAC-CE that can be configured by at least one combination of the various MAC-CE structures below, and may interpret each codepoint of the TCI state field in DCI format 1_1 or 1_2 based on the information within the MAC-CE received from the base station, from 3 slots after transmitting the HARQ-ACK for the PDSCH to the base station. That is, the UE may activate each entry of the MAC-CE received from the base station to each codepoint of the TCI state field in DCI format 1_1 or 1_2.

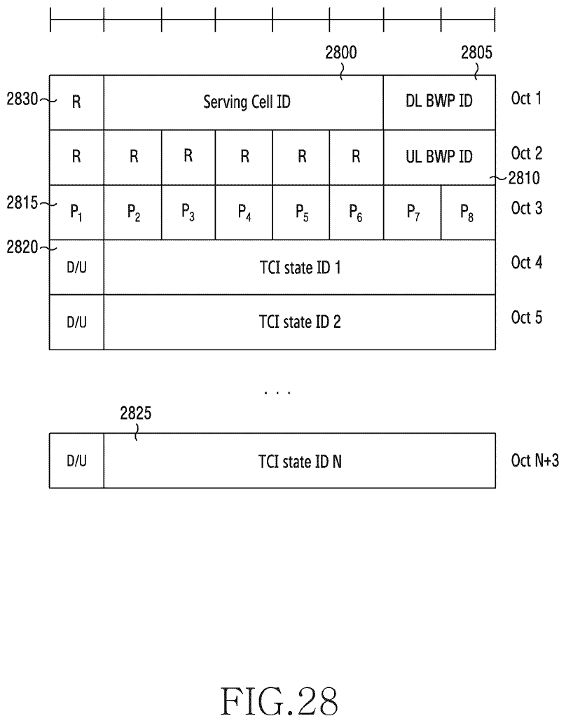

FIG. 28 illustrates a MAC-CE structure for activating and indicating joint TCI state or separate DL or UL TCI state in a wireless communication system according to an embodiment. The meaning of each field in the corresponding MAC-CE structure is provided as follows.

The serving cell ID 2800 field indicates a serving cell to which the corresponding MAC CE will be applied. The length of the field may be 5 bits. If the serving cell indicated by this field is included in at least one of a simultaneousU-TCI-UpdateList1, simultaneousU-TCI-UpdateList2, simultaneousU-TCI-UpdateList3, or simultaneousU-TCI-UpdateList4, which are higher layer signaling, the corresponding MAC CE may be applied to all the serving cells included in at least one of the simultaneousU-TCI-UpdateList1, simultaneousU-TCI-UpdateList2, simultaneousU-TCI-UpdateList3, or simultaneousU-TCI-UpdateList4, in which the serving cell indicated by this field is included.

The DL BWP ID 2805 field may indicate a DL BWP to which the corresponding MAC-CE will be applied, and the meaning of each codepoint in this field may correspond to each codepoint of a bandwidth part indicator in DCI. The length of the BWP ID field may be 2 bits.

The UL BWP ID 2810 field may indicate a UL BWP to which the corresponding MAC CE will be applied, and the meaning of each codepoint in this field may correspond to each codepoint of the bandwidth part indicator in DCI. The length of the BWP ID field may be 2 bits.

The Pᵢ 2815 field indicates whether each codepoint of the TCI state field in DCI format 1_1 or 1_2 has multiple TCI states or single TCI state. If a value of Pᵢ is 1, this implies that the corresponding i-th codepoint has multiple TCI states, which may imply that the corresponding codepoint may include a separate DL TCI state and a separate UL TCI state. If the value of Pᵢ is 0, this implies that the corresponding i-th codepoint has a single TCI state, which may imply that the corresponding codepoint may include one of a joint TCI state, a separate DL TCI state, or a separate UL TCI state.

The D/U 2820 field indicates whether the TCI state ID field in the same octet is for joint TCI state, separate DL TCI state, or separate UL TCI state. If this field is 1, the TCI state ID field in the same octet may be joint TCI state or separate DL TCI state, and if this field is 0, the TCI state ID field in the same octet may be separate UL TCI state.

The TCI state ID 2825 field indicates a TCI state identified by TCI-StateId which is higher layer signaling. If D/U field is configured to be 1, this TCI state ID field may be used in representing 7-bits length of TCI-StateId. If D/U field is configured to be 0, the MSB of this TCI state ID field is considered as the reserved bit and remainder 6 bits indicate the UL-TCIState-Id which is higher layer signaling. The maximum number of TCI states that can be activated is 8 for the joint TCI states and 16 for the separate DL or UL TCI states.

The R field indicates a reserved bit, which can be configured to be 0.

With respect to the MAC-CE structure of FIG. 28, regardless of whether unifiedTCI-StateType-r17 of MIMOparam-r17 in ServingCellConfig, which is higher layer signaling, is configured to be joint or separate, the UE may include the 3rd octet including P₁, P₂, . . . , the P₈ field in FIG. 28 in the corresponding MAC-CE structure. In this case, the UE may perform TCI state activation using a fixed MAC-CE structure regardless of higher layer signaling configured from the base station. As another example, in case that unifiedTCI-StateType-r17 of MIMOparam-r17 in ServingCellConfig, which is higher layer signaling, is configured to be joint, the UE may omit the 3rd octet including P₁, P₂, . . . , the P₈ field in FIG. 28. In this case, the UE may save up to 8 bits of the payload of the MAC-CE according to the higher layer signaling configured from the base station. Additionally, the UE may regard all D/U fields located in the first bit from the fourth octet in FIG. 28 as R fields, and all the corresponding R fields may be configured as bit 0.

In case that the UE has been configured with two different CORESETPoolIndex through higher layer signaling and DLorJointTCIState or UL-TCIState which is higher layer signaling, the base station and the UE may expect that the R field 2830 existing in the first octet is interpreted as a field indicating the CORESET Pool ID in FIG. 28 which is one of the MAC-CE structures indicating activation of the unified TCI state. If the corresponding CORESET Pool ID is configured to be 0, the UE may consider that the corresponding MAC-CE can be applied to each codepoint of the TCI state field in the PDCCH transmitted in CORESET corresponding to CORESETPoolIndex 0. If the corresponding CORESET Pool ID is configured to be 1, the UE may consider that the corresponding MAC-CE can be applied to each codepoint of the TCI state field in the PDCCH transmitted in CORESET corresponding to CORESETPoolIndex 1.

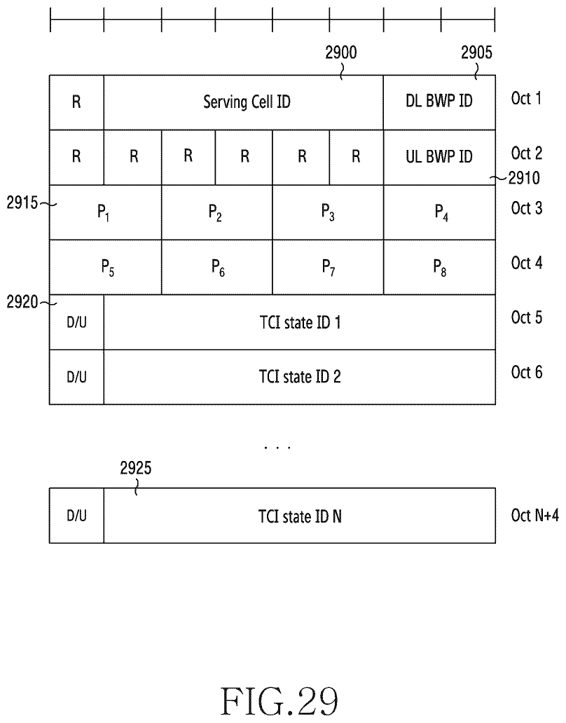

FIG. 29 illustrates a MAC-CE structure for activating and indicating a plurality of joint TCI states, or separate DL or UL TCI states in a wireless communication system according to an embodiment. The meaning of each field in the corresponding MAC-CE structure is provided as follows.

The serving cell ID 2900 field indicates a serving cell to which the corresponding MAC CE will be applied. The length of the field may be 5 bits. If the serving cell indicated by this field is included in at least one of a simultaneousU-TCI-UpdateList1, simultaneousU-TCI-UpdateList2, simultaneousU-TCI-UpdateList3, or simultaneousU-TCI-UpdateList4, which are higher layer signaling, the corresponding MAC CE may be applied to all the serving cells included in at least one of the simultaneousU-TCI-UpdateList1, simultaneousU-TCI-UpdateList2, simultaneousU-TCI-UpdateList3, or simultaneousU-TCI-UpdateList4, in which the serving cell indicated by this field is included.

The DL BWP ID 2905 field may indicate a DL BWP to which the corresponding MAC-CE will be applied, and the meaning of each codepoint in this field may correspond to each codepoint of a bandwidth part indicator in DCI. The length of the BWP ID field may be 2 bits.

The UL BWP ID 2910 field may indicate a UL BWP to which the corresponding MAC CE will be applied, and the meaning of each codepoint in this field may correspond to each codepoint of the bandwidth part indicator in DCU. The length of the BWP ID field may be 2 bits.

The Pᵢ 2915 field can indicate whether each codepoint in the TCI state field in DCI format 1_1 or 1_2 has multiple TCI states or one TCI state.

In case that the UE can configure unifiedTCI-StateType-r17 in MIMOparam-r17 in ServingCellConfig, which is higher layer signaling, for one of joint and separate, regardless of which one of the two configuration information is configured, this field can be interpreted as follows.

If the value of Pᵢ is 00, this implies that the corresponding i-th codepoint has a single TCI state, and this may imply that the corresponding codepoint may include one of the joint TCI state, separate DL TCI state, or separate UL TCI state.

If the value of Pᵢ is 01, this implies that the corresponding i-th codepoint has two TCI states, and this may imply that the corresponding codepoint may include one of two joint TCI states, one separate DL TCI state and one separate UL TCI state, two separate DL TCI states, or two separate UL TCI states.

If the value of Pᵢ is 10, this implies that the corresponding i-th codepoint has three TCI states, and this may imply that the corresponding codepoint may include one separate DL TCI state and two separate UL TCI states, or two separate DL TCI states and one separate UL TCI state.

If the value of Pᵢ is 11, this implies that the corresponding i-th codepoint has four TCI states, and this may imply that the codepoint may include two separate DL TCI states and two separate UL TCI states.

In case that the UE can configure unifiedTCI-StateType-r17 of MIMOparam-r17 in ServingCellConfig, which is higher layer signaling, for one of joint, separate, and mixed modes, regardless of which one of the possible configuration values is configured, this field can be interpreted as follows. The mixed mode may be expressed as one configuration value meaning that a general mixed mode of joint TCI state and separate DL or UL TCI state is possible, or may be expressed as multiple configuration values such as 1joint+1DL, 1joint+1UL and configured to represent a specific combination of a specific number of joint TCI states and a specific number of separate DL or UL TCI states.

If the value of Pᵢ is 00, this implies that the corresponding i-th codepoint has a single TCI state, and this may imply that the corresponding codepoint may include one of the joint TCI state, separate DL TCI state, or separate UL TCI state.

If the value of Pᵢ is 01, this implies that the corresponding i-th codepoint has two TCI states, and that the codepoint may include one of two joint TCI states, one joint TCI state and one separate DL TCI state, one joint TCI state and one separate UL TCI state, one separate DL TCI state and one separate UL TCI state, two separate DL TCI states, or two separate UL TCI states. If the UE has been configured with a value which indicates that unifiedTCI-StateType-r17 of MIMOparam-r17 in ServingCellConfig, which is higher layer signaling, can be a general mixed mode of joint TCI state and separate DL or UL TCI state, such as mixed mode, both of one joint TCI state and one separate DL TCI state, one joint TCI state and one separate UL TCI state may be possible. If the UE has been configured such that-the unifiedTCI-StateType-r17 of MIMOparam-r17 in ServingCellConfig, which is higher layer signaling, is configured with one of 1joint+1DL and 1joint+1UL, only a case that corresponds to the unifiedTCI-StateType-r17 configuration value among the above-mentioned one joint TCI state and one separate DL TCI state, and one joint TCI state and one separate UL TCI state, may be possible.

If the value of Pᵢ is 10, this implies that the corresponding i-th codepoint has three TCI states, and this may imply that the corresponding codepoint may include one separate DL TCI state and two separate UL TCI states, or two separate DL TCI states and one separate UL TCI state.

If the value of Pᵢ is 11, this implies that the corresponding i-th codepoint has four TCI states, and this may imply that the codepoint may include two separate DL TCI states and two separate UL TCI states.

The field may be 2 bits.

The D/U 2920 field indicates whether the TCI state ID field in the same octet is for joint TCI state, separate DL TCI state, or separate UL TCI state. If this field is 1, the TCI state ID field in the same octet is joint TCI state or separate DL TCI state, and if this field is 0, the TCI state ID field in the same octet is separate UL TCI state.

The TCI state ID 2925 field indicates a TCI state identified by TCI-StateId which is higher layer signaling. If D/U field is configured to be 1, this TCI state ID field may be used in representing 7-bits length of TCI-StateId. If D/U field is configured to be 0, the MSB of this TCI state ID field is considered as the reserved bit and remainder 6 bits indicate the UL-TCIState-Id which is higher layer signaling. The maximum number of TCI states that can be activated is 8 for the joint TCI states and 16 for the separate DL or UL TCI states.

The R field indicates reserved bit, which can be configured to be 0.

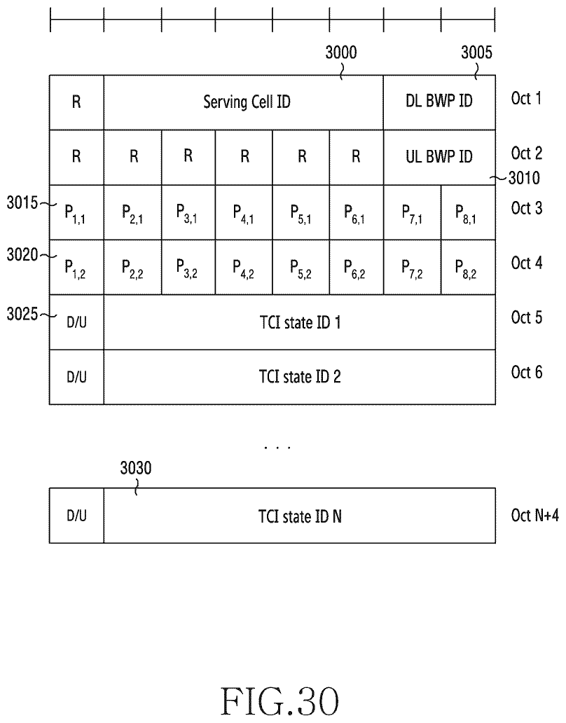

FIG. 30 illustrates a MAC-CE structure for activating and indicating a plurality of joint TCI states, or separate DL or UL TCI states in a wireless communication system according to an embodiment. The meaning of each field in the corresponding MAC-CE structure is provided as follows.

The serving cell ID 3000 field indicates a serving cell to which the corresponding MAC CE will be applied. The length of the field may be 5 bits. If the serving cell indicated by this field is included in at least one of a simultaneousU-TCI-UpdateList1, simultaneousU-TCI-UpdateList2, simultaneousU-TCI-UpdateList3, or simultaneousU-TCI-UpdateList4, which are higher layer signaling, the corresponding MAC CE may be applied to all the serving cells included in at least one of the simultaneousU-TCI-UpdateList1, simultaneousU-TCI-UpdateList2, simultaneousU-TCI-UpdateList3, or simultaneousU-TCI-UpdateList4, in which the serving cell indicated by this field is included.

The DL BWP ID 3005 field may indicate a DL BWP to which the corresponding MAC-CE will be applied, and the meaning of each codepoint in this field may correspond to each codepoint of a bandwidth part indicator in DCI. The length of the BWP ID field may be 2 bits.

The UL BWP ID 3010 field may indicate a UL BWP to which the corresponding MAC CE will be applied, and the meaning of each codepoint in this field may correspond to each codepoint of the bandwidth part indicator in DCI. The length of the BWP ID field may be 2 bits.

The P_{i,1} 3015 and P_{i,2} 3020 fields may indicate whether each codepoint in the TCI state field in DCI format 1_1 or 1_2 has multiple TCI states or one TCI state.

When the unifiedTCI-StateType-r17 in MIMOparam-r17 in ServingCellConfig, which is the higher layer signaling, can be configured as one of joint and separate, or can be configured as one of joint, separate, and mixed modes, in case that the unifiedTCI-StateType-r17, which is higher layer signaling, is configured as joint, the UE may omit the 4th octet including the fields P_{1,2}, P_{2,2}, . . . , P_{8,2} in FIG. 30, and only Pᵢ can be interpreted as follows. The mixed mode may be expressed as one configuration value meaning that a general mixed mode of joint TCI state and separate DL or UL TCI state is possible, or multiple configuration values such as 1joint+1DL, 1joint+1UL, and may be configured to represent a specific combination of a specific number of joint TCI states and a specific number of separate DL or UL TCI states.

If the value of P_{i,1} is 0, this implies that the corresponding i-th codepoint has a single TCI state, and that the corresponding codepoint may include one joint TCI state.

If the value of P_{i,1} is 1, this implies that the corresponding i-th codepoint has two TCI states, and that the corresponding codepoint may include two joint TCI states.

When the unifiedTCI-StateType-r17 in MIMOparam-r17 in ServingCellConfig, which is the higher layer signaling, can be configured as one of joint and separate, or can be configured as one of joint, separate, and mixed modes, in case that the unifiedTCI-StateType-r17, which is higher layer signaling, is configured as separate, the UE may consider P_{i,1} in the 3rd octet and P_{i,2} in the 4th octet as a single field of 2 bits, which can be interpreted as follows. The mixed mode may be expressed as one configuration value meaning that a general mixed mode of joint TCI state and separate DL or UL TCI state is possible, or multiple configuration values such as 1joint+1DL, 1joint+1UL, and may be configured to represent a specific combination of a specific number of joint TCI states and a specific number of separate DL or UL TCI states.

If the value of P_{i.1} and the value of P_{i.2} are 0 and 0, respectively, this implies that the corresponding i-th codepoint has a single TCI state, and that the corresponding codepoint may include one of separate DL TCI state or separate UL TCI state.

If the value of P_{i.1} and the value of P_{i.2} are 0 and 1, respectively, this implies that the corresponding i-th codepoint has two TCI states, and that the corresponding codepoint may include one of one separate DL TCI state and one separate UL TCI state, two separate DL TCI states, or two separate UL TCI states.

If the value of P_{i.1} and the value of P_{i.2} are 1 and 0, respectively, this implies that the corresponding i-th codepoint has three TCI states, and that the corresponding codepoint may include one separate DL TCI state and two separate UL TCI states, or two separate DL TCI states and one separate UL TCI state.

If the value of P_{i.1} and the value of P_{i.2} are 1 and 1, respectively, this implies that the corresponding i-th codepoint has four TCI states, and that the corresponding codepoint may include two separate DL TCI states and two separate UL TCI states.

In case that the UE can configure unifiedTCI-StateType-r17 of MIMOparam-r17 in ServingCellConfig, which is higher layer signaling, for one of joint, separate, and mixed modes, if the unifiedTCI-StateType-r17 which is higher layer signaling is configured as a mixed mode, the UE may interpret the P_{i,1} of the 3rd octet as follows, and may not transmit the 4th octet. The mixed mode may be represented by one configuration value, which indicates that a general mixed mode of joint TCI state and separate DL or UL TCI state is possible.

If the value of P_{i,1} is 0, this may imply that the corresponding i-th codepoint may include one joint TCI state and one separate DL TCI state.

If the value of P_{i,1} is 1, this may imply that the corresponding i-th codepoint may include one joint TCI state and one separate UL TCI state.

In case that the UE can configure unifiedTCI-StateType-r17 in MIMOparam-r17 in ServingCellConfig, which is higher layer signaling, for one of joint, separate, and mixed mode, if the unifiedTCI-StateType-r17, which is higher layer signaling, is configured to be mixed mode, the UE may interpret P_{i,1} of the 3rd octet and P_{i,2} of the 4th octet as follows. The mixed mode may be expressed as one configuration value, which has meaning that a general mixed mode of the joint TCI state and the separate DL or UL TCI state is possible.

If the value of P_{i,1} is 0, this may imply that the corresponding i-th codepoint includes only one joint TCI state. That is, since mixed mode is not used, the value of P_{i,2} may be disregarded.

If the value of P_{i,1} is 1, this may imply that the corresponding i-th codepoint includes one of one separate UL TCI state and one separate DL TCI state, in addition to one joint TCI state. That is, the mixed mode can be used for the corresponding codepoint, and if the value of P_{i,2} is 0, one separate UL TCI state may be additionally used, and if the value of P_{i,2} is 1, one separate UL TCI state may be additionally used.

The D/U 3025 field indicates whether the TCI state ID field in the same octet is for joint TCI state, separate DL TCI state, or separate UL TCI state. If this field is 1, the TCI state ID field in the same octet is joint TCI state or separate DL TCI state, and if this field is 0, the TCI state ID field in the same octet is separate UL TCI state.

The TCI state ID 3030 field indicates a TCI state identified by TCI-StateId which is higher layer signaling. If D/U field is configured to be 1, this TCI state ID field may be used in representing 7-bits length of TCI-StateId. If D/U field is configured to be 0, the MSB of this TCI state ID field is considered as the reserved bit and remainder 6 bits indicate the UL-TCIState-Id which is higher layer signaling. The maximum number of TCI states that can be activated is 8 for the joint TCI states and 16 for the separate DL or UL TCI states.

The R field indicates reserved bit, which can be configured to be 0.

The above-mentioned unifiedTCI-StateType-r17 in MIMOparam-r17 in ServingCellConfig, which is higher layer signaling, may be defined as a new parameter such as unifiedTCI-StateType-r18 in MIMOparam-r18, which is higher layer signaling in ServingCellConfig, and existing parameters may be reused.

### Third Embodiment: Beam Reporting Method for Simultaneous Transmission Using Multiple Panels

In NR Release 17 (Rel.17), new techniques are enhanced and introduced to support beams that were managed separately for uplink and downlink in previous releases using a unified TCI framework. As described above based on the unified TCI, not only reception beam for receiving downlink signals but also transmission beam for transmitting uplink signals may be indicated through TCI. More precisely, the UE may determine the transmission beam or reception beam based on the transmission filter or reception filter used to transmit or receive a reference signal indicated by the TCI state.

In order for a UE to simultaneously transmit uplink signals using multiple panels, an uplink transmission filter for each panel may be required. If the UE selects two panels among multiple panels and transmits an uplink signal using each transmission beam, two transmission beams should be determined. By extension, if N panels are selected from among multiple panels and an uplink signal is transmitted through each transmission beam, N transmission beams should be determined. To support simultaneous uplink transmission using multiple panels, the UE may apply transmission beam, which is determined in the same manner as in the method for reporting and determining N transmission beams common to systems supporting multi-panel simultaneous transmission based on single DCI (s-DCI). and systems supporting multi-panel simultaneous transmission based on multiple DCI (mDCI), to simultaneous uplink transmission. Alternatively, N transmission beams are reported and determined in common for sDCI-based systems and mDCI-based systems, but a separate application method suitable for each system may be considered. Alternatively, a method of reporting and determining N transmission beams suitable for each sDCI-based system and a method of reporting and determining N transmission beams suitable for an mDCI-based system may be distinguished and applied respectively.

The UE may perform beam reporting to a base station to determine the transmission beam. In order to perform beam reporting, the UE may use the beam reporting method supported in NR Releases 17 (Rel.-17). Alternatively, the UE may use a method that augments the beam reporting method supported in Rel.17, or may introduce a new beam reporting method that is different from the beam reporting method supported in Rel. 17. For example, in order to support simultaneous uplink transmission using multiple panels, beam reporting can be performed by additionally reporting group-based beam reporting reinforced in Rel. 17. To specifically explain the enhanced group based beam reporting, the CSI information reported by the UE to the base station may include the following information (here, it is assumed that the group based beam reporting method supported in NR Rel. 17 is the same as the case of N=2 in N transmission beams described above). That is, the transmission beam reporting and decision method to support simultaneous transmission using multiple panels based on NR Rel. 17, which will be described later, assumes the case of N=2. However, this is an example and can be applied by expanding N to an integer greater than 2.

In the resource set indicator the first and second CSI-RS resource indicators (CRIs) for each resource group (up to 4 groups may be defined, and the number of groups configured for the corresponding UE is determined based on a higher layer parameter configured by the base station), or SSB resource indicator (SSBRI).

When the RSRP or differential RSRP for the CRI or SSBRI is reported, RSRP is reported as 7 bits only for the first resource of the first resource group, and differential RSRPs are reported as 4 bits for other resource groups and resources of the same, respectively.

The CORESETPoolIndex may be implicitly omitted, in which case the first beam information of each resource group is associated with CORESETPoolIndex being 0 or a case in which CORESETSETPoolIndex is not configured, and the second beam information of each resource group is assumed to be associated with a case in which CORESETPoolIndex is 1. Mapping information may exist between beam information and CORESETPoolIndex different from the example described.

Each resource group reports information on the first and second beams within the beam group. That is, in the first resource group, one of the CSI-RS resources in the first resource group or one of the SSB resources in the first resource group may be selected to indicate the first beam of a predetermined beam group. In the second resource group, one of the CSI-RS resources in the second resource group or one of the SSB resources in the second resource group may be selected to indicate the second beam of a predetermined beam group. Each resource group may imply two CSI-RS resource groups or two SSB resource groups for non-coherent-joint transmission (mTRP NC-JT) introduced in Rel. 17. The UE should be able to simultaneously perform transmission and reception using multiple panels, by using transmission beams according to the two selected CSI-RS resources or SSB resources in each beam group. Alternatively, CRI or SSBRI may be selected from two different CSI-RS resources or two different CSI-RS resources that the UE can transmit and receive simultaneously through one or multiple spatial domain receive filters, in the same manner as supporting groupBasedBeamReporting introduced prior to Rel. 17. Beam reporting methods based on releases prior to Rel. 17, unlike group-based beam reporting based on Rel. 17, may not establish separate groups of two resources, and may be any two different CSI-RS or SSB resources capable of performing simultaneous transmission and reception using multiple panels, among the multiple resources.

As described above, the CSI information reported by a UE to a base station is the CSI reporting method supported by Rel. 17, and the UE may report additional CSI information for multi-panel simultaneous transmission to the base station by additionally reporting information below.

The base station may report CapabilityIndex to indicate a capability value for the CRI or SSBRI being reported (or an indicator of any name that can perform an operation of indicating the maximum number of SRS ports that the UE can support for the CRI or SSBRI being reported, such as UE capability set index), as 2 bits each for each resource group and the resources of the resource group

In other words, the UE may support the base station to configure two TCI states to perform simultaneous support using multiple panels by additionally reporting the maximum number of SRS ports that can be supported for each beam group and resources of the group. For example, the base station may expect two resources included in the same group to be received through different panels. If the resource group and CSI resource set according thereto are configured in this way, the base station may activate two TCI states by using the reported beam group pair. Alternatively, like groupBasedBeamReporting prior to Rel. 17, the base station may active two TCI states using a beam pair in a beam group reported from two different CSI-RS resources or two different SSB resources, which can be simultaneously received by the UE using one or multiple spatial domain receive filters as described earlier, among multiple CSI-RS resources or multiple SSBresources. In other words, with regard to the MAC CE for activating/deactivating the unified TCI state enhanced in Rel. 17, an operation in which only one TCI state is allowed to be indicated in one codepoint in the past can be extended to indicate up to two TCI states in one codepoint. In this case, beam group pairs of the beam group report reported from the UE may be referred to two TCI states to support simultaneous transmission using multiple panels to one codepoint.

For convenience of explanation, the case in which two TCI states are indicated has been described. However, in the case of performing simultaneous transmission using a number N_{UL,panel} of panels greater than 2, N_{UL,panel} TCI states may be indicated using one codepoint instead of indicating the two TCI states by using one codepoint. As another example, the base station may consider an operation of configuring the same CSI resource for each CSI resource set in the same group through higher layer configuration and receiving the same CSI resource using different panels. This can be used as a method capable of considering simultaneous transmission and reception of a single TRP using multiple panels.

In another method, at the time of reporting a beam to a base station, the UE may configure panel information about the beam being reported, as additional CSI information and report the same. For example, when the maximum number of panels that a UE can support is defined as Nₚₐₙₑₗ, information about the panels may be notified to the base station by adding log₂Nₚₐₙₑₗ bits for each reported CRI or SSBRI. This can be defined as a panel index or may be configured by other forms of CSI reporting information that can be indicated implicitly rather than explicitly indicating that it is information about the panel. For example, if the number of resources in the CSI resource set associated with CSI reporting is 8, and the CSI-RS resource having a CRI of 0, 1, 2, or 3 is received using the first panel of two panels that can be operated by the UE, the corresponding CRI and the RSRP according thereto (or signal to interference plus noise ratio (SINR) or any channel measurement information is applicable) may be reported together with an additional 1 bit configured to be 0. In other words, the UE may report to the base station that it received information through the first of the two panels.

Similarly, if a CSI-RS resource having a CRI of 4, 5, 6, or 7 is received using the second panel of the two panels that can be operated by the UE, the corresponding CRI and the RSRP according thereto (or SINR or any channel measurement information is applicable) may be reported with an additional bit configured to be 1. In case of adding additional information to the CSI report as such, the base station may configure a beam combination capable of performing simultaneous transmission using multiple panels based on the reported beam information and the panel information according thereto. Accordingly, the base station may transmit a MAC CE that configures multiple TCI states using one codepoint to the UE. The UE receives this MAC CE from the base station and activates the TCI state, and a single codepoint is indicated via DCI format 1_1 or DCI format 1_2 and can be applied to transmit the uplink signal after the BAT time. In the case of adding panel information as such, it is also possible to consider an operation in which the base station configures the same CSI resource for each CSI resource set in the same group through higher layer configuration and receives the same CSI resource using different panels. When the same CSI resource is configured for different resource set within a group, the UE may report the corresponding CRI and the RSRP according thereto (or SINR, or any channel measurement information is applicable) and panel information (e.g., configured by log₂Nₚₐₙₑₗ bits as described above) to the base station in a similar manner.

As described above, in the second embodiment, the UE reports beam information to the base station, and the base station may configure higher layer parameters to support simultaneous transmission using multiple panels based on the beam information and transmit the MAC CE to the UE to activate the TCI state. A MAC CE for indicating the unified TCI-based multiple TCI states as shown in FIGS. 25 to 27 of the first embodiment described above may be used as the MAC CE transmitted to the UE by the base station. Alternatively, to indicate multiple TCI states using one codepoint, the MAC CE may be configured as shown in FIG. 29 or FIG. 30 to activate multiple TCI states to support multi-panel simultaneous transmission using one codepoint. The multiple TCI states activated with one codepoint through the MAC CE (FIGS. 25 to 27, FIG. 29 or FIG. 30) may be multiple TCI states that can be transmitted simultaneously using multiple panels, and simultaneous transmission using multiple panels may result in multiple TCI states that are not supported. The former and the latter may be identified and configured by the base station through group-based beam reports transmitted by the UE to the base station, and the UE and the base station may implicitly identify whether it is a combination of TCI states enabling simultaneous transmission using multiple panels, or a combination of TCI states that does not allow simultaneous transmission using multiple panels, based on the reported (received) group-based beam reporting.

Alternatively, an unused field of a reserved area (R area) may be used to add an indicator indicating multi-panel simultaneous transmission to each codepoint. It is also possible to newly add an indicator area for indicating multi-panel simultaneous transmission by using a new Octet (8 bits) in which the reserved area may not be secured for the total number of codepoints. For example, if there are a total of 8 codepoints, the additional bits to indicate multi-panel simultaneous transmission may consist of a total of 8 bits, and the MAC CE may be configured using the reserved area or by adding a new Octet. In this case, when the first bit (MSB) is configured to be 1 and multiple (e.g., two) TCI states are indicated for the first codepoint, the TCI state can be activated to perform uplink simultaneous transmission using multiple panels based on the multiple TCI states. Alternatively, when the first bit (MSB) is configured to be 0 and multiple (e.g., two) TCI states are indicated for the first codepoint, uplink simultaneous transmission using multiple panels may not be performed based on the multiple TCI states. In case that simultaneous transmission using multiple panels is not performed, the multiple TCI states indicated by the corresponding codepoint may support multiple TRP transmissions based on TDM.

As such, the base station may activate/configure/indicate the multiple TCI states described above with one codepoint, and the method of indicating one codepoint meaning the multiple TCI states through one field in a single DCI is a method suitable for simultaneous transmission using multiple panels based on sDCI. For the mDCI-based multi-panel simultaneous transmission method, which performs uplink transmission to TRPs that may correspond to each CORESETPoolIndex via multiple DCIs, the same or similar procedure as previously described may be used to determine multiple (e.g., N=2) transmission beam pairs as one beam group, and the UE may report the determined beam group to the base station. The base station and the UE may define explicit rules in the 3GPP specifications to associate the first transmission beam information in the beam group with CORESETPoolIndex=0 (when considering the groupBasedBeamReporting method, the first transmission beam information may imply the beam information first reported by any beam group of CSI information contained in UCI, where the beam information may be CRI or SSBRI), and may define beam information, which is reported second among the CSI information contained in the UCI, to be associated with CORESETPoolIndex=1 (when considering the groupBasedBeamReporting method, the beam information may imply the beam information that is reported second among a group of beams containing the first transmission beam information preceding the CSI information contained in the UCI, and the beam information may imply CRI or SSBRI). Alternatively, the base station and UE may define the association between the reported beam group and CORESETPoolIndex in an implicit manner.

As the relationship between the first beam information and the second beam information in the reported beam group and the CORESETPoolIndexes having different indices follows the explicit rules described earlier, the first beam information in the beam group is associated with CORESETPoolIndex=0, and the second beam information in the beam group is associated with CORESETPoolIndex=1. When following the implicit method, this association may not be specified within the 3GPP specifications, but the base station may consider the implicit relationship and indicate the beam information (e.g., CRI or SSBRI) which is associated with the corresponding CORESETPoolIndex within the beam group through the DCI associated with the corresponding CORESETPoolIndex (i.e., a PDCCH received through a CORESET having a CORESETPoolIndex of 0 (or may not be configured) or 1), by using the TCI state for the scheduled uplink channel transmission (e.g., DLorJoint-TCIstate-r17 information element (IE) or the reference signal (referenceSignal) of UL-TCIstate (IE)). The DCI indicating the TCI state may be indicated through a DL DCI format (e.g., DCI format 1_1 or 1_2) for downlink scheduling or TCI state indication in the same manner as in the conventional unified TCI framework and applied to uplink transmission after the BAT, and may be indicated through a UL DCI format (e.g., DCI format 0_1 or 0_2) for scheduling uplink PUSCH and applied after the BAT or immediately applied at a time point when the PUSCH scheduled with the corresponding DCI is transmitted.

### Fourth Embodiment: SRS Configuration Method for Simultaneous Transmission of Codebook-Based PUSCH by Using Multiple Panels

In case that simultaneous uplink transmission using multiple panels is possible depending on the capability of the UE, the UE may configure the corresponding UE capability as supportable and report the same to the base station. For example, a UE capability reporting parameter that the UE reports to the base station may be simulTx-PUCCH-PUSCH, and a value for the parameter may be configured as supported, enable, and the like to report that the UE is capable of simultaneously transmitting PUCCH or PUSCH using multiple panels. The UE may simultaneously transmit multiple PUCCH or PUCCH repetitive transmissions or transmit multiple PUSCH or PUSCH repetitive transmissions simultaneously using multiple panels. On the other hand, simultaneous transmission of PUCCH and PUSCH using multiple panels may not be supported. The UE capability reporting parameter simulTx-PUCCH-PUSCH that the UE reports to the base station is only an example, and the UE may report to the base station that the UE is capable of performing uplink simultaneous transmission using multiple panels through parameters of other names that can perform similar or identical UE capability reporting.

Thereafter, the base station may configure higher layer parameters to support the UE, and the configured higher layer parameters may include higher layer parameters for simultaneous uplink transmission using multiple panels. If the base station configures higher layer parameters for simultaneous uplink transmission using multiple panels for the corresponding UE, an SRS resource set for PUSCH transmission may be configured. If codebook-based PUSCH is supported using multiple panels, an SRS resource set in which the usage of the SRS resource set is configured as codebook may be configured for the UE. One or more SRS resource sets having usage of codebook for simultaneous transmission of codebook-based PUSCH using multiple panels may be configured. If multiple SRS resource sets with usage of codebook are configured, this may imply that uplink signals can be transmitted through multiple TRPs according to the relationship between TCI states, as many as the number of configured SRS resource sets. For example, if an SRS resource set with two usages of codebook is configured for the UE by the base station, this may imply that the UE can transmit an uplink signal with up to two TRPs. For convenience of explanation, the disclosure mainly describes a method of simultaneously transmitting uplink signals to two TRPs, but the method can be expanded to simultaneously transmit uplink signals to a number of TRPs greater than 2.

When the base station configures multiple SRS resource sets with usage being codebook, one or at least one SRS resource may be configured within each SRS resource set. When configuring higher layer parameters for the SRS resource set for the UE, the base station may additionally include followUnifiedTCTstate-r17 therein. If followUnifiedTCTstate-r17 is configured in the SRS resource set, the UE transmits SRS resources in the SRS resource set according to the spatial relation obtained by referencing an RS (e.g., SRS) or an RS (e.g., CSI-RS or SSB) that has been used to determine the UL transmission spatial filter with qcl-Type configured as typeD in QCL-Info, such as the indicated DLorJoint-TCIstate-r17 (or TCI-State if the higher layer parameter unifiedTCI-StatType is configured as joint) or UL-TCIstate (or TCI-UL-State if the higher layer parameter unifiedTCI-StatType is configured as separate). The reference RS indicated by DLorJoint-TCIstate-r17 may be a CSI-RS within the NZP-CSI-RS-ResourceSet configured with higher layer parameter repetition or a CSI-RS within the NZP-CSI-RS-ResourceSet configured with higher layer parameter trs-Info. Alternatively, the reference RS indicated by UL-TCIstate may be a CSI-RS within the NZP-CSI-RS-ResourceSet configured with the higher layer parameter repetition, a CSI-RS within the NZP-CSI-RS-ResourceSet configured with higher layer parameter trs-Info, an SRS resource with usage configured as beamManagement, or an SSB associated with the same or different PCI as or from the PCI of the serving cell.

For convenience of explanation, it is assumed that the higher layer parameter followUnifiedTCTstate-r17 is configured in multiple SRS resource sets, and SRS resources are transmitted according to spatial relation determined by referencing the TCI state indicated by DCI (for example, DLorJoint-TCIstate-r17 or UL-TCIstate).

As described in the third embodiment, if a MAC CE for activating multiple TCI states has been received from a base station to a UE to support simultaneous uplink transmission using multiple panels, and one codepoint containing multiple (e.g., N) TCI states has been received from the UE through DCI and the like, the first SRS resource set among the multiple SRS resource sets is associated with the first TCI state among the indicated N TCI states. That is, the UE may transmit all SRS resources in the first SRS resource set according to the spatial relation determined with reference to the first TCI state among the N indicated TCI states. The first SRS resource set refers to the SRS resource set with the lowest SRS-ResourceSetId value among multiple SRS resource sets with usage configured as codebook (for convenience of explanation, the SRS resource set described in the fourth and fifth embodiments refers to an SRS resource set with usage being codebook). Similarly, the second SRS resource set among the multiple SRS resource sets is associated with the second TCI state among the indicated N TCI states. That is, the UE may transmit all SRS resources in the second SRS resource set according to the spatial relation determined with reference to the second TCI state among the N indicated TCI states. In a similar manner, in the case of SRS resource sets and TCI states with a number greater than 2, the UE may transmit all SRS resources included in the n-th SRS resource set according to a spatial relation determined with reference to the n-th TCI state. If multiple SRS resources are included in one SRS resource set, each SRS resource is associated with a panel according to different methods as follows. In case that the UE has reported that it can perform simultaneous uplink transmission using multiple panels through a UE capability report, and the base station considers this and configures higher layer parameters for simultaneous uplink transmission using multiple panels, the association between the SRS resources and the panel can be established.

Association 1

Each SRS resource included in the SRS resource set is associated with one panel supported by the UE. For example, the first SRS resource within the first SRS resource set is associated with the first panel among the panels supported by the UE (The order between panels among multiple panels may be determined by the implementation of the UE if information about the panel is implicitly determined. Alternatively, if information about the panel is explicitly configured and indicated, it can be determined as the lowest panel indicator. Thereafter, the second, third, etc. panels can be similarly defined). The second SRS resource within the first SRS resource set is associated with the second panel among the panels supported by the UE. The described configuration method is only an example, and a number of SRS resources other than two may be configured in one SRS resource set, and each SRS resource may be associated with any panel supported by the UE. However, this association should be established so that the base station and the UE have the same understanding, and a method of defining the association between the SRS resource and the panel supported by the UE in order, as in the above-mentioned example, may be considered. Additionally, in order for the base station and the UE to have the same understanding of the relationship between SRS resources and panels, the group-based beam reporting information described above may be used. Alternatively, information about a panel supported by the UE may be additionally configured within the SRS-Resource that is explicitly configured using a higher layer parameter. For example, a higher layer parameter such as panel_Index may be added within the higher layer parameter SRS-Resource and may be indicated as one of the values starting from 0 to Nₚₐₙₑₗ−1.

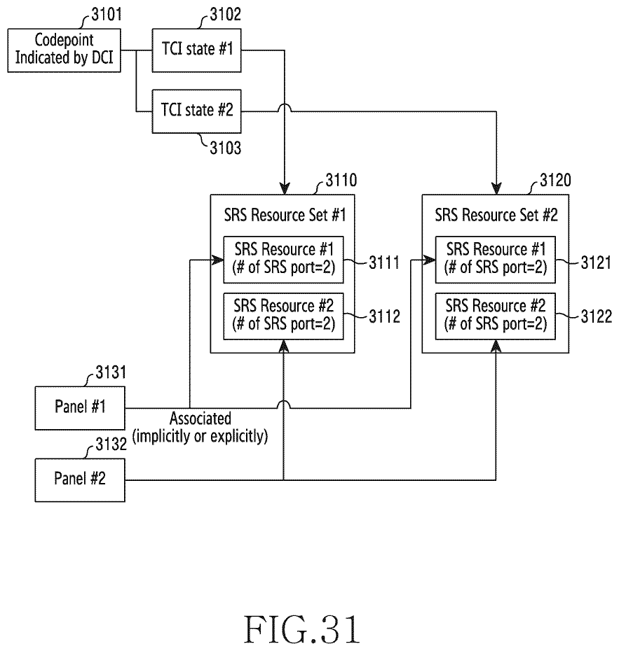

FIG. 31 illustrates when two sets of SRS resources each include two SRS resources, and when a UE can support simultaneous uplink transmission using two panels in a wireless communication system according to an embodiment. A codepoint indicated by a TCI field of DCI 3101 received by a UE from a base station indicates two TCI states 3102 and 3103 for simultaneous transmission using multiple panels. The first TCI state 3102 may be used to determine a spatial relation for transmitting SRS resources 3111 and 3112 in a first SRS resource set 3110. The second TCI state 3103 may be used to determine a spatial relation for transmitting SRS resources 3121 and 3122 in a second SRS resource set 3120. A first panel 3131 of the UE may be implicitly or explicitly associated with the first SRS resource 3111 in the first SRS resource set 3110.

If the first TCI state includes RS transmitted from the first TRP among multiple TRPs as a reference RS, the UE may understand that the first SRS resource 3111 in the first SRS resource set 3110 has been configured to perform transmission to the first TRP using the first panel 3131 of the UE. Additionally, the first panel 3131 may be implicitly or explicitly associated with the first SRS resource 3121 in the second SRS resource set 3120. If the second TCI state includes RS transmitted from the second TRP among the multiple TRPs as a reference RS, the UE may understand that the first SRS resource 3121 in the second SRS resource set 3120 has been configured to perform transmission to the second TRP using the first panel 3131 of the UE. The second panel 3132 of the UE may be implicitly or explicitly associated with the second SRS resource 3112 in the first SRS resource set 3110. If the first TCI state includes RS transmitted from the first TRP among multiple TRPs as a reference RS, the UE may understand that the first SRS resource 3111 in the first SRS resource set 3110 has been configured to perform transmission to the first TRP using the second panel 3132 of the UE. Additionally, the second panel 3132 may be implicitly or explicitly associated with the second SRS resource 3122 in the second SRS resource set 3120. If the second TCI state includes an RS transmitted from the second TRP among the multiple TRPs as a reference RS, the UE may understand that the second SRS resource 3122 in the second SRS resource set 3120 has been configured to perform transmission to the second TRP using the second panel 3132 of the UE. In FIG. 31, a case in which the number of SRS ports of SRS resources included in each SRS resource set is 2 is shown.

Association 2

SRS resources included in the SRS resource set is associated with one panel or multiple panels. For example, the first SRS resource within the first SRS resource set is associated with a first panel (or second panel) among panels supported by the UE, and the second SRS resource within the first SRS resource set is associated with the first and second panels among panels supported by the UE. Similarly, the first SRS resource within the second SRS resource set is associated with the second panel (or first panel) among the panels supported by the UE, and the second SRS resource within the second SRS resource set is associated with the first and second panels among the panel supported by the UE. The described configuration method is only an example, and a number of SRS resources other than two may be configured in one SRS resource set. Each SRS resource may be associated with any panel supported by the UE, and the first SRS resource in the SRS resource set may be associated with multiple panels. However, as with Association 1, Association 2 should also be configured so that the base station and the UE have the same understanding, and the above-mentioned example may be considered as a method to define the association between SRS resources and the panels supported by the UE.

Additionally, in order for the base station and the UE to have the same understanding of the association between SRS resources and panels, the group-based beam reporting information described above may be used. Alternatively, information about the panels supported by the UE may be added to an SRS-Resource that is explicitly configured as a higher layer parameter. For example, a higher layer parameter such as panel_Index may be added within a higher layer parameter SRS-Resource and indicated by one or more values from 0 to Nₚₐₙₑₗ−1 Alternatively, panel_Index may be configured as a higher layer parameter, using a bitmap format, with a value of 1 for panels that are associated with that SRS resource and 0 for panels that are not associated. In this case, panel_Index may include Nₚₐₙₑₗ bits. Alternatively, panel_Index may be configured with

$$⌈ {log}_{2} ( {\sum }_{k = 1}^{{N}_{panel}} ( \begin{matrix}{N}_{panel} \\ k\end{matrix} ) ) ⌉$$

bits so as to consider the full range of combinations for supported panels.

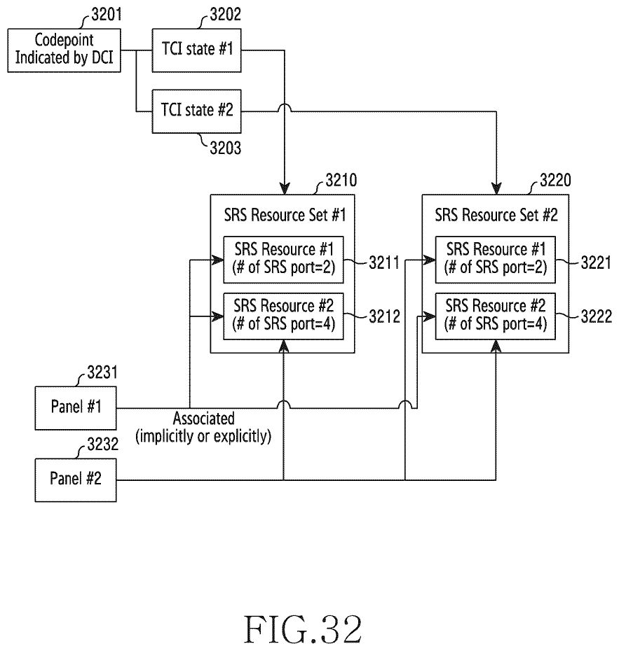

FIG. 32 illustrates when two sets of SRS resources each include two SRS resources, and when a UE can support simultaneous uplink transmission using two panels in a wireless communication system according to an embodiment. A codepoint indicated by a TCI field of DCI 3201 received by a UE from a base station indicates two TCI states 3202 and 3203 for simultaneous transmission using multiple panels. The first TCI state 3202 may be used to determine a spatial relation for transmitting SRS resources 3211 and 3212 in a first SRS resource set 3210. The second TCI state 3203 may be used to determine a spatial relation for transmitting SRS resources 3221 and 3222 in a second SRS resource set 3220. A first panel 3231 of the UE may be implicitly or explicitly associated with the first SRS resource 3211 in the first SRS resource set 3210.

If the first TCI state includes RS transmitted from the first TRP among multiple TRPs as a reference RS, the UE may understand that the first SRS resource 3211 in the first SRS resource set 3210 has been configured to perform transmission to the first TRP using the first panel 3231 of the UE. In this case, the number of SRS ports configured in the first SRS resource 3211 in the first SRS resource set 3210 may be equal to 2. The second panel 3232 of the UE may be implicitly or explicitly associated with the first SRS resource 3221 in the second SRS resource set 3220. If the second TCI state includes RS transmitted from the second TRP among the multiple TRPs as a reference RS, the UE may understand that the first SRS resource 3221 in the second SRS resource set 3220 has been configured to perform transmission to the second TRP using the second panel 3232 of the UE. In this case, the number of SRS ports configured in the first SRS resource 3211 in the second SRS resource set 3220 may be equal to 2. The second SRS resource 3212 configured in the first SRS resource set 3210 may be implicitly or explicitly associated with both panels, that is, the first panel 3231 and the second panel 3232 supported by the UE. If the first TCI state includes RS transmitted from the first TRP among multiple TRPs as a reference RS, the UE may understand that the second SRS resource 3212 in the first SRS resource set 3210 has been configured to perform transmission to the first TRP using both panels, that is, the first panel 3231 and the second panel 3232 of the UE. The number of SRS ports configured in the second SRS resource 3212 in the first SRS resource set 3210 may be equal to 4, which is the number that can be supported using both panels. The first two SRS ports is associated with the first panel 3231 and then the remaining two SRS ports is associated with the second panel 3232.

The relationship between these SRS ports and multiple panels may be implicitly associated in order or may be explicitly indicated as a new higher layer parameter. For example, panel_Index equal to the number of SRS ports for the SRS resource may be configured in the form of a sequence. The second SRS resource 3222 configured in the second SRS resource set 3220 may be implicitly or explicitly associated with the first panel 3231 and second panel 3232 of both panels supported by the UE. If the second TCI state includes an RS transmitted from the second TRP among the multiple TRPs as a reference RS, the UE may understand that the second SRS resource 3222 in the first SRS resource set 3220 has been configured to perform transmission to the second TRP using both panels, that is, the first panel 3231 and the second panel 3232 of the UE. The number of SRS ports configured in the second SRS resource 3222 in the second SRS resource set 3220 may be equal to 4, which is the number that can be supported using both panels. As with the second SRS resource 3212 in the first SRS resource set 3210, an implicit or explicit association may be established between the SRS port and the panel supported by the UE.

The above description concerns when SRS resources are transmitted based on the indicated TCT state. However, even in cases where followUnifiedTCTstate-r17 is not configured, simultaneous transmission using multiple panels can be supported by applying the above-described method based on the spatial relation info configured in the SRS resources within each SRS resource set. The first TCI state described above may be replaced with spatialRelationInfo configured as a higher layer parameter for SRS resources in the first SRS resource set, and the second TCI state may be replaced with spatialRelationInfo configured as a higher layer parameter for SRS resources in the second SRS resource set.

As described above, the base station indicates multiple TCI states through sDCI, and each indicated TCI state is associated with each SRS resource set and the SRS resource(s) included in each SRS resource set. That is, if each TCI state and the SRS resource set are associated, the UE may transmit the SRS resource with reference to the reference signal indicated by the TCI state, may transmit PUSCH by configuring a PUSCH transmission port to be the same as the SRS port of the SRS resource indicated via SRI (when supporting non-codebook based PUSCH), or may transmit PUSCH by applying a precoder indicated by TPMI (when supporting codebook based PUSCH) to the PUSCH transmission port configured to be the same as the SRS port of the SRS resource indicated via SRI.

Each PUSCH may be scheduled using multiple DCIs through mDCI, and may fully/partially/non overlap in the time/frequency domain. Each DCI is associated with a different CORESETPoolIndex, and each scheduled PUSCH is also associated with a different CORESETPoolIndex. In order to transmit the PUSCH scheduled by each DCI, two different sets of SRS resources may be configured through higher layer parameters. Depending on the explicit rules within the 3GPP technical specifications or the implicit rules between the base station and the UE, the first SRS resource set (which may indicate the SRS resource set configured with a low SRS-ResourceSetId of the two different SRS resource sets, the usage of which is codebook or nonCodebook) is associated with a CORESET with CORESETPoolIndex=0 (or with no CORESETPoolIndex configured) and a PUSCH scheduled with DCI within the corresponding CORESET. The second SRS resource set (which may indicate the SRS resource set configured with a high SRS-ResourceSetId of the two different SRS resource sets, the usage of which is codebook or nonCodebook) is associated with a CORESET with CORESETPoolIndex=1 and a PUSCH scheduled with DCI within the corresponding CORESET. The DCI associated with each CORESETPoolIndex may indicate the TCI state based on beam information within the beam group that is associated with each CORESETPoolIndex to schedule the corresponding PUSCH transmission, as described in the third embodiment. For example, the first beam information in the beam group may indicate the TCI state (DLorJoint-TCIstate-r17 or UL-TCIstate) in the DCI received as CORESET with CORESETPoolIndex=0 (or with no CORESETPoolIndex configured). The DCI may indicate the TCI state through the DL DCI format (e.g., DCI format 1_1 or 1_2) as described in the third embodiment, and beam information indicated by the TCI state may be applied to uplink transmission after BAT. Alternatively, as described in the third embodiment, the TCI state is indicated through the UL DCI format (e.g., DCI format 0_1 or 0_2) and the beam information indicated by the TCI state is applied to uplink transmission after BAT or may also be immediately applied at a time of transmitting a UL PUSCH scheduled with the corresponding DCI.

### Fifth Embodiment: Method for Configuring Higher Layer Parameters for Simultaneous Transmission of Configured Grant PUSCH Using Multiple Panels

As described in the third and fourth embodiments, the UE may perform beam reporting and beam application to support mDCI-based uplink multi-panel simultaneous transmission, and a base station may perform reception of beam reporting, beam indication, and configure SRS resource sets for the corresponding UE. The mDCI-based uplink multi-panel simultaneous transmission may be supported for dynamic grant (DG) PUSCH scheduled based on DCI and configured grant (CG) PUSCH scheduled based on higher layer parameters (RRC parameters).

Specifically, CG PUSCH is divided into Type 1 CG PUSCH, which is scheduled only with preconfigured higher layer parameters, and Type 2 CG PUSCH, which requires DCI format 0_0 or DCI format 0_1 to activate CG PUSCH transmission in addition to configured higher layer parameters. Higher layer parameters to support CG PUSCH may be configured as ConfiguredGrantConfig, and in the case of Type 1 CG PUSCH, rrc-ConfiguredUplinkGrant in ConfiguredGrantConfig is configured. rrc-ConfiguredUplinkGrant is not configured in ConfiguredGrantConfig to support Type 2 CG PUSCH. Prior to Rel. 16, only one ConfiguredGrantConfig may be configured to support CG PUSCH. Subsequently, up to maxNrofConfiguredGrantConfig-r16 (for example, 12) ConfiguredGrantConfig may be configured in the higher layer parameter ConfiguredGrantConfigToAddModList-r16. Therefore, after Rel. 16, both Type 1 CG PUSCH and Type 2 CG PUSCH may be supported in the same UL BWP.

In NR Release 18 (Rel.18), to support simultaneous uplink transmission using sDCI-based or mDCI-based multiple panels with respect to CG PUSCH, similar or new higher layer parameter configuration with regard to Rel. 17 may be required. The following two options may be considered as a new higher layer parameter configuration method.

Option 1 provides that within one ConfiguredGrantConfig configuration, an additional higher layer parameter set is configured to support multi-panel simultaneous transmission.

Option 1 is a method of applying one ConfiguredGrantConfig to a CG PUSCH for simultaneous transmission using two panels. Depending on a method for configuring higher layer parameter set configured in ConfiguredGrantConfig, it is possible to support only simultaneous transmission fully overlapping on the exact same resource, or support simultaneous transmission overlapping on some resources. As an example, if ConfiguredGrantConfig is configured in the method of Option 1 to support multi-panel simultaneous transmission of Type 1 CG PUSCH, a new higher layer parameter may be configured to indicate a multi-panel simultaneous transmission in ConfiguredGrantConfig. This indicates that the UE has reported to the base station the UE capability of being capable of multi-panel simultaneous transmission, and may have additionally reported the UE capability of being capable of multi-panel simultaneous transmission for CG PUSCH. As a higher layer parameter that can be added to ConfiguredGrantConfig, supportSTxMP-r18 (or a higher layer parameter having another name that performs the same function) may be configured to be a value capable of indicating that support is available, such as enable, support, or 1. Alternatively, the UE may be configured to implicitly recognize through the presence or absence of additional higher layer parameters. In case that a new higher layer parameter is configured or the implicitly corresponding ConfiguredGrantConfig is determined to be a higher layer parameter to support multi-panel simultaneous transmission, the base station may configure additional parameters for CG PUSCH transmission using two panels in ConfiguredGrantConfig.

For example, the previously configured higher layer parameters may be used by the UE to transmit a CG PUSCH through the first panel. The PUSCH transmitted using the first panel is not explicitly indicated, and may be defined as a PUSCH transmitted using a transmission beam associated with CORESET with CORESETPoolIndex=0 (or CORESETPoolIndex is not configured). The additionally configured higher layer parameters may be used by the UE to transmit CG PUSCH through the second panel. Similarly, the PUSCH transmitted using the second panel is not explicitly indicated, and may be defined as a PUSCH transmitted using a transmission beam associated with CORESET with CORESETPoolIndex=1. The previously configured higher layer parameters may be used to transmit the CG PUSCH through the second panel, and the additionally configured higher layer parameters may be used to transmit the CG PUSCH through the first panel. As such, higher layer parameters that should be configured differently for the PUSCH transmitted through each panel may be some or all of the parameters configured in ConfiguredGrantConfig. If some of the parameters configured in ConfiguredGrantConfig may be configured differently for transmission for each panel, other parameters may be commonly used to transmit PUSCH using both panels. For example, p0-PUSCH-Alpha in ConfiguredGrantConfig may be configured differently for transmission for each panel since the channel situation and scheduling situation between each panel and each TRP may be different. The transmission power of PUSCH through each panel can be calculated differently through the corresponding parameters.

Similarly, parameters including two parameters, such as powerControlLoopToUse, pathlossReferenceIndex, precodingAndNumberOfLayers, antennaPort, srs-ResourceIndicator, mcsAndTBS, etc. may be configured in ConfiguredGrantConfig or in rrc-ConfiguredUplinkGrant within ConfiguredGrantConfig, so that different parameters may be applied to the PUSCH transmission for each panel. Alternatively, the higher layer parameters (e.g., precodingAndNumberOfLayers2-r17, pathlossReferenceIndex2-r17, srs-ResourceIndicator2-r17, etc.) added in Rel. 17 for sDCI-based time division multiplexing (TDM) mTRP CG PUSCH repetitive transmission may be used for CG PUSCH simultaneous transmission with multiple panels. If sDCI-based TDM mTRP CG PUSCH repetitive transmission and mDCI-based multi-panel simultaneous transmission or sDCI-based multi-panel simultaneous transmission are supported simultaneously, a new higher layer parameter (e.g., supportSTxMP-r18) for indicating that it is a higher layer parameter for multi-panel-based simultaneous transmission as described above may be considered. In addition, higher layer parameters for CG PUSCH, which can be simultaneously transmitted through each panel, may be additionally considered.

However, the UE may use the same parameters in common for two CG PUSCHs transmitted simultaneously through each panel. For example, resourceAllocation in ConfiguredGrantConfig can be commonly applied to two CG PUSCHs transmitted simultaneously through two panels (or a separate additional parameter may be configured so that the corresponding parameter can be applied differently to PUSCH transmission through each panel). In case that the same resourceAllocation is applied to both CG PUSCHs, this indicates that the CG PUSCHs transmitted simultaneously using both panels are scheduled with the same type of resource allocation method (e.g., resourceAllocationType0, resourceAllocationType1, or one of dynamicSwitches that can support both types). Similarly, parameters such as repK, repK-RV, Periodicity, timeDomainOffset, timeDomainAllocation, and frequencyDomainAllocation may be applied equally to two CG PUSCHs transmitted simultaneously through two panels.

According to Option 1, second higher layer parameters that can have new values for some higher layer parameters of ConfiguredGrantConfig may be additionally configured and the same may be applied to the CG PUSCH transmitted through each panel, and higher layer parameters configured with only one value may be commonly applied to all CG PUSCHs transmitted through both panels.

In Option 2, an additional configuration of separate ConfiguredGrantConfig to support multi-panel simultaneous transmission is provided.

Option 2, unlike Option 1, is a method of configuring a higher layer parameter ConfiguredGrantConfig for the CG PUSCH transmitted through each panel. The same higher layer parameters as before may be configured in ConfiguredGrantConfig for the CG PUSCH transmitted through each panel. Some parameters may be configured to have different values as previously described in Option 1, and remaining parameters may be configured to have the same value. Additionally, each ConfiguredGrantConfig is associated with CORESETPoolIndex=0 or CORESETPoolIndex=1. To indicate this association, the higher layer parameter CORESETPoolIndex within ConfiguredGrantConfig may be configured to be 0 or 1, and A new higher layer parameter to indicate multi-panel simultaneous transmission as described above (e.g., supportSTxMP-r18) may be configured. CG PUSCH activated by ConfiguredGrantConfig with CORESETPoolIndex configured as 0 and CG PUSCH activated by ConfiguredGrantConfig with ConfiguredGrantConfig configured as 1 may be transmitted simultaneously through two panels. If only one set of ConfiguredGrantConfig is configured (meaning one ConfiguredGrantConfig with CORESETPoolIndex configured as 0 and one ConfiguredGrantConfig with CORESETPoolIndex configured as 1), it may be unnecessary for an additional connection relationship since it is clear that both ConfiguredGrantConfig are configured for simultaneous transmission using two panels. However, if there are multiple ConfiguredGrantConfig sets configured with different CORESETPoolIndices, an association between ConfiguredGrantConfig that activates CG PUSCH that can be transmitted simultaneously may be required. To specify this association, a new higher layer parameter may be added within ConfiguredGrantConfig.

For example, a parameter referred to as ConfiguredGrantLinkingId (or another named higher layer parameter for the same purpose may be configured) may be configured. The parameter may be configured as one of the values from 0 to M−1, and two ConfiguredGrantConfig having association may include a ConfiguredGrantLinkingId parameter having the same value. For example, if the Kth ConfiguredGrantConfig configuration and the (K+1)th ConfiguredGrantConfig configuration in ConfiguredGrantConfigToAddModList are configured as CORESETPoolIndex 0 and 1, respectively, and ConfiguredGrantLinkingId are both configured as k, the UE may perform simultaneous transmission of the CG PUSCH activated by the Kth ConfiguredGrantConfig and the CG PUSCH activated by the (K+1)th ConfiguredGrantConfig, by using each panel. This may correspond to when each CG PUSCH scheduled with ConfiguredGrantConfig overlap on the same physical resource, and if they do not overlap, they may not be transmitted at the same time.

### Sixth Embodiment: Overlapping Rule for Handling Overlap Between Dynamic Grant PUSCH and Configured Grant PUSCH when Supporting Multi-DCI-Based Multi-Panel Simultaneous Transmission

The sixth embodiment concerns when supporting simultaneous uplink transmission using multiple panels based on multi DCI (mDCI), for the case in which a dynamic grant (DG) PUSCH and a configured grant (CG) PUSCH partially or fully overlaps on the same resource, the overlapping rule for determining the PUSCH to be transmitted by the UE.

As previously explained in the fifth embodiment, simultaneous transmission using multiple panels may also be supported by CG PUSCH in addition to DG PUSCH. If simultaneous uplink multiple panel transmission is supported based on mDCI, the following cases of overlap between DG PUSCH and CG PUSCH may be considered.

Case 1 concerns DG PUSCH (associated with panel1 or CORESETPoolIndex=0) and DG PUSCH (associated with panel2 or CORESETPoolIndex=1) partially or fully overlap on a resource.

Case 2, concerns DG PUSCH (associated with panel1 or CORESETPoolIndex=0) and Type 1 CG PUSCH (associated with panel2 or CORESETPoolIndex=1).

Case 3 concerns DG PUSCH (associated with panel2 or CORESETPoolIndex=1) and Type 1 CG PUSCH (associated with panel1 or CORESETPoolIndex=0).

Case 4 concerns DG PUSCH (associated with panel1 or CORESETPoolIndex=0) and Type 2 CG PUSCH (associated with panel2 or CORESETPoolIndex=1).

Case 5 concerns DG PUSCH (associated with panel2 or CORESETPoolIndex=1 and Type 2 CG PUSCH (associated with panel1 or CORESETPoolIndex=0).

Case 6 concerns Type 1 CG PUSCH (associated with panel1 or CORESETPoolIndex=0) and Type 1 CG PUSCH (associated with panel2 or CORESETPoolIndex=1).

Case 7 concerns Type 1 CG PUSCH (associated with panel2 or CORESETPoolIndex=1) and Type 1 CG PUSCH (associative with panel1 or CORESETPoolIndex=0).

Case 8 concerns Type 2 CG PUSCH (associated with panel1 or CORESETPoolIndex=0) and Type 2 CG PUSCH (associated with panel2 or CORESETPoolIndex=1).

Case 9 concerns Type 2 CG PUSCH (associated with panel2 or CORESETPoolIndex=1) and Type 2 CG PUSCH (associated with panel1 or CORESETPoolIndex=0).

Case 10 concerns Type 1 CG PUSCH (associated with panel1 or CORESETPoolIndex=
0) and Type 2 CG PUSCH (associated with panel2 or CORESETPoolIndex=1).

Case 11 concerns Type 1 CG PUSCH (associated with panel2 or CORESETPoolIndex=1) and Type 2 CG PUSCH (associated with panel1 or CORESETPoolIndex=0).

As described above, multi-panel simultaneous transmission cases are assumed by considering association between various PUSCH types and panels or CORESETPoolIndex. In the case of overlap between DG PUSCHs (Case 1), it is assumed that the corresponding scheduling is performed based on the DCI associated with each CORESETPoolIndex, and the number of layers may be determined by considering the case in which two TRPs overlap. This is because even though mDCI mTRP NC-JT operates based on a non-ideal backhaul instead of ideal backhaul, some essential scheduling information can be assumed to be exchanged. If mDCI mTRP NC-JT, which has a backhaul capability that makes it difficult to share even the minimum scheduling information, is supported, scheduling restrictions that are strictly adhere to the conditions that should satisfy to perform multi-panel simultaneous transmission, such as limiting the number of layers may be necessary. Herein, mDCI mTRP NC-JT may not exchange as much scheduling information as sDCI mTRP NC-JT, but scheduling information that can be exchanged with only a few bits, such as layer information and whether to schedule simultaneous transmission using multiple panels, can be assumed to be exchanged between two TRPs.

Among the various overlapping cases described above, when DG PUSCH and CG PUSCH overlap, since the CG PUSCH is an uplink transmission resource that is activated based on scheduling information already configured by the higher layer parameter, the CG PUSCH may be a less flexible uplink transmission management method, unlike dynamically scheduled DG PUSCH. Due to this characteristic, when DG PUSCH is scheduled to overlap with CG PUSCH, only an operation of stopping transmission of the CG PUSCH transmission resource activated by a higher layer parameter for CG PUSCH (if it is a Type2 CG PUSCH, scheduling information included in the DCI for activation is also included) and updating the scheduling information to transmit (i.e., override) only DG PUSCH has been supported until NR Rel. 17.

However, as Rel. 18 supports simultaneous transmission using multiple panels, scheduling information may be updated through DG PUSCH, and if the conditions are met, CG PUSCH transmission resources activated according to the higher layer configuration of CG PUSCH may also be transmitted simultaneously through a panel different from a panel through which the DG PUSCH is transmitted. Through this function, the UE may gain the advantage of increasing the uplink throughput of a system by allowing more uplink data to be transmitted. However, such multi-panel simultaneous transmission may not always be supported. As described above, CG PUSCH has the characteristic that flexible scheduling depending on the situation is not possible because the transmission resources of CG PUSCH are determined based on configuration information configured by higher layer parameters. Therefore, when multiple conditions are met between CG PUSCH transmission resources and overlapping DG PUSCH transmission resources, they can be transmitted simultaneously. If some (including one) or all of these conditions are not satisfied, the UE may transmit DG PUSCH without transmitting CG PUSCH or change the transmission resources of CG PUSCH according to a predetermined clear rule to transmit CG PUSCH and DG PUSCH through multiple panels. A predetermined rule should have a common understanding between the base station and the UE.

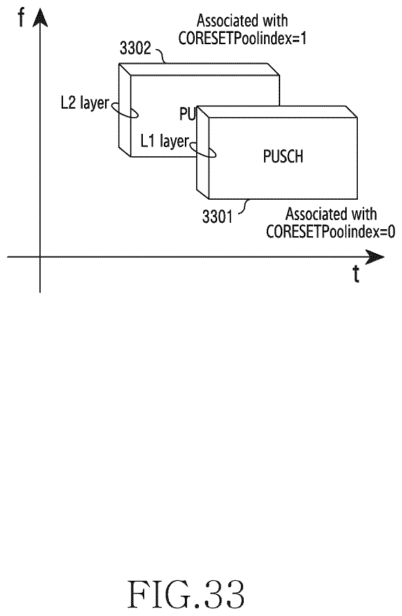

FIG. 33 illustrates when two PUSCH transmissions associated with each CORESETPoolIndex overlap according to an embodiment. A first PUSCH transmission 3301 associated with CORESETPoolIndex=0 and a second PUSCH transmission 3302 associated with CORESETPoolIndex=1 may overlap across some or all resources in the time domain or/and frequency domain. In FIG. 33, overlap may include both a case of overlapping in the frequency and time domains or not overlapping in the frequency domain but overlapping in the time domain. Two different PUSCHs may have PUSCH transmission scheduled based on the DCI received from CORESET configured with the associated CORESETPoolIndex, the PUSCH transmissions may have been activated based on a higher layer parameter configured by considering multi-panel simultaneous transmissions as previously described in fifth embodiment, or the PUSCH transmissions may have been activated based on a higher layer parameter without further association with a specific CORESETPoolIndex, in the same method as conventional CG PUSCHs are activated.

The following assumes a case in which two PUSCHs associated with CORESETPoolIndex overlap, but commonly applicable rules may also be considered for the conventional method of activating the CG PUSCH. Based on this, the UE may support multi-panel simultaneous transmission. In FIG. 33, the first PUSCH 3301 is scheduled/activated to be transmitted to the L1 (e.g., 4) layer and the second PUSCH 3302 is scheduled/activated to be transmitted to the L2 (e.g., 4) layer. The total number of layers of two overlapping PUSCHs is obtained by (L1+L2) (for example, 4+4=8). If the total number of layers that the UE can transmit simultaneously using multiple panels is limited to L (for example, 4 in Rel. 18), the UE may not transmit two PUSCHs simultaneously in an area in which resources overlap. This is one condition, and the UE may determine whether multi-panel simultaneous transmission of two overlapping PUSCHs is possible or whether transmission of one PUSCH is canceled by identifying all or some of the conditions. It is assumed that the two overlapping PUSCHs are configured by one DG PUSCH and one CG PUSCH, but the same can be applied to other similar conditions (e.g., DG PUSCH and DG PUSCH). Additionally, higher layer parameters for CG PUSCH supporting multi-panel simultaneous transmission are explained assuming Option 2, which configures a separate ‘ConfiguredGrantConfig’ for each CORESETPoolIndex among the higher layer configuration methods described in the fifth embodiment.

In Condition 1, it is determined whether CORESETPoolIndexs associated with two overlapping PUSCHs are different.

When performing mDCI-based multi-panel simultaneous transmission, the UE may simultaneously transmit two different PUSCHs associated with two different CORESETPoolIndex. That is, if two different PUSCHs are associated with the same CORESETPoolIndex, the UE may cancel transmission of one PUSCH (e.g., CG PUSCH) of the two different PUSCHs and transmit only the other PUSCH (e.g., DG PUSCH) without performing multi-panel-based simultaneous transmission. However, if the UE is capable of simultaneously transmitting two different overlapping PUSCHs using different panels even if they are associated with the same CORESETPoolIndex, the UE may transmit two different PUSCHs depending on whether other conditions are satisfied. Additional UE capability reporting for this operation may be required, a new higher layer parameter may be configured for the UE that has reported the UE capability report to the base station, and the UE may be scheduled to simultaneously transmit two different PUSCHs associated with the same CORESETPoolIndex.

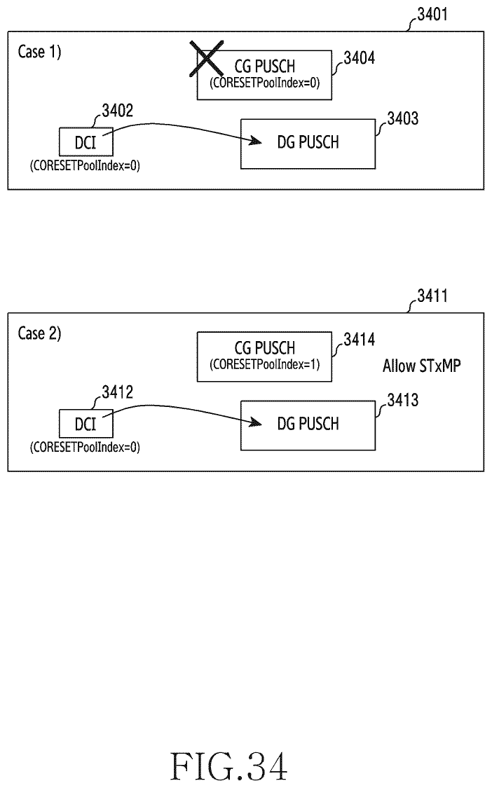

FIG. 34 illustrates determining multi-panel simultaneous transmission according to CORESETPoolIndex according to an embodiment. As in case 1 3401, simultaneous transmission using multiple panels may not be possible for a DG PUSCH 3403 scheduled with DCI 3402, which is received using CORESET configured with the same CORESETPoolIndex as CORESETPoolIndex with which a CG PUSCH (3404) is associated. However, as in case 2 3411, simultaneous transmission using multiple panels may be possible for a DG PUSCH 3413 scheduled with DCI 3412, which is received using CORESET configured with CORESETPoolIndex different from CORESETPoolIndex with which a CG PUSCH 3414 is associated. Therefore, the UE can simultaneously transmit two different overlapping PUSCHs 3413 and 3414.

In Condition 2, it is determined whether the total transmission power in the overlapping part of two different PUSCHs does not exceed the maximum UE transmission power.

When performing mDCI-based multi-panel simultaneous transmission, the uplink transmission power of each PUSCH transmitted through each panel may be determined according to different uplink power control (or uplink power control) (or, in another example, they may share the same transmission power). Depending on the power management method to support multiple panels of the UE, the total transmission power in the overlapping part of two different PUSCHs may be less than or equal to the maximum UE transmission power.

If each panel is capable of operating separate transmission power and the maximum transmission power for each panel can be utilized separately, it may not be necessary to verify that the overlapped PUSCH transmission part under Condition 2 exceeds the maximum UE transmission power. However, if multiple panels of the UE share the total transmission power, and the sum of the transmission power transmitted through all panels should be determined according to the maximum UE transmission power per UE rather than the maximum transmission power per panel, the UE may identify whether the overlapping PUSCH transmission portion according to Condition 2 exceeds the maximum UE transmission power. If the UE is required to identify Condition 2 as described above and the sum of the transmission power of the overlapping parts exceeds the maximum transmission power of the UE, the UE may cancel the transmission of one PUSCH (e.g., CG PUSCH) of the two different PUSCHs and transmit only the other PUSCH (e.g., DG PUSCH) without performing simultaneous multi-panel based transmission. If the UE should identify Condition 2, the sum of the transmission power of the overlapping parts does not exceed the maximum transmission power of the UE, and some or all of the other conditions are satisfied, the UE may perform multi-panel based simultaneous transmission and transmit the two different PUSCHs through their respective panels.

As a method of supporting multi-panel simultaneous transmission according to different transmission powers, if Condition 2 should be identified and the sum of the transmission power of the overlapping part exceeds the maximum transmission power of the UE, the UE may adjust the transmission power of each PUSCH transmission segment according to UE implementation (or rules determined between the base station and the UE). Alternatively, the UE may only adjust the transmission power of overlapping PUSCH transmission segments (in this case, the UE may require additional UE capacity). As UE implementation, the transmission power of each PUSCH can be scaled with the same scaling factor so that the transmission section in which two different PUSCHs overlap can be less than or equal to the maximum uplink transmission power of the UE. Alternatively, scaling of the transmission power of each PUSCH may be done with different scaling factors. In this case, depending on the DG PUSCH or CG PUSCH, a large scaling factor is assigned to the DG PUSCH and a small scaling factor is assigned to the CG PUSCH to reduce the transmission power of the DG PUSCH. Alternatively, the CG PUSCH transmission power may be implemented to be scaled to be small.

In Condition 3, it is determined whether the sum of the layers of two PUSCHs in the overlapping part of two different PUSCHs is less than the maximum number of uplink layers that the UE can support.

When performing multi-panel simultaneous transmission, the number of layers transmitted for each PUSCH transmitted through each panel may be determined by DCI or higher layer parameters. The sum of layers in the overlapping part of two different PUSCHs may be compared to the total number of uplink layers that the UE is capable of supporting. The total number of uplink layers may be configured as a common value for both multi-panel simultaneous transmission and single-panel transmission. Alternatively, multi-panel simultaneous transmission and single-panel transmission may each support different values of the total number of uplink layers. In this case, each higher layer parameter may be configured.

If multi-panel simultaneous transmission and single-panel transmission are supported based on different total numbers of uplink layers, the total number of uplink layers for multi-panel simultaneous transmission is compared with the sum of layers in the overlapping part of two different PUSCHs in Condition 3. As in Condition 3, if the sum of layers in the overlapping part is greater than the total number of uplink layers that the UE is capable of supporting, the UE may not perform multi-panel simultaneous transmission depending on the UE capability. If multi-panel simultaneous transmission is not performed because two different overlapping PUSCHs do not satisfy Condition 3, the UE may transmit only the DG PUSCH without transmitting the CG PUSCH. Alternatively, although two different overlapping PUSCHs do not satisfy Condition 3, if the UE is capable of supporting additional UE capability, the UE may support limited cases of multi-panel simultaneous transmission and transmit the DG PUSCH and CG PUSCH (the entire CG PUSCH or part of CG PUSCH). Even if Condition 3 is not satisfied through the corresponding additional UE capability, the UE may report to the base station that the UE can transmit CG PUSCH using as many layers as {the maximum number of supportable layers−the number of layers of DG PUSCH} of the layers scheduled for CG PUSCH (or the UE may report to the base station that the UE may transmit DG PUSCH using as many layers as {the maximum number of supportable layers−the number of layers of CG PUSCH}).

If the sum of (allocated/configured for transmission/resources) layers of two different overlapped PUSCHs is greater than the maximum number of layers (e.g., 4 or 8) that can be transmitted during multi-panel simultaneous transmission of the UE, the UE may transmit only a DG PUSCH without transmitting a CG PUSCH. In this case, reception, by the UE, of the PDCCH for DCI scheduling the DG PUSCH is assumed to be complete in symbol i, and the start point of symbol j is assumed to be a time point at which the UE starts to transmit the CG PUSCH. In this case, depending on whether the difference between the end point of symbol i (the symbol in which the UE completes reception of the PDCCH for the DCI scheduling the DG PUSCH) and the start point of symbol j (the symbol associated with a time point at which the UE starts transmitting the CG PUSCH) is greater than or less than a predetermined value/specific value, the procedure for the UE to prepare the MAC protocol date unit (PDU) on a higher layer may differ. The predetermined value/specific value may be a value N₂, which may be determined according to UE processing capability for a preparation procedure time required for the UE to prepare for PUSCH, or may be determined according to any other preparation procedure time to support multi-panel simultaneous transmission or to support PUSCH transmission. If the difference between the end point of the symbol i and the start point of the symbol j described above is greater than a predetermined value (e.g., N₂), the UE may identify in advance to perform DG PUSCH transmission without performing CG PUSCH transmission, and may not generate a MAC PDU that should be transmitted through the CG PUSCH. In other words, if the difference between the end point of symbol i and the start point of symbol j is greater than a predetermined value (e.g., N₂), a UE operation may be defined/configured such that the UE transmits the DG PUSCH without transmitting the CG PUSCH, and according to the defined/configured operation, the UE may not generate the MAC PDU that should be transmitted through the CG PUSCH. If the difference between the end point of symbol i and the start point of symbol j described above is less than a predetermined value (e.g., N₂), the UE may have already generated and transferred the MAC PDU that should be transmitted through the CG PUSCH to a lower layer (or physical layer), and the UE may drop the MAC PDU that should be transmitted through the CG PUSCH and transmit only the MAC PDU that should be transmitted through the DG PUSCH to the base station. In other words, if the difference between the end point of symbol i and the start point of symbol j described above is less than a predetermined value (e.g., N₂), the UE may have already generated and transferred the MAC PDU that should be transmitted through the CG PUSCH to a lower layer (or physical layer), and the UE may drop the MAC PDU that have already been transferred to the lower layer and should be transmitted through the CG PUSCH, and transmit only the MAC PDU that should be transmitted through the DG PUSCH to the base station. In this case, if the UE is already transmitting the CG PUSCH, the UE may stop transmitting and drop the remaining CG PUSCHs, and may transmit only the DG PUSCH to the base station. In other words, when the UE has already started transmitting a MAC PDU that should be transmitted through the CG PUSCH before dropping the entire MAC PDU that should be transmitted through the CG PUSCH and has already been transferred to a lower layer, the UE may stop transmitting and drop the CG PUSCH associated with the remaining MAC PDUs other than the portion of the MAC PDU that should be transmitted through the CG PUSCH and has already been transferred, and may transmit only the DG PUSCH to the base station. Alternatively, instead of dropping a MAC PDU that should be transmitted through the CG PUSCH on a lower layer, the UE may separately store the MAC PDU that should be transmitted through the CG PUSCH, and then may transmit the MAC PDU through a PUSCH resource that can be transmitted (CG PUSCH or DG PUSCH is also available).

Alternatively, if the sum of the layers of two different overlapped PUSCHs is greater than the maximum number of layers (e.g., 4 or 8) that can be transmitted during multi-panel simultaneous transmission, the UE may transmit only the DG PUSCH without transmitting the CG PUSCH. In this case, the UE may not generate a MAC PDU for transmission of the CG PUSCH. Alternatively, if the UE has generated a MAC PDU for transmission of the CG PUSCH, the UE may drop the MAC PDU to be transmitted through the CG PUSCH, or may store the MAC PDU for transmission through the next available PUSCH (CG PUSCH or DG PUSCH is also available as the next available PUSCH.

If this UE capability has been reported and the base station supports the corresponding method, new parameters to support the operation may be added at the time of configuring higher layer parameters for CG PUSCH. The corresponding function may also be supported implicitly without additionally configured higher layer parameters. If the UE supports this operation, even if Condition 3 is not satisfied, the UE may conditionally perform multi-panel simultaneous transmission, transmit the entire layer of DG PUSCH (or CG PUSCH), and may perform, with respect to CG PUSCH (or DG PUSCH), CG PUSCH transmission using as many layers as {the maximum number of supportable layers−the number of layers of DG PUSCH} (or perform DG PUSCH transmission using as many layers as {the maximum number of supportable layers−the number of layers of CG PUSCH}).

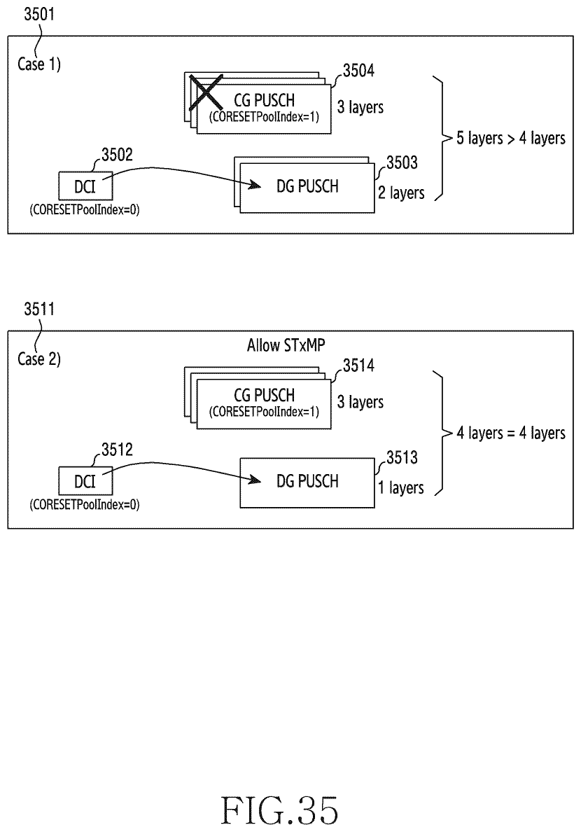

FIG. 35 illustrates determining whether multi-panel simultaneous transmission is possible according to the sum of the number of layers of two different overlapping PUSCHs according to an embodiment. If the number of uplink transmission layers of a CG PUSCH 3504 activated according to a higher layer parameter is 3 and the number of uplink transmission layers of a DG PUSCH 3503 scheduled by DCI 3502 is 2, and when the total number of layers that the UE should transmit in the overlapping transmission section is 5 and the maximum number of uplink layers that the UE is capable of supporting is 4, the UE may not perform simultaneous transmission using multiple panels. However, if the number of uplink transmission layers of a CG PUSCH 3514 activated according to a higher layer parameters is 3 and the number of uplink transmission layers of a DG PUSCH 3513 scheduled by DCI 3512 is 1, and when the total number of layers that the UE should transmit in the overlapping transmission section is 4 and the maximum number of uplink layers that the UE is capable of supporting is 4, the UE can support simultaneous transmission using multiple panels. Therefore, the UE can simultaneously transmit two different PUSCHs 3513 and 3514 that overlap each other.

Condition 4 concerns, in case that DCI for scheduling a PUSCH exists, whether a UE satisfies the minimum timeline required to determine processing of two different overlapping PUSCHs.

In NR, when multiple uplink channels overlap in the time domain, there are rules for a UE to select an uplink channel to transmit and to multiplex UCI, which is included in an uplink channel that is not transmitted, on the uplink channel for transmission. A certain amount of time interval or more is required between a time point at which the reception of the DCI that schedules the uplink channel is completed and the first symbol of the fastest transmitted uplink channel among the overlapping uplink channels. This time interval includes a time required for the UE to decode the received DCI and a time required to prepare for UCI multiplexing and uplink channel transmission. If these timeline conditions (e.g., T_{proc,2}^{mux} or T_{proc,2}) are satisfied, a time required to determine which channel the UE transmits among the overlapping uplink channels and multiplex the UCI thereon can be secured. This is merely an example, and specific timeline conditions and the cases in which they should be satisfied are described in the 3GPP standard.

Even when performing simultaneous uplink transmission using multiple panels, time may be required to ensure that the aforementioned conditions and additional conditions described later are satisfied and to multiplex the UCI in case that one uplink channel (e.g., CG PUSCH) is not transmitted. Therefore, if two different PUSCHs are overlapping, it may be identified whether a time interval satisfying the timeline condition (e.g., T_{proc,2}^{mux} or T_{proc,2}) exists between a time point at which reception of the DCI scheduling the DG PUSCH is completed and the first symbol of the first transmitted PUSCH among the two different overlapping PUSCHs. If Condition 4 is not satisfied, the base station is not able to clearly identify which one of the two overlapping PUSCHs is being transmitted. This may occur when the DCI is received in such a way that a timeline condition required for the UE to determine a PUSCH to be transmitted is not satisfied, i.e., if the timeline condition is unable to be satisfied because the interval between a time point at which reception of the DCI scheduling the DG PUSCH is completed and the first symbol of the CG PUSCH is too short, it may be unclear whether the UE cancels the CG PUSCH being transmitted and transmits the DG PUSCH, disregards the newly scheduled DG PUSCH and continues to transmit the CG PUSCH being transmitted, or transmits the CG PUSCH and DG PUSCH simultaneously using multiple panels.

Therefore, the base station should schedule the PUSCH to satisfy Condition 4. Alternatively, if the UE is capable of supporting a UE capability partialCancellation (the UE capability to cancel the remaining uplink channel during uplink transmission and perform other operations (such as receiving a downlink channel or transmitting another uplink channel)), even if the interval between the DCI and the first symbol of the first transmitted PUSCH does not satisfy Condition 4 above, it is possible to determine whether to perform multi-panel simultaneous transmission of the remaining two PUSCHs after a certain period time (e.g., T_{proc,2}) from the completion of DCI reception, or to cancel the remaining CG PUSCH transmission after a certain period of time (e.g., T_{proc,2}) from the completion of DCI reception. The examples described in Condition 4 assume that the CG PUSCH is transmitted before the DG PUSCH. If the DG PUSCH is scheduled to be transmitted before the CG PUSCH, Condition 4 may be satisfied because the interval between the DCI and the first symbols of the DG PUSCH satisfies a slot offset K₂ greater than a certain period of time (e.g., T_{proc,2}).

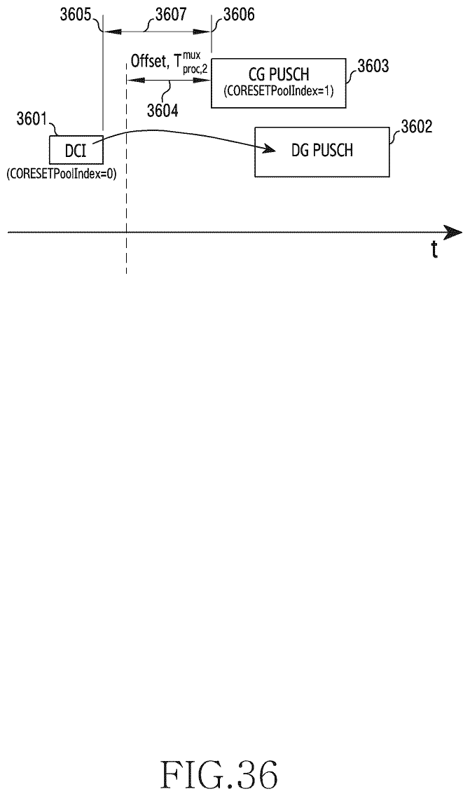

FIG. 36 illustrates scheduling of two different overlapping PUSCHs according to the minimum timeline condition required to determine processing of the two different overlapping PUSCHs according to an embodiment. A UE may receive DCI 3601 for scheduling a DG PUSCH 3602 from a base station from a CORESET in which CORESETPoolIndex is 0. An interval 3607 between a time point 3605 at which the UE receives the DCI 3601 and a time point 3606 when the first symbol of the fastest transmitted PUSCH of the two overlapping PUSCHs (CG PUSCH 3603) is transmitted should be greater than a minimum timeline condition 3604 required to determine the processing of the two different PUSCHs. Since the two PUSCHs 3602 and 3603 scheduled in FIG. 36 satisfy the timeline condition, the UE may simultaneously transmit the two different PUSCHs 3602 and 3603 that overlap each other.

In Condition 5, when a CG PUSCH is transmitted repeatedly, it is determined whether a CG PUSCH transmission section overlapping with a DG PUSCH is a section for transmitting an RV sequence in which initial transmission start is possible.

If CG PUSCH is transmitted repeatedly, higher layer parameters repK (higher layer parameter to indicate the number of repetitions) and repK-RV (higher layer parameter to indicate a redundancy version (RV) sequence utilized for repeated transmission if CG PUSCH is transmitted repeatedly such as if the repK-RV parameter is configured as s3-0303, which is one of the candidate values such as s1-0231, s2-0303, s3-0000, etc., TBs according to RV sequences 0 and 3 are alternately mapped to CG PUSCH transmission section and transmitted) are configured. The UE may start transmission on CG PUSCH with a RV value of 0. This is because if there is no data to transmit to the base station, the UE does not transmit the CG PUSCH configured as ConfiguredGrantConfig, but if there is data to transmit, the UE transmits the CG PUSCH from a section in which transmission initiation is possible.

According to Condition 5, the UE may identify whether the DG PUSCH overlaps with a CG PUSCH for transmitting a TB according to an RV sequence in which initial transmission start is possible. If the CG PUSCH transmission section overlapping with the DG PUSCH is a transmission associated with RV sequence 0, the UE may use multiple panels to transmit two different overlapping PUSCHs simultaneously. If the CG PUSCH transmission section overlapping with the DG PUSCH is a transmission not associated with RV sequence 0, the UE may transmit only the DG PUSCH without transmitting the CG PUSCH. If a CG PUSCH is not transmitted because Condition 5 is not satisfied, the UE may subsequently transmit only the DG PUSCH without transmitting the entire CG PUSCH. Alternatively, the UE may transmit the CG PUSCH that does not overlap with the DG PUSCH without transmitting the overlapping part of the CG PUSCH.

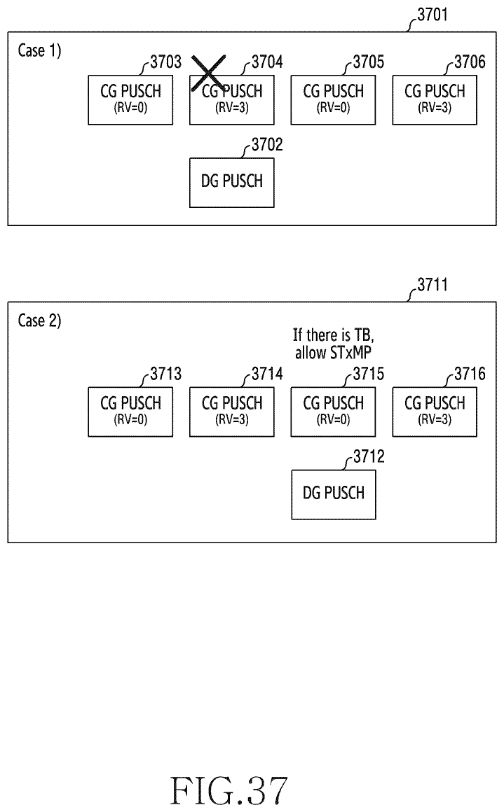

FIG. 37 illustrates determining whether multi-panel simultaneous transmission is possible by identifying whether there is a section capable of starting initial transmission for the repeatedly transmitted CG PUSCH according to an embodiment. Case 1 3701 corresponds to when a DG PUSCH 3702 overlaps with a PUSCH 3704, which is associated with RV sequence 3 in which initial transmission start is not available, among CG PUSCHs 3703, 3704, 3705, and 3706 that can be transmitted repeatedly. In this case, the UE may only transmit DG PUSCH 3702 without performing multi-panel simultaneous transmission. Case 2 3711 corresponds to a case in which a DG PUSCH 3712 overlaps with a PUSCH 3715, which is associated with RV sequence 0 in which initial transmission start is possible, among CG PUSCHs 3713, 3714, 3715, and 3716 that can be transmitted repeatedly. In this case, the UE may support simultaneous transmission using multiple panels. Therefore, if there is data, such as a TB, to be transmitted to the transmission section for the CG PUSCH 3715, the UE may simultaneously transmit two different PUSCHs 3712 and 3715 that overlap each other.

In Condition 6, it is determined whether higher layer parameters to support multi-panel simultaneous transmission are configured within a higher layer parameter configuration for CG PUSCH.

When performing multi-panel simultaneous transmission, a UE may identify whether higher layer parameter(s) for multi-panel simultaneous transmission are configured in a higher layer parameter configuration for the overlapping CG PUSCH. If the CG PUSCH of the two different overlapping PUSCHs has the higher layer parameter(s) configured in consideration of multi-panel simultaneous transmission and the other requirements for multi-panel simultaneous transmission have been satisfied, the UE may perform multi-panel based simultaneous transmission to transmit the two different PUSCHs through their respective panels. If the CG PUSCH of the two overlapping PUSCHs does not have the higher layer parameters configured for multi-panel simultaneous transmission, the UE may cancel the transmission of one PUSCH (e.g., CG PUSCH) of the two overlapping PUSCHs and transmit only the other PUSCH (e.g., DG PUSCH) without performing multi-panel based simultaneous transmission.

In Condition 7, the type of data or UCI transmitted on DG PUSCH or CG PUSCH is identified.

When performing multi-panel simultaneous transmission, depending on the type of data or UCI included in the two different overlapping PUSCHs, the UE may perform simultaneous transmission or transmit only one of the two PUSCHs. For example, multi-panel simultaneous transmission may be performed or not depending on whether data is included in the DG PUSCH among the two overlapping PUSCHs. If the overlapping DG PUSCH includes data, the UE may not perform multi-panel simultaneous transmission and may only transmit the DG PUSCH among the two PUSCHs. This may be considered in case that the two panels share the uplink transmission power of the UE, and that the transmission power can be reduced due to other simultaneously transmitting panels. Alternatively, if the overlapping DG PUSCHs include data, the UE may perform multi-panel simultaneous transmission. In this case, the multi-panel simultaneous transmission has no effect on the transmission power and may be used to prevent the actual code rate of the data from increasing when the UCI included in the CG PUSCH is multiplexed on the DG PUSCH. In another example, if the AP CSI is multiplexed on the DG PUSCH of two different overlapping PUSCHs, the UE may not perform multi-panel simultaneous transmission and may only transmit the DG PUSCH, on which the AP CSI is multiplexed, among two PUSCHs. Alternatively, in case the corresponding PUSCH is multiplexed with UCI such as HARQ-ACK after applying the overlap rule with PUCCH, the UE may not perform multi-panel simultaneous transmission and may only transmit the PUSCH that multiplexes UCI (including HARQ-ACK) among the two PUSCHs.

As such, the UE identifies whether all conditions among Conditions 1 to 7 are met. If so, the UE may transmit two different overlapping PUSCHs through multi-panel simultaneous transmission. Alternatively, if some of the conditions among Conditions 1 through 7 are met, the UE may perform multi-panel simultaneous transmission. For example, the UE may identify if Condition 1, Condition 3, and Condition 4 are met and perform multi-panel simultaneous transmission if all three conditions are satisfied. This is merely an example, and any combination of Conditions 1 to 7 may be considered by the UE to determine if the condition(s) are met and whether to perform multi-panel simultaneous transmission.

While the preceding embodiments describe specific operations in terms of single-panel transmissions, it can be understood to operate by replacing single-panel transmission with uplink transmission to sTRP instead of the single-panel transmission. The common feature between uplink transmission to sTRP and single-panel transmission is that the PUSCH transmission to sTRP occurs. However, depending on the implementation of the UE, antenna ports included in two panels may be tied together so that the UE may transmit the PUSCH to the sTRP using the antenna ports included in the two panels. Therefore, when the above multi-panel simultaneous transmission is not performed, it may be understood that the UE does not perform mTRP simultaneous transmission using multiple panels, and the UE may transmit PUSCH to the sTRP by using antenna ports included in one or multiple panels.

### Seventh Embodiment: Method for Configuring Higher Layer Parameters to Support Switching Between Multi-Panel Simultaneous Transmission and Single Panel Transmission

The seventh embodiment is performed by considering both cases in which a CG PUSCH overlaps with another PUSCH and a case in which the CG PUSCH does not overlap with another PUSCH.

CG PUSCHs are transmitted according to higher layer parameters configured in the higher layer parameter ConfiguredGrantConfig as described earlier, and for Type 2 CG PUSCHs, the scheduling information indicated by DCI for activating CG PUSCH transmission. In other words, the number of transmission layers, TB size, SRS resource referenced in the PUSCH transmission, and the like of the CG PUSCH are determined according to the preconfigured higher layer parameters or the DCI for activating the CG PUSCH transmission. In other words, CG PUSCH is characterized by being transmitted according to the determined scheduling information until the activated transmission is deactivated (RRC reconfiguration or reception of deactivated DCI). In the fifth embodiment, a configuration method for simultaneous transmission of two CG PUSCHs through multiple panels has been described, and in the sixth embodiment, a condition under which simultaneous transmission through multiple panels is possible when one CG PUSCH and one DG PUSCH are overlapped has been specifically described, and the operation of the UE according to whether the condition is met has been described.

In the seventh embodiment, a method for supporting the use of different configuration information depending on whether one CG PUSCH is transmitted through a single panel or overlaps with another PUSCH and transmitted through multiple panels is described. It is assumed that higher layer parameters for CG PUSCH considering both single-panel transmission and multi-panel transmission are configured based on individual ConfiguredGrantConfig associated with each CORESETPoolIndex, as in Option 2 of the fifth embodiment. In other words, one ConfiguredGrantConfig is configured to be associated with one CORESETPoolIndex.

The base station configures additional parameters for multi-panel transmission for some of the higher layer parameters configured in the higher layer parameter ConfiguredGrantConfig if the UE can support simultaneous transmission using multiple panels. For example, a higher layer parameter precodingAndNumberOfLayers2 (or another named parameter to indicate the number of precoders and layers utilized for multi-panel transmission may be added) is additionally configured, and precodingAndNumberOfLayers and precodingAndNumberOfLayers2 may be configured in ConfiguredGrantConfig. Other higher layer parameters contained in ConfiguredGrantConfig can be understood by the UE as higher layer parameters shared by both single-panel and multi-panel simultaneous transmissions. For example, a higher layer parameter periodicity may be shared and used by both single-panel and multi-panel simultaneous transmissions.

Among the higher layer parameters including multiple parameters due to additional parameters being configured, the existing higher layer parameters are referenced by the UE to transmit CG PUSCH when performing single-panel PUSCH transmission using a single panel. The added higher layer parameters are referenced by the UE to transmit CG PUSCH when the CG PUSCH overlaps with other CG PUSCHs to perform multi-panel simultaneous transmission. If the CG PUSCH scheduled with ConfiguredGrantConfig to which some higher layer parameters are added is overlapped with another PUSCH, the UE may identify whether some or all of the conditions described in the preceding sixth embodiment are satisfied, and may refer to the added parameters in consideration of the multi-panel simultaneous transmission to determine whether the conditions are satisfied. If the parameter required to determine whether the condition is satisfied is a parameter common to both the multi-panel transmission and the single-panel transmission, the UE may determine whether the condition is satisfied by referring to the common parameter. As such, the following parameters, which include precodingAndNumberOfLayers as described above, can be considered as higher layer parameters that can be added for multi-panel transmission:
p0-PUSCH-Alpha
pathlossReferenceIndex
precodingAndNumberOfLayers
antennaPort
srs-ResourceIndicator
mcsAndTBS

In addition to the above examples of additional higher layer parameters that may be configured within the ConfiguredGrantConfig for multi-panel transmissions, other higher layer parameters may be additionally configured depending on the technique (e.g., repK to indicate the number of repetitions). If not additionally configured, the UE may apply these parameters in a manner common to both multi-panel and single-panel simultaneous transmissions.

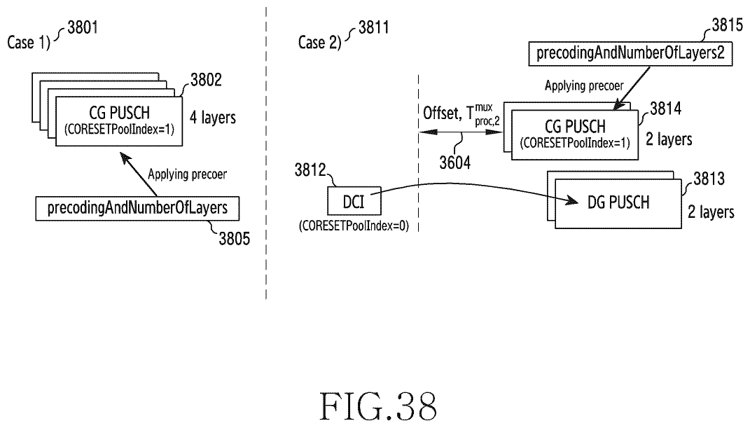

FIG. 38 illustrates CG PUSCH scheduling based on whether a CG PUSCH is transmitted through a single panel or multi-panel simultaneous transmission according to an embodiment. Case 1 3801 illustrates when a CG PUSCH 3802 is scheduled for a single panel transmission with no overlap with other PUSCHs. The UE may activate and transmit the CG PUSCH 3802 according to higher layer parameters configured in ConfiguredGrantConfig. In this case, the number of layers and precoder of the CG PUSCH 3802 are determined by the UE by referring to the configured higher layer parameter precodingAndNumberOfLayers 3805. Case 2 3811 illustrates when a CG PUSCH 3814 overlaps with another PUSCH 3813 scheduled with DCI 3812 and is scheduled to be transmitted through multiple panels. The UE may activate and transmit the CG PUSCH 3814 according to the higher layer parameter configured in the ConfiguredGrantConfig. In this case, the number of layers and precoder of the CG PUSCH 3802 are determined by the UE by referring to additionally configured precodingAndNumberOfLayers2 3815 rather than the configured higher layer parameter precodingAndNumberOfLayers. Thereafter, the UE may transmit the CG PUSCH 3814 and the DG PUSCH 3813 simultaneously using the respective panels.

In this embodiment, the operation is also described in terms of single-panel transmission, but it can be understood to operate by replacing single-panel transmission with uplink transmission to the sTRP instead of the single-panel transmission. The common feature between uplink transmission to sTRP and single-panel transmission is that PUSCH transmission to sTRP occurs. However, depending on the implementation of the UE, antenna ports included in two panels may be tied together so that the UE may transmit the PUSCH to the sTRP using the antenna ports included in the two panels. Therefore, when the above multi-panel simultaneous transmission is not performed, it may be understood that the UE does not perform mTRP simultaneous transmission using multiple panels, and the UE may transmit PUSCH to the sTRP by using antenna ports included in one or multiple panels.

### Eighth Embodiment: During Multi-Panel Simultaneous Transmission, Sharing of Scheduling Information to Support Multi-Panel Simultaneous Transmissions Between Base Stations

The eighth embodiment describes a method capable of supporting switching between multi-panel and single-panel transmissions, by considering both cases in which a CG PUSCH overlaps with another PUSCH and a case in which the CG PUSCH does not overlap with another PUSCH.

As described above, the mTRP technique based on mDCI may not be able to fully share scheduling information between two TRPs, unlike the mTRP technique based on sDCI, because a backhaul link between the two TRPs is not ideal. Therefore, only some limited information may be shared between the two TRPs. As previously described in the sixth and seventh embodiments, prior to performing a simultaneous transmission using multiple panels, the two base stations may share in advance the higher layer parameters for the multi-panel simultaneous transmission configured for the corresponding UE. This information may include pieces of configuration information for the CG PUSCH transmitted to each TRP (which is associated with each CORESETPoolIndex). Based on the exchanged information, a DG PUSCH may be scheduled in the corresponding TRP, by considering the CG PUSCHs configured for other TRPs. Thereafter, one TRP (e.g., TRP1) may schedule a DG PUSCH that overlaps with a CG PUSCH which is transmitted to another TRP (e.g., TRP2). In this case, because the CG PUSCH is scheduled to overlap with another PUSCH, the UE may transmit the CG PUSCH by referring to the parameter additionally configured in the ConfiguredGrantConfig as described in the seventh embodiment.

As such, in case that the UE transmits the CG PUSCH by referencing a higher layer parameter for multi-panel transmission rather than a higher layer parameter for single-panel transmission, the TRP to which the CG PUSCH is transmitted should be aware of this switched transmission method. This is because the received CG PUSCH should be decoded by considering the switched scheduling information such as the number of layers scheduled in the CG PUSCH, TB size, MCS, etc. Therefore, the TRP for scheduling the DG PUSCH should share scheduling information with other TRPs, the scheduling information indicating scheduling of the DG PUSCH for multi-panel simultaneous transmission before transmitting the DCI to the UE. In this case, the shared information should be limited information obtained by considering the limited backhaul link.

Therefore, the TRP scheduling the DG PUSCH may transfer, to the TRP for which the CG PUSCH is scheduled, an indicator indicating that the DG PUSCH overlaps with the CG PUSCH. The indicator may consist of one bit, and a value of indicator is configured as 1 to transfer the information. Upon receiving this indicator, the TRP for which the CG PUSCH is scheduled may understand that multi-panel simultaneous transmission is being performed, and may expect the UE to transmit the CG PUSCH by referring to the parameter additionally configured in the ConfiguredGrantConfig, and may receive the CG PUSCH. However, if the DG PUSCH scheduled by one TRP does not affect the scheduling of CG PUSCH which is transmitted to another TRP (e.g., when CG PUSCHs and DG PUSCHs scheduled with higher layer parameters configured before can satisfy the conditions described in the sixth embodiment, such as the case in which the number of transmission layers of the DG PUSCH is 2 and the number of transmission layers of the CG PUSCH for single panel transmission is 1), separate inter-TRP information sharing for DG PUSCH scheduling may not be required.

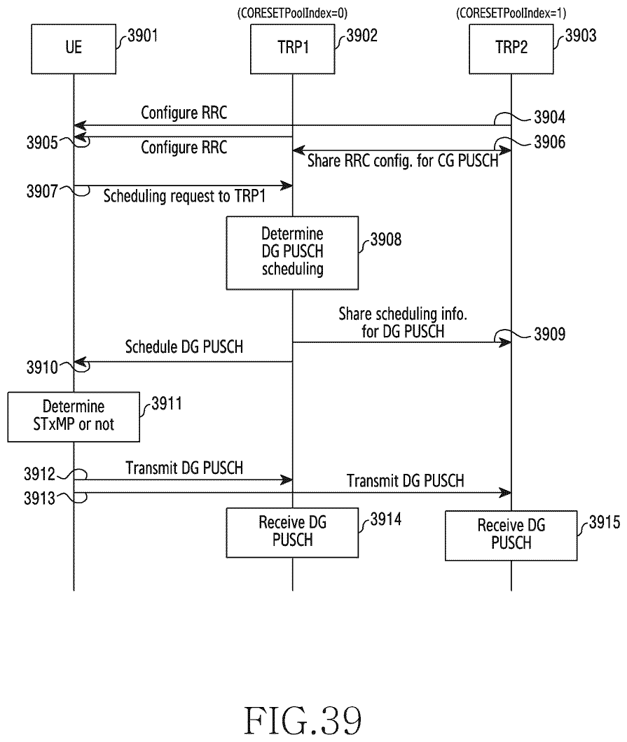

FIG. 39 illustrates an operation between a base station and a UE of simultaneously transmitting and receiving DG PUSCH and CG PUSCH through multiple panels according to an embodiment. In FIG. 39, TRP1 3902 may be associated with CORESETPoolIndex=0, and TRP2 3903 may be associated with CORESETPoolIndex=1. If each TRP transmits an RRC parameter, RRC configuration 3905 of the TRP1 3902 and RRC configuration 3904 of the TRP2 3903 may be transmitted to a UE 3901. The two TRPs 3902, 3903 may then exchange their respective RRC information (indicated by reference numeral 3906). Alternatively, TRP1 3902 may transmit all RRC configurations for all TRPs to the UE. In this case, separate RRC configuration information sharing 3906 between the two TRPs may be omitted. Thereafter, the UE 3901 may separately make a scheduling request (SR) 3907 to TRP1 3902. Based on the scheduling request received from the UE 3901, the TRP1 3902 may determine DG PUSCH scheduling 3908. Alternatively, the TRP1 3902 may determine the DG PUSCH scheduling 3908 by triggering an aperiodic CSI report to the UE 3901. After determining the scheduling of DG PUSCH 3908, the TRP1 3902 may transfer information about the DG PUSCH scheduling 3909 to the TRP2 3903. The transferred scheduling information may include information such as whether simultaneous transmission with multi-panel occurs or the number of layers of DG PUSCH to be scheduled. The scheduling information may also include any additional information required or requested by the TRP2 3903. Thereafter, the TRP1 3902 may schedule the DG PUSCH 3910 to the UE 3901. The UE 3901 may determine whether to perform simultaneous transmission with multi-panel (STxMP) 3911 by identifying the conditions of the sixth embodiment described above or by identifying higher layer parameters according to the seventh embodiment. If the UE 3901 performs simultaneous transmission with multi-panel, the UE 3901 transmits the DG PUSCH to the TRP1 3902 and transmits the CG PUSCH 3913 to the TRP2 3903. The TRP1 3902 may decode the received DG PUSCH 3914 to complete the reception. The TRP2 3903 may decode the received CG PUSCH based on the higher layer parameter for multi-panel transmission and may then complete the reception 3915.

Some or all of the above embodiments may be performed in combination with some or all of the other one or more embodiments.

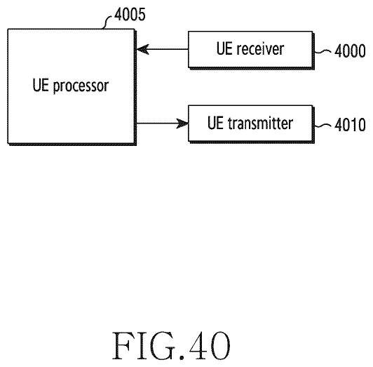

FIG. 40 illustrates the structure of a terminal in a wireless communication system according to an embodiment.

Referring to FIG. 40, the terminal may include a transceiver (referring to the terminal receiver 4000 and the terminal transmitter 4010), a memory, and a terminal processing unit 4005 (or a terminal control unit or processor). Depending on the communication method of the terminal described above, the terminal's transceiver units (4000, 4010), memory, and terminal processing unit 4005 can operate. However, the components of the terminal are not limited to the examples described above. For example, the terminal may include more or fewer components than the aforementioned components. In addition, the transceiver, memory, and processor may be implemented in the form of a single chip.

The transceiver unit can transmit and receive signals to and from the base station. The signal may include control information and data. To this end, the transceiver may be composed of an RF transmitter that up-converts and amplifies the frequency of the transmitted signal, and an RF receiver that amplifies the received signal with low noise and down-converts the frequency. However, the components of the transceiver are not limited to the RF transmitter and RF receiver.

Additionally, the transceiver may receive a signal through a wireless channel and output it to the terminal processing unit 4005, and transmit the signal output from the terminal processing unit 4005 through a wireless channel.

Memory can store programs and data necessary for the operation of the terminal. Additionally, the memory can store control information or data included in signals transmitted and received by the terminal. Memory may be composed of storage media such as read only memory (ROM), random access memory (RAM), hard disk, compact disc (CD)-ROM, and digital versatile disc DVD, or a combination of storage media. Additionally, there may be multiple memories.

The terminal processing unit 4005 can control a series of processes so that the terminal can operate according to the above-described embodiment. For example, the processor can receive DCI composed of two layers and control the components of the terminal to transmit multiple PUSCHs at the same time. There may be a plurality of processors, and the processor may perform a component control operation of the terminal by executing a program stored in the memory.

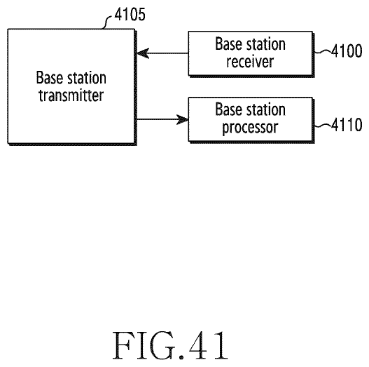

FIG. 41 illustrates the structure of a base station in a wireless communication system according to an embodiment. The base station in may refer to the above-described specific TRP.

Referring to FIG. 41, the base station may include a base station receiver 4100, a transceiver unit referring to the base station transmitter 4110, a memory, and a base station processing unit 4105 (or abase station control unit or processor). According to the above-described communication method of the base station, the base station's transceiver units 4100 and 4110, memory, and base station processing unit 4105 can operate. However, the components of the base station are not limited to the above examples. For example, a base station may include more or fewer components than those described above. In addition, the transceiver, memory, and processor may be implemented in the form of a single chip.

The transmitting and receiving unit can transmit and receive signals to and from the terminal. The signal may include control information and data. To this end, the transceiver may be composed of an RF transmitter that up-converts and amplifies the frequency of the transmitted signal, and an RF receiver that amplifies the received signal with low noise and down-converts the frequency. However, the components of the transceiver are not limited to the RF transmitter and RF receiver.

Additionally, the transceiver may receive a signal through a wireless channel and output it to the base station processing unit 4105, and transmit the signal output from the base station processing unit 4105 through a wireless channel.

It will be understood that each block of the processing flow diagrams and combinations of the flow diagram diagrams can be performed by computer program instructions. These computer program instructions can be mounted on a processor of a general-purpose computer, special-purpose computer, or other programmable data processing equipment, so that the instructions performed through the processor of the computer or other programmable data processing equipment are described in the flow chart block(s). These computer program instructions may also be stored in computer-usable or computer-readable memory that can be directed to a computer or other programmable data processing equipment to implement a function in a particular manner, so that the computer-usable or computer-readable memory It is also possible to produce manufactured items containing instruction means that perform the functions described in the flowchart block(s). Computer program instructions can also be mounted on a computer or other programmable data processing equipment, so that a series of operational steps are performed on the computer or other programmable data processing equipment to create a process that is executed by the computer, thereby generating a process that is executed by the computer or other programmable data processing equipment. Instructions that perform processing equipment may also provide steps for executing the functions described in the flow diagram block(s).

Additionally, each block may represent a module, segment, or portion of code that includes one or more executable instructions for executing specified logical function(s). Additionally, it should be noted that in some alternative execution examples it is possible for the functions mentioned in the blocks to occur out of order. For example, it is possible for two blocks shown in succession to be performed substantially simultaneously, or it is possible for the blocks to be performed in reverse order depending on the corresponding function.

The memory can store programs and data necessary for the operation of the base station. Additionally, the memory may store control information or data included in signals transmitted and received by the base station. Memory may be composed of storage media such as ROM, RAM, hard disk, CD-ROM, and DVD, or a combination of storage media. Additionally, there may be multiple memories.

The processor can control a series of processes so that the base station can operate according to the above-described embodiment of the present disclosure. For example, the processor can configure two layers of DCIs containing allocation information for multiple PUSCHs and control each component of the base station to transmit them. There may be a plurality of processors, and the processor may perform a component control operation of the base station by executing a program stored in a memory.

Methods according to embodiments described in the claims or disclosure of the present disclosure may be implemented in the form of hardware, software, or a combination of hardware and software.

When implemented as software, a computer-readable storage medium that stores one or more programs (software modules) may be provided. One or more programs stored in a computer-readable storage medium are configured to be executable by one or more processors in an electronic device (configured for execution). One or more programs include instructions that cause the electronic device to execute methods according to embodiments described in the claims or disclosure of the present disclosure.

These programs (software modules, software) include random access memory, non-volatile memory including flash memory, ROM, and electrically erasable programmable ROM. electrically erasable programmable read only memory (EEPROM), magnetic disc storage device, CD-ROM, DVDs, or other types of It can be stored in an optical storage device or magnetic cassette. Alternatively, it may be stored in a memory consisting of a combination of some or all of these. Additionally, multiple configuration memories may be included.

In addition, the program can be accessed through a communication network such as the Internet, Intranet, LAN (Local Area Network), WLAN (Wide LAN), or SAN (Storage Area Network), or a combination of these. It may be stored in an attachable storage device that can be accessed. This storage device can be connected to a device performing an embodiment of the present disclosure through an external port. Additionally, a separate storage device on a communication network may be connected to the device performing an embodiment of the present disclosure.

The embodiments of the present disclosure and drawings are merely provided as specific examples to easily explain the technical content of the present disclosure and aid understanding of the present disclosure, and are not intended to limit the scope of the present disclosure. That is, it is obvious to those skilled in the art that other modifications based on the technical idea of the present disclosure can be implemented. Additionally, each of the above embodiments can be operated in combination with each other as needed. For example, a base station and a terminal may be operated by combining parts of one embodiment of the present disclosure and another embodiment. For example, parts of the first and second embodiments of the present disclosure may be combined to operate the base station and the terminal. In addition, although the above embodiments were presented based on the FDD LTE system, other modifications based on the technical idea of the above embodiments may be implemented in other systems such as a TDD LTE system, 5G or NR system.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
receiving configuration information on a resource for transmitting a first physical uplink shared channel (PUSCH) based on a configured grant, the first PUSCH being associated with a first control resource set (CORESET) pool identifier;
receiving downlink control information (DCI) including information on a resource for transmitting a second PUSCH based on a dynamic grant (DG), the second PUSCH being associated with a second CORESET pool identifier, wherein the resource for transmitting the first PUSCH overlaps with all or part of the resource for transmitting the second PUSCH in a time domain;
identifying whether a value of the first CORESET pool identifier is different from a value of the second CORESET pool identifier; and
in case that the value of the first CORESET pool identifier is identified to be different from the value of the second CORESET pool identifier, transmitting the first PUSCH and the second PUSCH.

2. The method of claim 1, in case that the value of the first CORESET pool identifier is identified to be equal to the value of the second CORESET pool identifier, further comprising:
transmitting the second PUSCH based on the DG among the first PUSCH and the second PUSCH,
wherein the first PUSCH based on the CG is dropped.

3. The method of claim 1, further comprising:
identifying whether a sum of a number of a first layer allocated to the first PUSCH and a number of a second layer allocated to the second PUSCH is less than or equal to a number of a maximum uplink transmission layer,
wherein in case that the sum of the number of the first layer allocated to the first PUSCH and the number of the second layer allocated to the second PUSCH is less than or equal to the number of the maximum uplink transmission layer, the first PUSCH and the second PUSCH is transmitted, and
wherein in case that the sum of the number of the first layer allocated to the first PUSCH and the number of the second layer allocated to the second PUSCH is greater than the number of the maximum uplink transmission layer, transmission for at least part of the first layer and the second layer is dropped.

4. The method of claim 3,
wherein transmitting both the first PUSCH and the second PUSCH is not performed in at least one case of when the value of the first CORESET pool identifier is identified to be equal to the value of the second CORESET pool identifier, or when the sum of the number of the first layer allocated to the first PUSCH and the number of the second layer allocated to the second PUSCH is greater than the number of the maximum uplink transmission layer, in a resource region in which the resource for transmitting the first PUSCH overlaps with all or part of the resource for transmitting the second PUSCH.

5. The method of claim 1,
wherein the configuration information on the resource for transmitting the first PUSCH includes a number that the first PUSCH is repeatedly transmitted, and information on a redundancy version (RV) sequence including four RVs having one value among 0 to 3 for each of repetitions of the first PUSCH,
wherein the first PUSCH is transmitted when, among the repetitions of the first PUSCH, the first PUSCH overlaps with the second PUSCH on a resource corresponding to the RV having a value corresponding to a specific value, and
wherein the first PUSCH is not transmitted when, among the repetitions of the first PUSCH, the first PUSCH overlaps with the second PUSCH on a resource corresponding to the RV having a value corresponding to a value other than the specific value.

6. A method performed by a base station in a wireless communication system, the method comprising:
transmitting configuration information on a resource for transmitting a first physical uplink shared channel (PUSCH) based on a configured grant, the first PUSCH being associated with a first control resource set (CORESET) pool identifier;
transmitting downlink control information (DCI) including information on a resource for transmitting a second PUSCH based on a dynamic grant (DG), the second PUSCH being associated with a second CORESET pool identifier, wherein the resource for transmitting the first PUSCH overlaps with all or part of the resource for transmitting the second PUSCH in a time domain;
in case that a value of the first CORESET pool identifier is different from a value of the second CORESET pool identifier, receiving the first PUSCH and the second PUSCH.

7. The method of claim 6, in case that the value of the first CORESET pool identifier is equal to the value of the second CORESET pool identifier, further comprising:
receiving the second PUSCH based on the DG among the first PUSCH and the second PUSCH, wherein the first PUSCH based on the CG is dropped.

8. The method of claim 6, further comprising:
wherein in case that a sum of a number of a first layer allocated to the first PUSCH and a number of a second layer allocated to a second PUSCH is less than or equal to the number of the maximum uplink transmission layer, the first PUSCH and the second PUSCH is received, and
wherein in case that the sum of the number of the first layer allocated to the first PUSCH and the number of the second layer allocated to the second PUSCH is greater than the number of the maximum uplink transmission layer, reception for at least part of the first layer and the second layer is dropped.

9. The method of claim 8,
wherein receiving both the first PUSCH and the second PUSCH is not performed in at least one case of when the value of the first CORESET pool identifier is identified to be equal to the value of the second CORESET pool identifier, or when the sum of the number of the first layer allocated to the first PUSCH and the number of the second layer allocated to the second PUSCH is greater than the number of the maximum uplink transmission layer, in a resource region in which the resource for transmitting the first PUSCH overlaps with all or part of the resource for transmitting the second PUSCH.

10. The method of claim 6,
wherein the configuration information on the resource for transmitting the first PUSCH includes a number that the first PUSCH is repeatedly transmitted, and information on a redundancy version (RV) sequence including four of RVs having one value among 0 to 3 for each of repetitions of the first PUSCH,
wherein the first PUSCH is received when, among the repetitions of the first PUSCH, the first PUSCH overlaps with the second PUSCH on a resource corresponding to the RV having a value corresponding to a specific value, and
wherein the first PUSCH is not received when, among the repetitions of the first PUSCH, the first PUSCH overlaps with the second PUSCH on a resource corresponding to the RV having a value corresponding to a value other than the specific value.

11. A user equipment (UE) in a wireless communication system, the UE comprising:
a transceiver; and
a controller coupled with the transceiver,
wherein the controller is configured to:
receive configuration information on a resource for transmitting a first physical uplink shared channel (PUSCH) based on a configured grant, the first PUSCH being associated with a first control resource set (CORESET) pool identifier,
receive downlink control information (DCI) including information on a resource for transmitting a second PUSCH based on a dynamic grant (DG), the second PUSCH being associated with a second CORESET pool identifier, wherein the resource for transmitting the first PUSCH overlaps with all or part of the resource for transmitting the second PUSCH in a time domain;
identify whether a value of the first CORESET pool identifier is different from a value of the second CORESET pool identifier, and
in case that the value of the first CORESET pool identifier is identified to be different from the value of the second CORESET pool identifier, transmit the first PUSCH and the second PUSCH.

12. The UE of claim 11, wherein in case that the value of the first CORESET pool identifier is identified to be equal to the value of the second CORESET pool identifier, the controller is further configured to:
transmit the second PUSCH based on the DG among the first PUSCH and the second PUSCH, and
wherein the first PUSCH based on the CG is dropped.

13. The UE of claim 11, wherein the controller is further configured to:
identify whether a sum of a number of a first layer allocated to the first PUSCH and a number of a second layer allocated to the second PUSCH is less than or equal to a number of a maximum uplink transmission layer,
wherein in case that the sum of the number of the first layer allocated to the first PUSCH and the number of the second layer allocated to the second PUSCH is less than or equal to the number of the maximum uplink transmission layer, the first PUSCH and the second PUSCH is transmitted, and
wherein in case that the sum of the number of the first layer allocated to the first PUSCH and the number of the second layer allocated to the second PUSCH is greater than the number of the maximum uplink transmission layer, transmission for at least part of the first layer and the second layer is dropped.

14. The UE of claim 13,
wherein the controller is not configured to transmit both the first PUSCH and the second PUSCH in at least one case of when the value of the first CORESET pool identifier is identified to be equal to the value of the second CORESET pool identifier, or when the sum of the number of the first layer allocated to the first PUSCH and the number of the second layer allocated to the second PUSCH is greater than the number of the maximum uplink transmission layer, in a resource region in which the resource for transmitting the first PUSCH overlaps with all or part of the resource for transmitting the second PUSCH.

15. The UE of claim 11,
wherein the configuration information on the resource for transmitting the first PUSCH includes a number indicating that the first PUSCH is repeatedly transmitted, and information on a redundancy version (RV) sequence including four of RVs having one value among 0 to 3 for each of repetitions of the first PUSCH,
wherein the first PUSCH is transmitted when, among the repetitions of the first PUSCH, the first PUSCH overlaps with the second PUSCH on a resource corresponding to the RV having a value corresponding to a specific value, and
wherein the first PUSCH is not transmitted when, among the repetitions of the first PUSCH, the first PUSCH overlaps with the second PUSCH on a resource corresponding to the RV having a value corresponding to a value other than the specific value.

16. A base station in a wireless communication system, the base station comprising:
a transceiver; and
a controller coupled with the transceiver,
wherein the controller is configured to:
transmit configuration information on a resource for transmitting a first physical uplink shared channel (PUSCH) based on a configured grant, the first PUSCH being associated with a first control resource set (CORESET) pool identifier,
transmit downlink control information (DCI) including information on a resource for transmitting a second PUSCH based on a dynamic grant (DG), the second PUSCH being associated with a second CORESET pool identifier, wherein the resource for transmitting the first PUSCH overlaps with all or part of the resource for transmitting the second PUSCH in a time domain, and
in case that a value of the first CORESET pool identifier is different from a value of the second CORESET pool identifier, receive the first PUSCH and the second PUSCH.

17. The base station of claim 16,
wherein in case that the value of the first CORESET pool identifier is equal to the value of the second CORESET pool identifier the controller is further configured to:
receive the second PUSCH based on the DG among the first PUSCH and the second PUSCH, and
wherein the first PUSCH based on the CG is dropped.

18. The base station of claim 16, wherein the controller is further configured to:
wherein in case that a sum of a number of a first layer allocated to the first PUSCH and a number of a second layer allocated to a second PUSCH is less than or equal to the number of the maximum uplink transmission layer, the first PUSCH and the second PUSCH is received, and
wherein in case that the sum of the number of the first layer allocated to the first PUSCH and the number of the second layer allocated to the second PUSCH is greater than the number of the maximum uplink transmission layer, reception for at least part of the first layer and the second layer is dropped.

19. The base station of claim 18, wherein the controller is not configured to receive both the first PUSCH and the second PUSCH in at least one case of when the value of the first CORESET pool identifier is identified to be equal to the value of the second CORESET pool identifier, or when the sum of the number of the first layer allocated to the first PUSCH and the number of the second layer allocated to the second PUSCH is greater than the number of the maximum uplink transmission layer, in a resource region in which the resource for transmitting the first PUSCH overlaps with all or part of the resource for transmitting the second PUSCH.

20. The base station of claim 16,
wherein the configuration information on the resource for transmitting the first PUSCH includes a number that the first PUSCH is repeatedly transmitted, and information on a redundancy version (RV) sequence including four of RVs having one value among 0 to 3 for each of repetitions of the first PUSCH,
wherein the first PUSCH is received when, among the repetitions of the first PUSCH, the first PUSCH overlaps with the second PUSCH on a resource corresponding to the RV having a value corresponding to a specific value, and
wherein the first PUSCH is not received when, among the repetitions of the first PUSCH, the first PUSCH overlaps with the second PUSCH on a resource corresponding to the RV having a value corresponding to a value other than the specific value.
